(19) United States
(12) Patent Application Publication
(10) Pub. No.: US 2002/0138527 A1
(43) Pub. Date: Sep. 26, 2002

(54) System and method for a web-based venture reporting

(76) Inventors: Neider Bell, Issaquah, WA (US); Asa Shows, Bellevue, WA (US); Samantha Wilkinson, Vashon, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/814,578

(22) Filed: Mar. 21, 2001

(51) Int. Cl. G06F 15/00

(52) U.S. Cl. 707/530

(57) ABSTRACT

A system and method for web-based venture reporting. The web-based venture reporting system allows for secure distribution of venture related information, including financial reports, mission statements, and business strategies to loaning institutions, investors, officers, and others having interest in the venture in a convenient and attractive manner. The system includes client computers accessing a server computer, which supports venture reporting websites directed to individual ventures. The server computer of the venture reporting system can support a plurality of disparate venture reporting websites for unrelated ventures. The web-based venture reporting system can be configured to be managed by a superset administrator who has access to all venture websites whereas individual venture websites are also managed by venture managers.

### TECHNICAL FIELD

The invention relates generally to distributed computing environments, and more particularly to a client-server environment involving a system and method for reporting business information, including financial information, over networks, particularly the Internet.

### BACKGROUND OF THE INVENTION

Lending institutions such as banks report that small and middle market lending to ventures, such as corporations and other businesses, is only marginally profitable because of the high loan administration costs and unavailability of current data for pricing and setting risk rating standards. Under conventional systems and methods, financial information is supplied to the lending institutions by debtor ventures in various formats such as printed reports, faxes, e-mail attachments and spreadsheets. Consequently, lending institutions have increased work loads to format and process pertinent financial data. In addition, typical loan covenants are generally not sufficient to motivate debtor ventures to report financial information on a timely basis. Without timely information, the lending institutions may not effectively manage their loans.

Company officers, board directors and investors, including stakeholders of a venture, require periodic updates on the venture's progress. Ventures can include companies, divisions of corporations, and other projects and undertakings managed under other organizational frameworks. Unfortunately, effective reporting to officers, board directors and investors under conventional circumstances is a significant challenge for busy venture managers, which include entrepreneurs and other leaders of ventures.

Typically, updates sent to investors take much effort and expense to assemble and distribute. When something is overlooked, remedial mailings only add further to the workload and costs involved. Often, the venture managers find themselves somewhat in a vacuum without proper feedback from the officers, board directors and investors since conventional methods do not allow for ways of knowing who of the officers, board directors and investors has reviewed the updates. Lack of feedback becomes more of a problem when financial statements, board minutes or other key data must be changed or corrected.

### SUMMARY OF THE INVENTION

The present invention resides in a method and system for web-based venture reporting. Aspects of the venture reporting system include a server computer having venture data and component applications including venture reporting components, operation components, and security components. In some embodiments the venture data have one or more venture data sets whereas in other embodiments, the venture data are directed to one set. With the embodiments having more than one venture data set, each set is directed to a particular venture. For each venture data set of the plurality of venture data sets, the security components are configured to allow full access to the venture data set to a set of one or more individuals. Each set has different members from one another. The security components are configured to allow at least one individual full access to all venture data sets.

Other aspects are directed to the server computer having component applications including a wizard component configured to guide an individual to set up a venture reporting website. Additional aspects include a method for operating a venture reporting system including receiving payment, granting to an individual associated with the payment access to a wizard to guide the individual in setting up a venture reporting website, and running a wizard component to support the individual in setting up the venture reporting website.

Further aspects include running a server computer hosting more than one venture reporting website, providing access to each venture reporting website to a different set of individuals, allowing different access privileges among at least one of the sets of individuals, and allowing full access privileges to at least one individual to all of the venture reporting websites. Also included are other aspects of a method of doing business related to using a web-based venture reporting system.

Other features and advantages of the invention will become apparent from the following detailed description, taken in conjunction with the accompanying drawings.

### BRIEF DESCRIPTION OF THE DRAWINGS

FIG. 1 is a schematic diagram of a computing system suitable for employing aspects of the present invention for web-based venture reporting.

FIG. 2 is a schematic diagram illustrating an exemplary embodiment of the web based venture reporting system including a venture set.

FIG. 3 is a schematic diagram illustrating an exemplary embodiment of the web based venture reporting system including a plurality of venture sets and a superset administrator client computer.

FIG. 4 is a schematic diagram illustrating dataflow in the exemplary embodiment of the web based venture reporting system of FIG. 3.

FIG. 5 is a flowchart illustrating an initial setup process of an exemplary embodiment of the web based venture reporting system.

FIG. 6 is a screen shot of an exemplary advertisement presented to prospective customer for a venture reporting website of the web based venture reporting system.

FIG. 7 is a screen shot of a welcome displayed upon activation of a signup option selection of the exemplary advertisement of FIG. 6.

FIG. 8 is a screen shot of a wizard welcome displayed upon activation of a wizard option selection of the welcome of FIG. 7.

FIG. 9 is a screen shot of an identification entry displayed upon activation of a next step option selection of the wizard welcome of FIG. 8.

FIG. 10 is a screen shot of a site participant entry displayed upon activation of a skip step option selection of the identification entry of FIG. 9.

FIG. 11 is a screen shot of a new participant entry template displayed upon activation of an add new participant option selection of the site participant entry of FIG. 10.

FIG. 12 is a screen shot of a group management area displayed upon activation of a continue option selection of the new participant entry template of FIG. 11.

FIG. 13 is a screen shot of a welcome page for a venture reporting website of the web based venture reporting system of FIGS. 2 and 3.

FIG. 14 is a screen shot of a welcome—edit page displayed upon activation of an edit option selection of the welcome page of FIG. 13.

FIG. 15 is a screen shot of a financial data page displayed upon activation of a financial data component option selection of FIGS. 13 and 14.

FIG. 16 is a screen shot of a manage financial data page displayed upon activation of an edit control of the financial data page of FIG. 15.

FIG. 17 is a screen shot of a template displayed upon activation of a download template control of the manage financial data page of FIG. 16.

FIG. 18 is a screen shot of a manage financial data—upload advisory page displayed upon activation of an upload data control of the manage financial data page of FIG. 16.

FIG. 19 is flowchart of an exemplary accountant maintenance procedure implemented with the web based venture reporting system of FIGS. 2 and 3.

FIG. 20 is a flowchart of an exemplary venture manager maintenance procedure implemented with the web based venture reporting system of FIGS. 2 and 3.

FIG. 21 is a flowchart of an exemplary superset administrator maintenance procedure implemented with the web based venture reporting system of FIGS. 2 and 3.

FIG. 22 is a screen shot of a high-level page associated with the accountant maintenance procedure of FIG. 19, the venture manager maintenance procedure of FIG. 20, and the superset administrator at maintenance procedure of FIG. 21 and containing a high-level menu.

FIG. 23 is a screen shot of a welcome component page displayed upon activation of an investor relations website selection of the high-level menu of FIG. 22 and containing the high-level menu and a component menu.

FIG. 24 is a screen shot of company description component page displayed upon activation a company description component option selection of the component menu of FIG. 23 and containing the component menu.

FIG. 25 is a screen shot of a management team component page displayed upon activation of a management team component option selection of the component menu of FIGS. 23 and 24 and containing the component menu.

FIG. 26 is a screen shot of a product description component page displayed upon activation of a product description component option selection on the component menu of FIGS. 23-25 and containing the component menu.

FIG. 27 is a screen shot of a market position component page displayed upon activation of a market position component option selection on the component menu of FIGS. 23-26 and containing the component menu.

FIG. 28 is a screen shot of a competitive strategy component page displayed upon activation of a competitive strategy component option selection of the component menu of FIGS. 23-27 and containing the component menu.

FIG. 29 is a screen shot of a next round component page displayed upon activation of a next round component option selection of the component menu of FIGS. 23-28 and containing the component menu.

FIGS. 30-37 are screenshots of a financial data component page displayed upon activation of a financial data component option selection of the component menu of FIGS. 23-29 and containing the component menu and an edit control.

FIG. 38 is a screen shot of a manage financial data page displayed upon activation of the edit control of FIGS. 30-37 and containing the component menu.

FIG. 39 is a screen shot of a revenue sources component page displayed upon activation of a revenue sources component option selection of the component menu of FIGS. 23-38.

FIG. 40 is a screen shot of a business key metrics component page displayed upon activation of a business key metrics component option selection of the component menu of FIGS. 23-39 and containing the component menu.

FIG. 41 is a screen shot of a financial key metrics component page displayed upon activation of a financial key metrics component option selection of the component menu of FIGS. 23-40 and containing the component menu.

FIG. 42 is a screen shot of a partners component page displayed upon activation of the partners component option selection on the component menu of FIGS. 23-41 and containing the component menu.

FIG. 43 is a screen shot of a press releases component page displayed upon activation of a press releases component option selection of the component menu of FIGS. 23-42 and containing the component menu.

FIG. 44 is a screen shot of a press mentions component page displayed upon activation of a press mentions component option selection of the component menu of FIGS. 23-43 and containing the component menu.

FIG. 45 is a screen shot of a FAQ component page displayed upon activation of a FAQ component option selection of the component menu of FIGS. 23-44 and containing the component menu.

FIG. 46 is a screen shot of an analyst reports component page displayed upon activation of an analyst reports component option selection of the component menu of FIGS. 23-45 and containing the component menu.

FIG. 47 is a screen shot of a mission statement component page displayed upon activation of a mission statement component option selection on the component menu of FIGS. 23-46 and containing the component menu.

FIG. 48 is a screen shot of a directors component page displayed upon activation on a directors component option selection on the component menu of FIGS. 23-47 and containing the component menu.

FIG. 49 is a screen shot of an advisory board component page displayed upon activation of an advisory board component option selection of the component menu of FIGS. 23-48 and containing the component menu.

FIG. 50 is a screen shot of an SEC filings component page displayed upon activation of an SEC filings component option selection of the component menu of FIGS. 23-49 and containing the component menu.

FIGS. 51A and 51B is a screen shot of a disclaimer component page displayed upon activation of a disclaimer's component option selection of the component menu of FIGS. 23-50 and containing the component menu.

FIG. 52 is a screen shot of a site participant page displayed upon activation of a site participants option selection of the high-level menu of FIGS. 22 and 23 and containing the high-level menu.

FIG. 53 is a screen shot of a group page displayed upon activation of an investor groups option selection of the high-level menu of FIGS. 22-23 and 52 and containing the high-level menu.

FIG. 54 is a screen shot of a broadcast e-mail history page based upon activation of a broadcast e-mail option selection of the high-level menu of FIGS. 22-23 and 52-53 and containing the high-level menu.

FIG. 55 is a screen shot on a calendar of the events page displayed upon activation of a calendar of the events option selection of the high-level menu of FIGS. 22-23 and 52-54 and containing the high-level menu.

FIG. 56 is a screen shot of a list of active surveys page based upon activation of a survey option selection of the high-level menu on FIGS. 22-23 and 52-55 and containing the high-level menu.

FIG. 57 as a screen shot of and activities reporting page displayed upon activation on and activity reports option selection on the high-level menu of FIGS. 22-23 and 52-56 and containing the high-level menu.

FIG. 58 is a screen shot of a private investor relations site layout page displayed upon activation of a site layout option selection of the high-level menu of FIGS. 22-23 and 52-57 and containing the high-level menu.

FIG. 59 is a screen shot of a profile maintenance menu page displayed upon activation on a my profile option selection of the high-level menu of FIGS. 22-23 and 52-57 and containing the high-level menu.

FIG. 60 is a flowchart of an exemplary and user procedure used with the web based venture reporting system of FIGS. 2 and 3.

FIG. 61 is a screen shot of a high-level page associated with the end-user procedure of FIG. 60 and containing a high-level menu.

FIG. 62 is a screen shot of a welcome component page displayed upon activation of an investor relations website selection on the high-level menu of FIG. 61 and containing a component menu.

FIG. 63 is a screen shot of a company description component page displayed upon activation of a company description option selection of the component menu of FIG. 62 and containing the component menu.

FIG. 64 is a screen shot of a financial data component page displayed upon activation of a financial data option selection of the component menu of FIGS. 62 and 63 and containing the component menu.

FIGS. 65A and 65B are screenshots on a disclaimer component page displayed upon activation of a disclaimer's option selection of the component menu of FIGS. 62-64 and containing the component menu.

FIG. 66 is a screen shot of an alternative embodiment of the welcome component page of FIG. 62.

FIG. 67 is a screen shot of a calendar of the events page displayed upon activation of a calendar of events option selection of the high-level menu of FIG. 61 and containing the high-level menu.

FIG. 68 is a screen shot of a profile maintenance page displayed upon activation on a my profile option selection of the high-level menu of FIG. 61 and 67 and containing the high-level menu.

FIG. 69 is a schematic diagram of an exemplary embodiment the server computer of the web based venture reporting system of FIGS. 2 and 3 showing component details.

FIG. 70 is a flowchart of a main procedure associated with a main application component of the exemplary server computer embodiment of FIG. 69.

FIG. 71 is a flowchart of a site wizard procedure associated with a site wizard application component of the exemplary server computer embodiment of FIG. 69.

FIG. 72 is a flowchart of a component managers procedure associated with a component manager application of the exemplary server computer embodiment of FIG. 69.

FIG. 73 is a flowchart of a standard display process for component types found with the exemplary server computer embodiment of FIG. 69.

FIG. 74 is a flowchart of a group security manager procedure associated with a group security manager application component of the exemplary server computer embodiment of FIG. 69.

FIG. 75 is a flowchart of an activity reports manager procedure associated with an activity monitor component application of the exemplary server computer embodiment of FIG. 69.

FIG. 76 is a participant manager procedure associated with a participant manager component application of the exemplary server computer embodiment of FIG. 69.

FIG. 77 is a flowchart of an e-mail manager procedure associated with an e-mail manager component application of the exemplary server computer embodiment of FIG. 69.

FIG. 78 is a flowchart of an event manager procedure associated with an event manager component application of the exemplary server computer embodiment of FIG. 69.

FIG. 79 is a flowchart of a survey manager procedure associated with a survey manager component application of the exemplary server computer embodiment of FIG. 69.

FIG. 80 is a flowchart of a site layout manager procedure associated with the site layout manager component application of the exemplary server computer embodiment of FIG. 69.

FIG. 81 is a flowchart of a profile manager procedure associated with a profile manager component application of the exemplary server computer embodiment of FIG. 69.

FIG. 82 is a flowchart of a component update manager procedure associated with a component update manager component application of the exemplary server computer embodiment of FIG. 69.

FIG. 83 is a flowchart of a financial display manager procedure associated with a financial display manager component application of the exemplary server computer embodiment of FIG. 69.

FIG. 84 is a flowchart of a financial upload manager procedure associated with a financial upload manager of the exemplary server computer embodiment of FIG. 69.

### DETAILED DESCRIPTION OF THE INVENTION

A system and method for web-based venture reporting is described herein. In exemplary embodiments, the web-based venture reporting system allows for secure distribution of venture related information, including financial reports, mission statements, and business strategies to loaning institutions, investors, officers, board directors and others having interest in the venture, in a convenient and attractive manner. Ventures, such as privately held companies, can take advantage of the web-based venture reporting system to efficiently communicate venture related matters. Busy venture managers have a web-based platform to showcase the venture's progress in a secure and efficient manner. Lending institutions can also provide a mechanism through the web-based venture reporting system for their venture clients to provide loan compliance data.

Embodiments of the web-based venture reporting system can be accessed through the Internet or other wide-area or local area networks through a web-based browser on a client computer. Some embodiments of the web-based reporting system have security features to allow data for multiple ventures to co-exist under separate venture reporting websites on the same web-based venture reporting system supported by one of more server computers while segregating access to venture data on the separate venture reporting websites to those associated with a particular venture. Security features also allow for inter-venture privileges to access data of all venture reporting websites for all ventures found with the particular web-based venture reporting system. Intra-venture groups of individuals, such as venture managers, venture officers and directors, investors, and accountants can have various levels of access to data of a particular venture.

A venture reporting service provider, such as a bank, venture capital firm, or other can sell a venture reporting service as furnished by the web-based venture reporting system. As an example, once a venture manager purchases a venture reporting service from the venture reporting service provider, the venture manager can set up a venture reporting website using a wizard component of the web-based venture reporting system. The venture reporting website has certain restrictions depending upon the type of individual trying to access the website. In some embodiments, the venture reporting service provider can retain inter-venture access to all data on all venture reporting websites for all ventures within the web-based venture reporting system. Inter-venture access is useful for cases such as when ventures have obtained funds from the venture reporting service provider, such as with a bank or venture capital firm that is also the venture reporting service provider.

In the following description, numerous specific details are provided to provide a thorough understanding of embodiments of the invention. One skilled in the relevant art, however, will recognize that the invention can be practiced without one or more of these specific details, or with other equivalent elements and components, etc. In other instances, well-known components and elements are not shown, or not described in detail, to avoid obscuring aspects of the invention or for brevity.

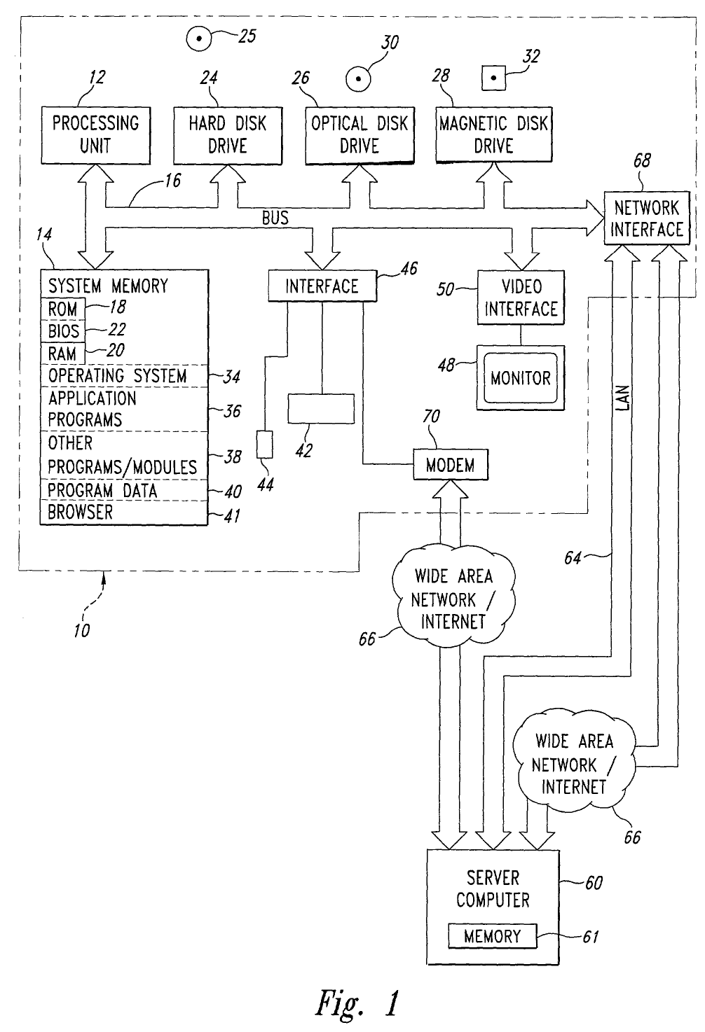

FIG. 1 and the following discussion provide a brief, general description of a suitable computing environment in which the invention can be implemented. Although not required, embodiments of the invention will be described in the general context of computer-executable instructions, such as program application modules, objects, or macros being executed by a personal computer. Those skilled in the relevant art will appreciate that the invention can be practiced with other computer system configurations, including hand-held devices, multiprocessor systems, microprocessor-based or programmable consumer electronics, network PCs, mini computers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 1, a conventional personal computer, referred to herein as a client computer 10, includes a processing unit 12, a system memory 14 and a system bus 16 that couples various system components including the system memory to the processing unit. The client computer 10 will at times be referred to in the singular herein, but this is not intended to limited the application of the invention to a single client computer since in typically embodiments, there will be more than one client computer involved. The processing unit 12 may be any logic processing unit, such as one or more central processing units (CPUs), digital signal processors (DSPs), application-specific integrated circuits (ASIC), etc. Unless described otherwise, the construction and operation of the various blocks shown in FIG. 1 are of conventional design. As a result, such blocks need not be described in further detail herein, as they will be understood by those skilled in the relevant art.

The system bus 16 can employ any known bus structures or architectures, including a memory bus with memory controller, a peripheral bus, and a local bus. The system memory 14 includes read-only memory (“ROM”) 18 and random access memory (“RAM”) 20. A basic input/output system (“BIOS”) 22, which can form part of the ROM 18, contains basic routines that help transfer information between elements within the client computer 10, such as during start-up.

The client computer 10 also includes a hard disk drive 24 for reading from and writing to a hard disk 25, and an optical disk drive 26 and a magnetic disk drive 28 for reading from and writing to removable optical disks 30 and magnetic disks 32, respectively. The optical disk 30 can be a CD-ROM, while the magnetic disk 32 can be a magnetic floppy disk or diskette. The hard disk drive 24, optical disk drive 26 and magnetic disk drive 28 communicate with the processing unit 12 via the bus 16. The hard disk drive 24, optical disk drive 26 and magnetic disk drive 28 may include interfaces or controllers (not shown) coupled between such drives and the bus 16, as is known by those skilled in the relevant art. The drives 24, 26 and 28, and their associated computer-readable media, provide nonvolatile storage of computer readable instructions, data structures, program modules and other data for the client computer 10. Although the depicted client computer 10 employs hard disk 25, optical disk 30 and magnetic disk 32, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 14, such as an operating system 34, one or more application programs 36, other programs or modules 38 and program data 40. The system memory 14 also includes a browser 41 for permitting the client computer 10 to access and exchange data with sources such as web sites of the Internet, corporate intranets, or other networks as described below, as well as other server applications on server computers such as those further discussed below. The browser 41 in the depicted embodiment is markup language based, such as Hypertext Markup Language (HTML) or Extensible Markup Language (XML) or Wireless Markup Language (WML), and operates with markup languages that use syntactically delimited characters added to the data of a document to represent the structure of the document. Although the depicted embodiment shows the client computer 10 as a personal computer, in other embodiments, the client computer is some other computer related device such as a personal data assistant (PDA) or a cell phone or other mobile device.

While shown in FIG. 1 as being stored in the system memory 14, the operating system 34, application programs 36, other programs/modules 38, program data 40 and browser 41 can be stored on the hard disk 25 of the hard disk drive 24, the optical disk 30 of the optical disk drive 26 and/or the magnetic disk 32 of the magnetic disk drive 28. A user can enter commands and information into the client computer 10 through input devices such as a keyboard 42 and a pointing device such as a mouse 44. Other input devices can include a microphone, joystick, game pad, scanner, etc. These and other input devices are connected to the processing unit 12 through an interface 46 such as a serial port interface that couples to the bus 16, although other interfaces such as a parallel port, a game port or a wireless interface or a universal serial bus (“USB”) can be used. A monitor 48 or other display device is coupled to the bus 16 via a video interface 50, such as a video adapter. The client computer 10 can include other output devices, such as speakers, printers, etc.

The client computer 10 can operate in a networked environment using logical connections to one or more remote computers, such as a server computer 60. The server computer 60 can be another personal computer, a server, another type of computer, or a collection of more than one computer communicatively linked together and typically includes many or all of the elements described above for the client computer 10 including memory 61. The server computer 60 is logically connected to one or more of the client computers 10 under any known method of permitting computers to communicate, such as through a local area network (“LAN”) 64 or a wide area network (“WAN”) or the Internet 66. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a LAN networking environment, the client computer 10 is connected to the LAN 64 through an adapter or network interface 68 (communicatively linked to the bus 16). When used in a WAN networking environment, the client computer 10 often includes a modem 70 or other device, such as the network interface 68, for establishing communications over the WAN/Internet 66. The modem 70 is shown in FIG. 1 as communicatively linked between the interface 46 and the WAN/Internet 66. In a networked environment, program modules, application programs, or data, or portions thereof, can be stored in the server computer 60. In the depicted embodiment, the client computer 10 is communicatively linked to the server computer 60 through the LAN 64 or the WAN/Internet 66 with TCP/IP middle layer network protocols; however, other similar network protocol layers are used in other embodiments. Those skilled in the relevant art will readily recognize that the network connections shown in FIG. 1 are only some examples of establishing communication links between computers, and other links may be used, including wireless links.

An exemplary embodiment of the invention is implemented in the Sun Microsystems Java programming language to take advantage of, among other things, the cross-platform capabilities found with the Java language. For instance, exemplary embodiments include the server computer 60 running Windows NT, Win2000, Solaris, and Linux operating systems. In exemplary embodiments, the server computer 60 runs Apache Tomcat/Tomcat Jakarta web server or Microsoft Internet Information Server (ISS) web server, or BEA Weblogic web server.

Apache is a freely available Web server that is distributed under an “open source” license and runs on most UNIX-based operating systems (such as Linux, Solaris, Digital UNIX, and AIX), on other UNIX/POSIX-derived systems (such as Rhapsody, BeOs, and BS2000/OSD), on AmigaOS, and on Windows NT/95/98. Windows-based systems with Web servers from companies such as Microsoft, and Netscape are alternatives, but Apache web server seems suited for enterprises and server locations (such as universities) where UNIX-based systems are prevalent. Other embodiments use other web servers and programming languages such as C, C++, and C#.

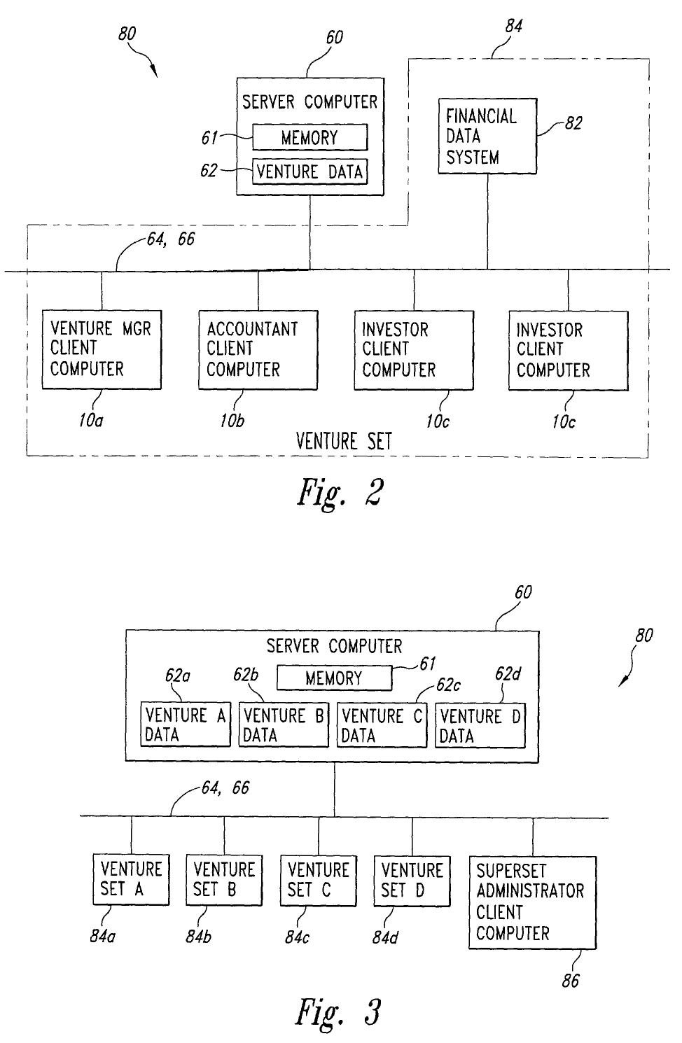

Exemplary embodiments of a web-based venture reporting system 80 of the present invention are shown in FIGS. 2 and 3. When only one particular venture is being supported by the web-based venture reporting system 80, the server computer 60 stores venture data 62 related to the particular venture so that one or more of the client computers 10 can be used to access and possibly update the venture data depending upon the access privileges afforded the particular individual using the client computer. For instance, as shown in FIG. 2, one or more of the client computers 10 could include a venture manager client computer 10a, which is one of the client computers 10 being used by a venture manager and could also include an accountant client computer 10b, which is one of the client computers 10 being used by an accountant wherein both the venture manager and the accountant have access privileges to read, write, and update the venture data 62.

Other of the client computers 10 could include one or more investor client computers 10c, which are client computers 10 being used by investors who typically would have privileges to read much of the venture data 62, but limited privileges to write or update the venture data. These access privileges can be managed with user groups in some embodiments wherein a particular individual is assigned certain access privileges based upon which one of possibly several user groups the individual is assigned. Other embodiments assign access privileges on an individual basis without user groups.

The exemplary web-based venture reporting system 80 also includes a financial data system 82 that stores original financial data of the venture that was generated before being transferred to the server computer 60. The process for transferring financial data from the financial data system 82 to the server computer 60 is explained in further detail below. A network of one or more of the client computers 10 and the financial data system 82 that are all directed to a particular venture can be referred to as a venture set 84.

As shown in FIG. 3, the server computer 60 can store more than one of the venture data 62, such as venture A data 62a, venture B data 62b, venture C data 62c, venture D data 62d, and so on. Likewise, the server computer 60 can be networked with more than one venture set 84, such as venture A set 84a, venture B set 84b, venture C set 84c, venture D set 84d, and so on. In this case where the server computer 60 serves more than one of the venture sets 84 and stores more than one of the venture data 62, the web-based venture reporting system 80 provides multiple venture reporting websites and also allows for a superset administrator client computer 86, which is one of the client computers 10 being used by a superset administrator who has security access rights to read, write, and update all of the more than one venture data 62, 62a, 62b, etc. The superset administrator typically would be one or more designated individuals from a venture reporting service provider, such as a bank or venture capital firm, but could also be some other so designated one or more individuals.

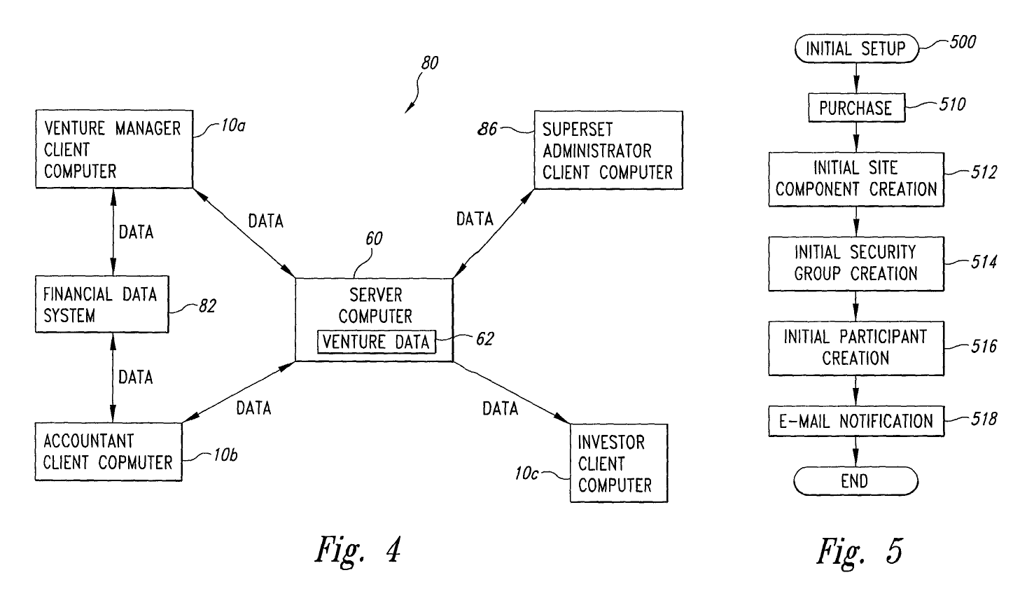

Data flow with respect to a particular venture for the exemplary embodiment of the web-based venture reporting system 80 is shown in FIG. 4 to include two-way data flow between the following pairs: the venture manager client computer 10a and the financial data system 82, the venture manager client computer 10a and the server computer 60, the accountant client computer 10b and the financial data system 82, the accountant client computer 10b and the server computer 60, and the superset administrator client computer 86 and the server computer 60. As shown, the superset administrator client computer in this example does not have access to the financial data system 82 so would not be necessarily updating financial data stored as part of the venture data 62 on the server computer 60. Although data flow is only shown as one-way going from the server computer 60 to the investor client computer 10c, in some embodiments, the investor client computer 10c may have limited access to update a small portion of venture data 62 directly related to a particular investor using the investor client computer such as personal contact data for the particular investor.

As an example of initial setup (step 500 of FIG. 5) of a financial reporting website, a venture manager would first purchase (step 510) the financial reporting website to service their venture from a financial reporting service provider. Using a wizard component of the web-based financial reporting system 80 described in detail below, the financial manager would create site components (step 512) to be used with the financial reporting website. Security groups would then be created (step 514) that contain group descriptions and specified access privileges to the financial reporting website. Access privileges are generally specified in terms of read, write, and update capabilities for various components contained within the financial reporting website. Identification of individual participants are then created (step 516). E-mail notifications are automatically sent to the individual participants (step 518) to notify them of their newly created memberships to the venture reporting website of the particular venture and to provide instructions regarding accessing the venture reporting website to allow access for the individuals.

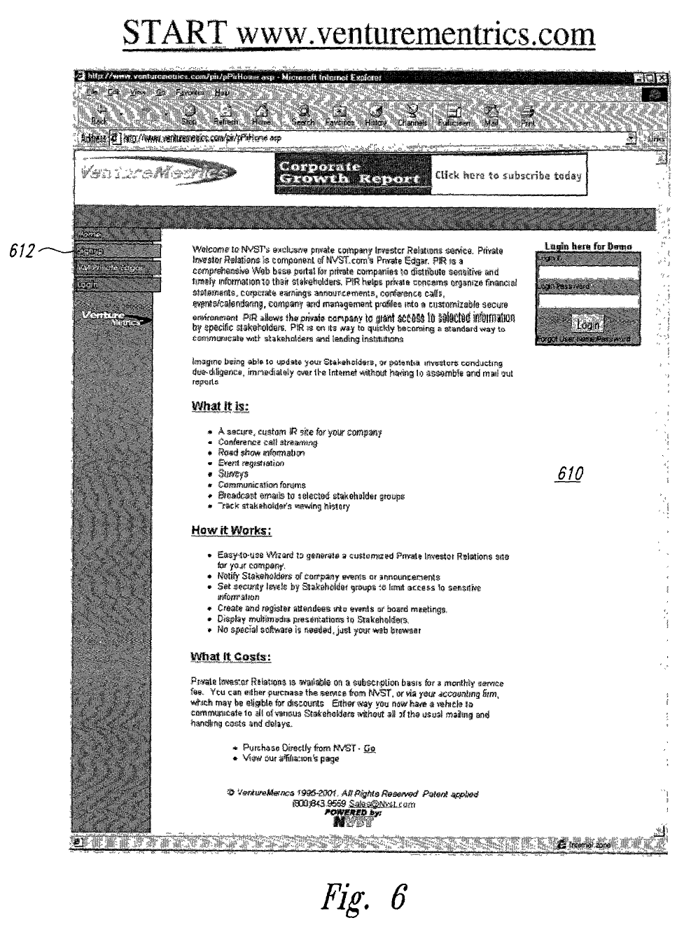

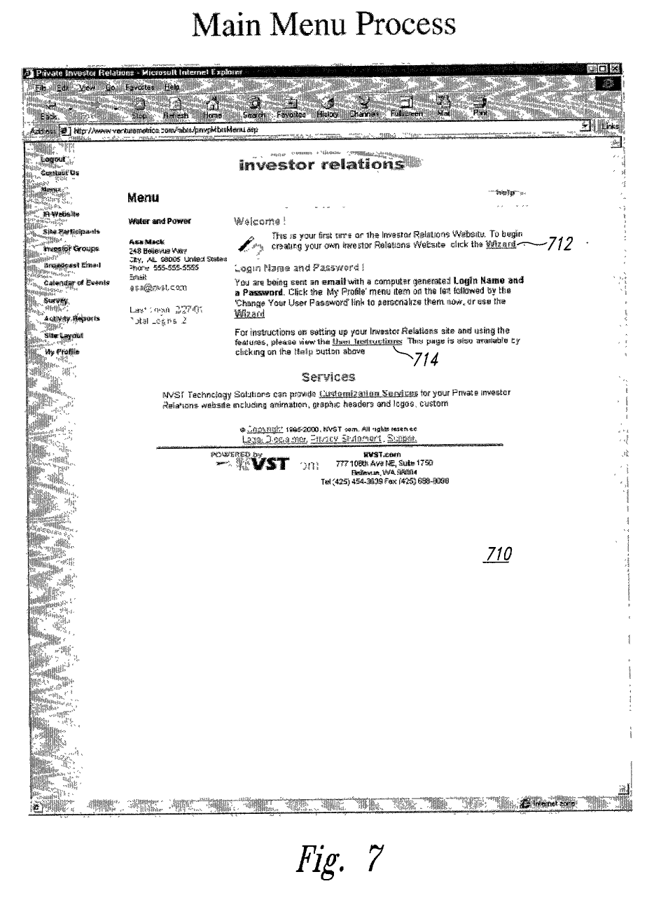

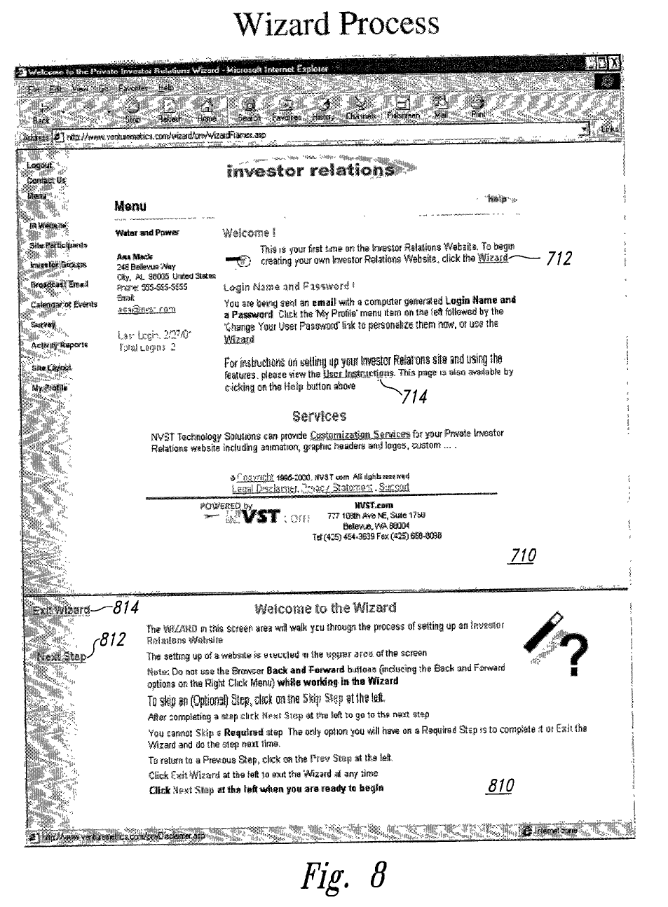

A screen shot of an exemplary advertisement 610 presented to a prospective customer for a venture reporting website is shown in FIG. 6. The advertisement 610 includes descriptions of how a venture reporting website could benefit those associated with a venture and includes a signup option selection 612. Upon activation of the signup option selection 612, a welcome 710 is displayed as shown in FIG. 7. The welcome 710 includes a wizard option selection 712 and a user instructions option selection 714. Upon activation of the wizard option selection 712, a wizard welcome 810 is displayed as shown in FIG. 8. The wizard welcome 810 includes a next step option selection 812 and an exit wizard option selection 814.

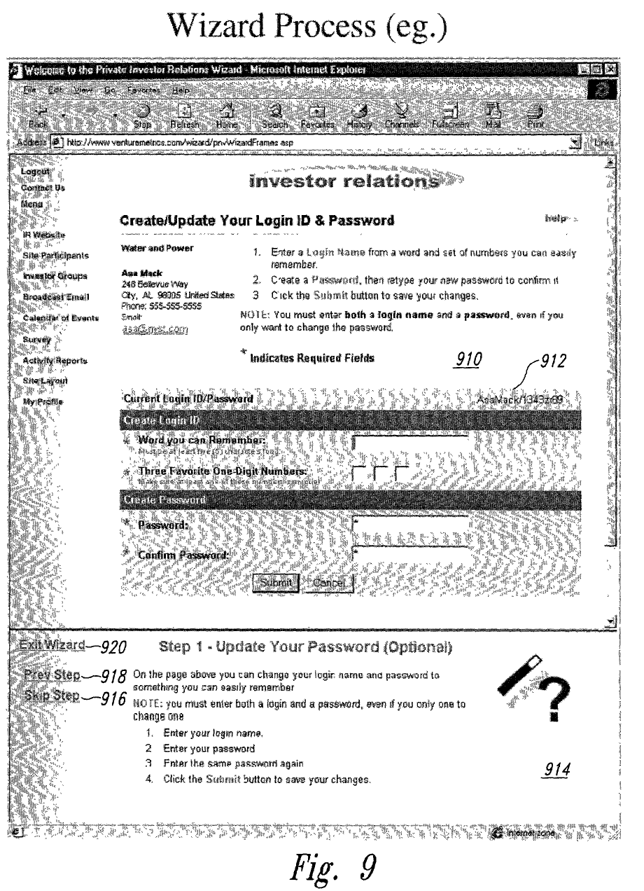

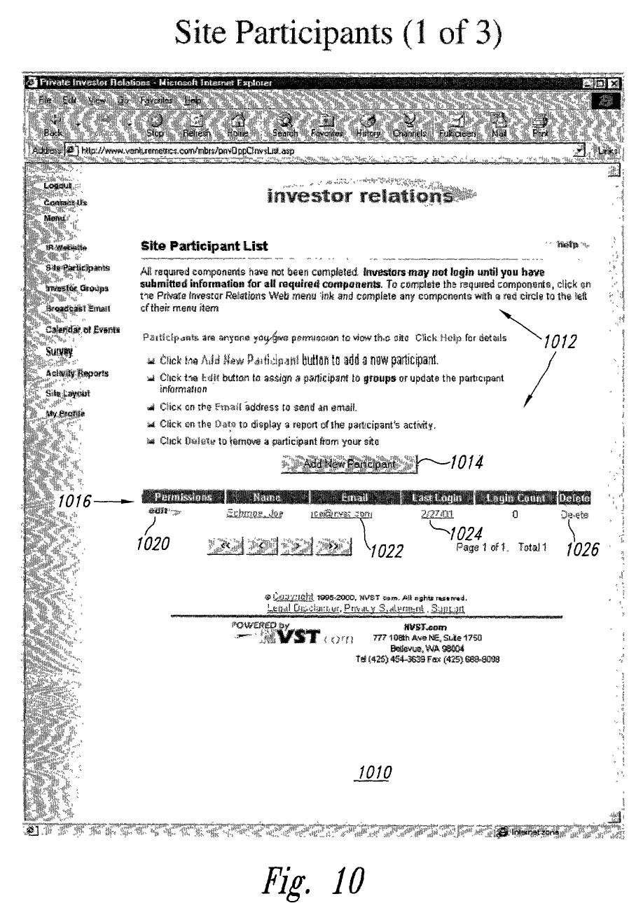

Upon activation of the next step option selection 812, an identification entry 910 is displayed as shown in FIG. 9. The identification entry 910 includes an identification template 912 to allow entry of the venture managers user identification and associated password to allow entry into the venture reporting website. The identification entry 910 includes entry instructions 914 to update passwords and also includes a skip step option selection 916, a previous step option selection 918, and an exit wizard option selection 920.

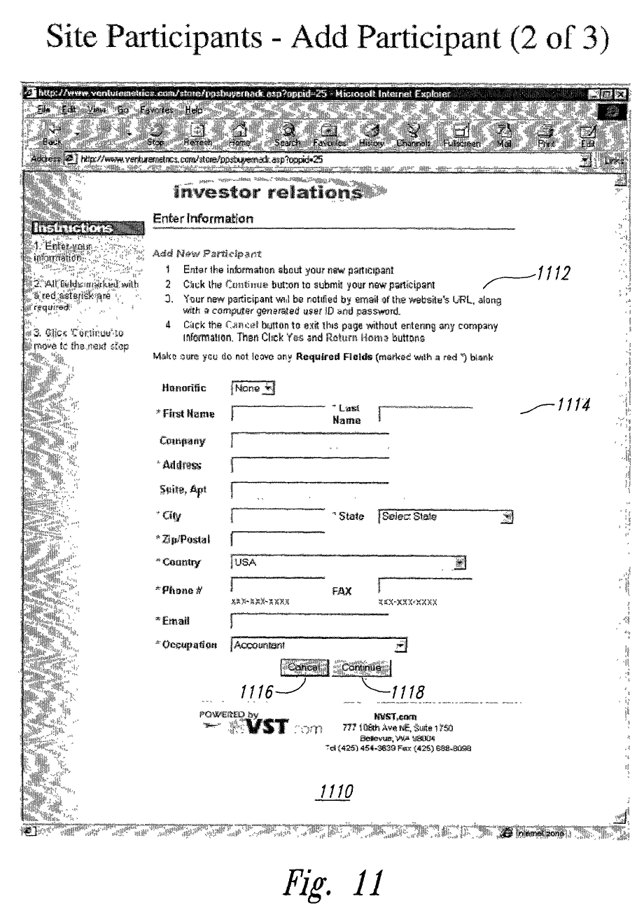

Upon activation of the skip step option selection 916, a site participant entry 1010 is displayed as shown in FIG. 10. The site participant entry 1010 includes a participant entry instruction 1012, an add new participant selection option 1014 to add a new participant, and a current participant display 1016. The current participant display 1016 further includes an edit option selection 1020 to assign a participant to one or more groups or to update information regarding a participant, and an e-mail option selection 1022 to send e-mail to a participant, a date option selection 1024 to display a report of the participants activity, and a delete option selection 1026 to remove a participant from the venture reporting website.

Upon activation of the add new participant option selection 1014, a new participant entry template 1110 is displayed as shown in FIG. 11. The new participant entry template 1110 includes entry instructions 1112, and an entry form 1114. The new participant entry template 1110 further includes a cancel option selection 1116 to exit the new participant entry template without entering data for a new participant and a continue option selection 1118 to submit data on a new participant for the venture reporting website.

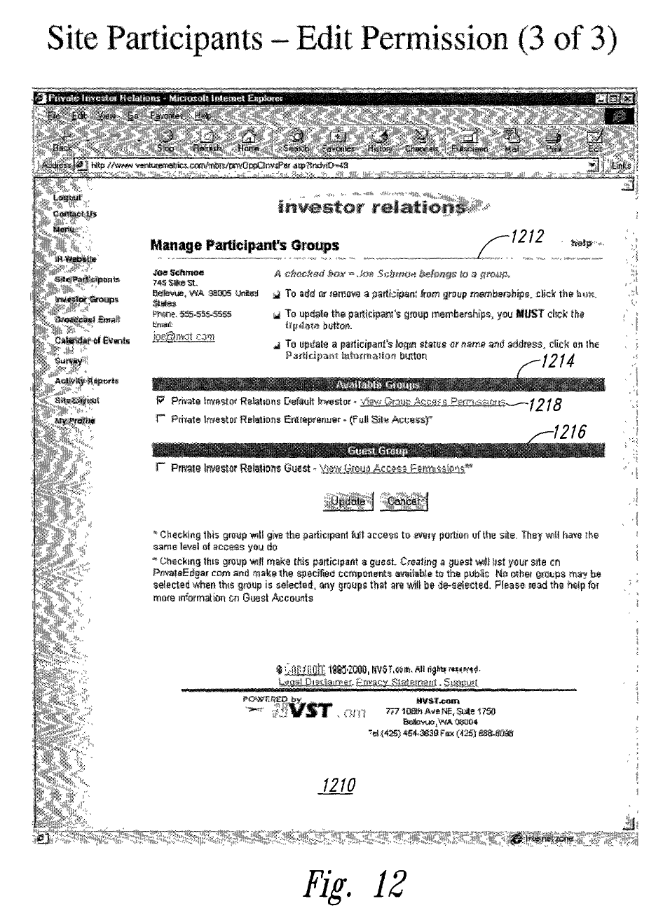

Upon activation of the continue option selection 1118, a group management area 1210 is displayed as shown in FIG. 12. The group management area 1210 includes group management instructions 1212, an available groups area 1214, and a guest group area 1216. As shown in FIG. 12, the available groups area 1214 allows for display of groups associated with the venture reporting website. In this case the venture reporting website has a private investor relations default investor group and a private investor relations entrepreneur group that has full site access. The private investor relations default investor group also has a view group access permissions option selection 1218 to view the access permissions of the individual participants that are associated with this group.

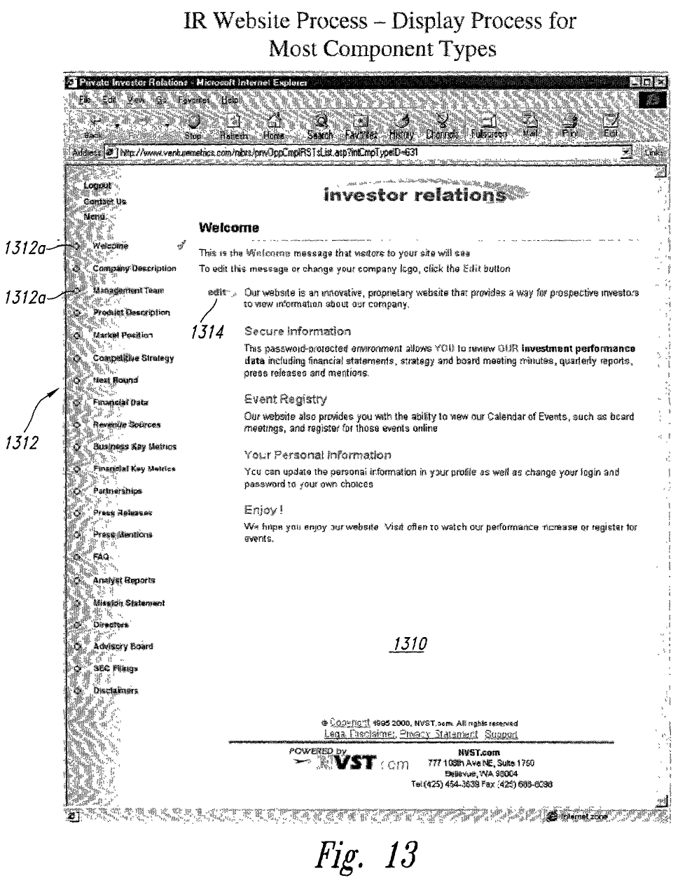

The venture reporting website for a particular venture also includes website components. An exemplary list of website components are shown in FIG. 13 as part of a welcome page 1310. The welcome page 1310 has component option selections 1312 including a welcome component, a company description component, a management team component, a product description component, a market position component, a competitive strategy component, a next round component, a financial data component, a revenue sources component, a business key metrics component, a financial key metrics component, a partnerships component, a press releases component, a press mentions component, a FAQ component, an analyst reports component, a mission statement component, a directors component, an advisory board component, an SEC filings component, and a disclaimers component. Each of the component option selections 1312 has an indicator 1312a, which indicates whether the particular component has been supplied satisfactorily with initial data. In some embodiments, the indicator 1312a furnishes indication by color, whereas in other embodiments, the indicator furnishes indication by the particular shape of the indicator, or the presence or absence of the indicator.

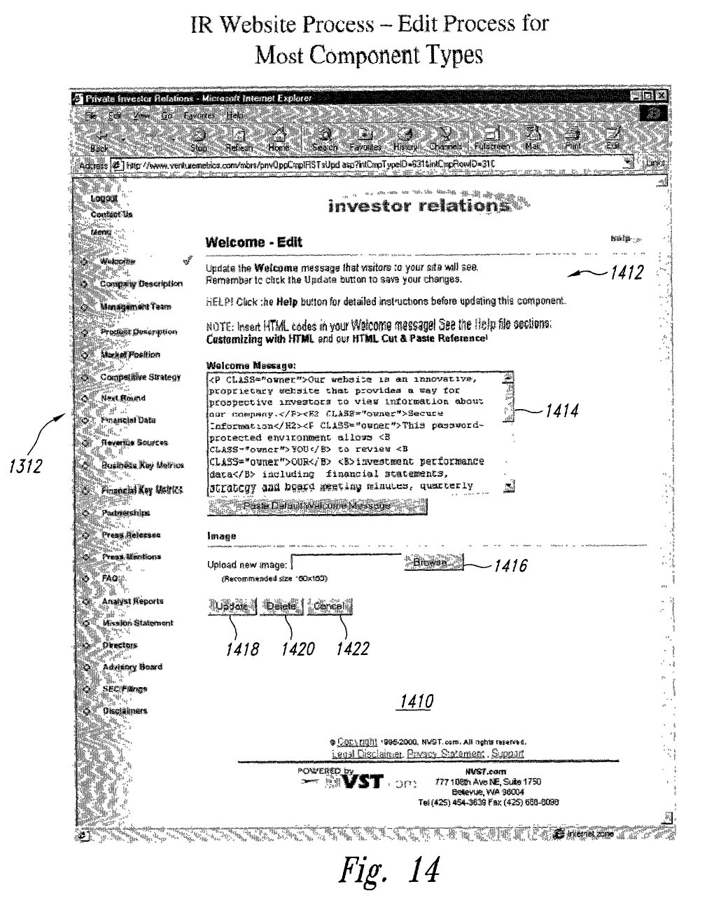

The welcome page 1310 further includes an edit option selection 1314. Upon activation of the edit option selection 1314, a welcome—edit page 1410 is displayed as shown in FIG. 14. The welcome—edit page 1410 includes edit instructions 1412 and a welcome message edit field 1414 to edit a welcome message that is displayed to the investors and others upon entrance into the venture reporting website. The welcome—edit page 1410 also includes an upload control 1416 used to obtain images for display on the welcome page of the venture reporting website. An update control 1418 is used to save changes. A delete control 1420 is used to delete changes and a cancel control 1422 is used to cancel operations performed within the welcome—edit page 1410.

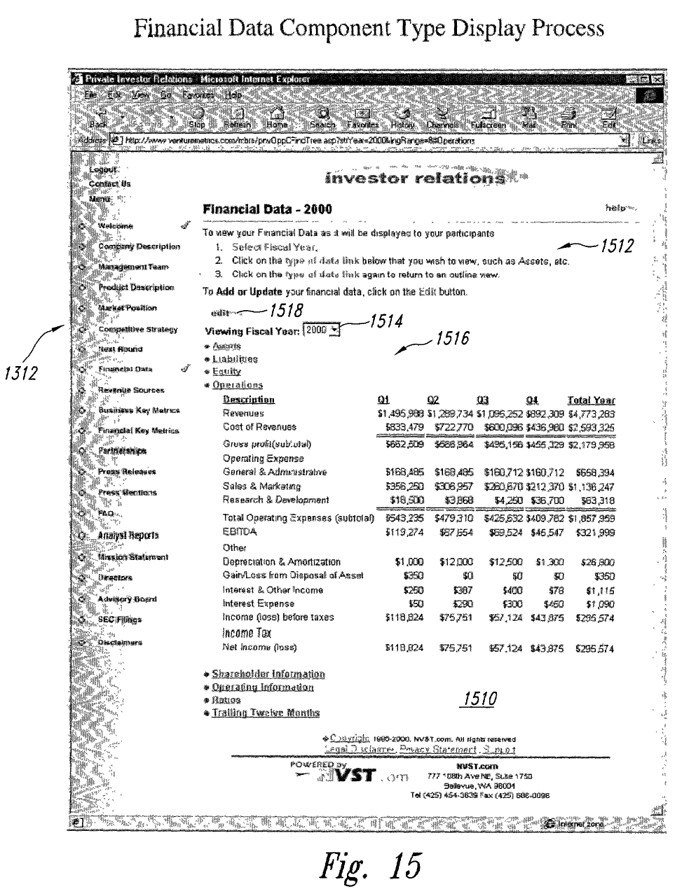

Upon activation of the financial data component option selection of the component option selections 1312, a financial data page 1510 is displayed as shown in FIG. 15. The financial data page 1510 includes an instructions section 1512, year selection control 1514, and financial data 1516 which is selected for display through hyperlink methods. As shown in FIG. 15, a hyperlink control for operations financial data has been selected for expansion to show detailed financial data for venture operations. The financial data page 1510 also includes an edit control 1518 for updating the financial data 1516.

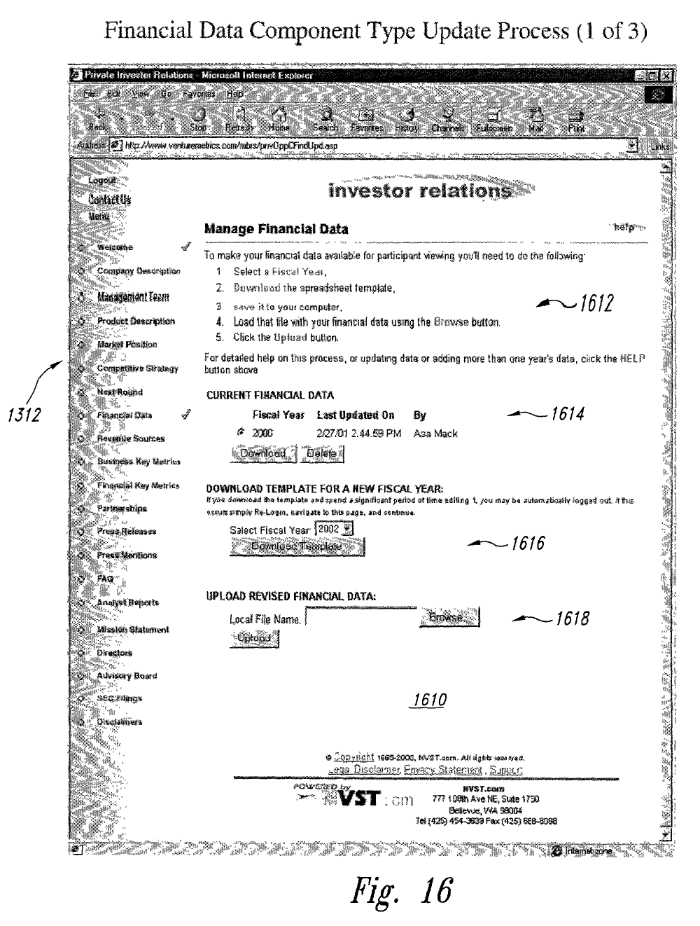

Upon activation of the edit control 1518 of the financial data page 1510, a manage financial data page 1610 is displayed as shown in FIG. 16. The manage financial data page 1610 includes manage instructions 1612, current financial data download control 1614, download template control 1616, and upload data control 1618. The current financial data download control 1614 allows a user of the manage financial data page 1610 to download, view and edit financial data for a current year as displayed by the current financial data download control. The current financial data download control 1614 also includes a delete control which allows deletion of financial data for the current year displayed.

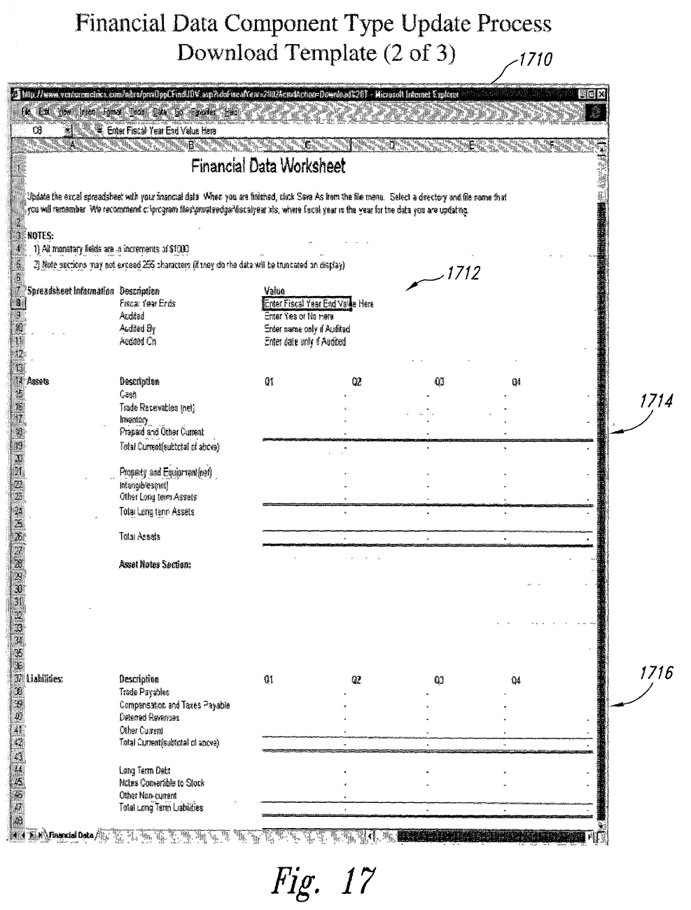

The download template control 1616 allows a user of the manage financial data page 1610 to download a template 1710, as shown in FIG. 17, which the user can then fill with financial data obtained from the financial data system 82 (see FIG. 4). The template 1710 as shown in FIG. 17 is spreadsheet based on Excel spreadsheet software by Microsoft Corporation of Redmond, Wash. Other embodiments use templates from other spreadsheet programs such as Lotus software of the former Lotus Development Corporation, now acquired by International Business Systems. The template 1710 includes a spreadsheet information section 1712, an assets section 1714, and a liability section 1716. In exemplary embodiments, the user of the manage financial data page 1610 uses an input of the client computer 10 such as the keyboard 42 to manually enter data from the financial data system 82 into the template 1710. In other embodiments, transfer of data from the financial data system 82 into the template 1710 is automated.

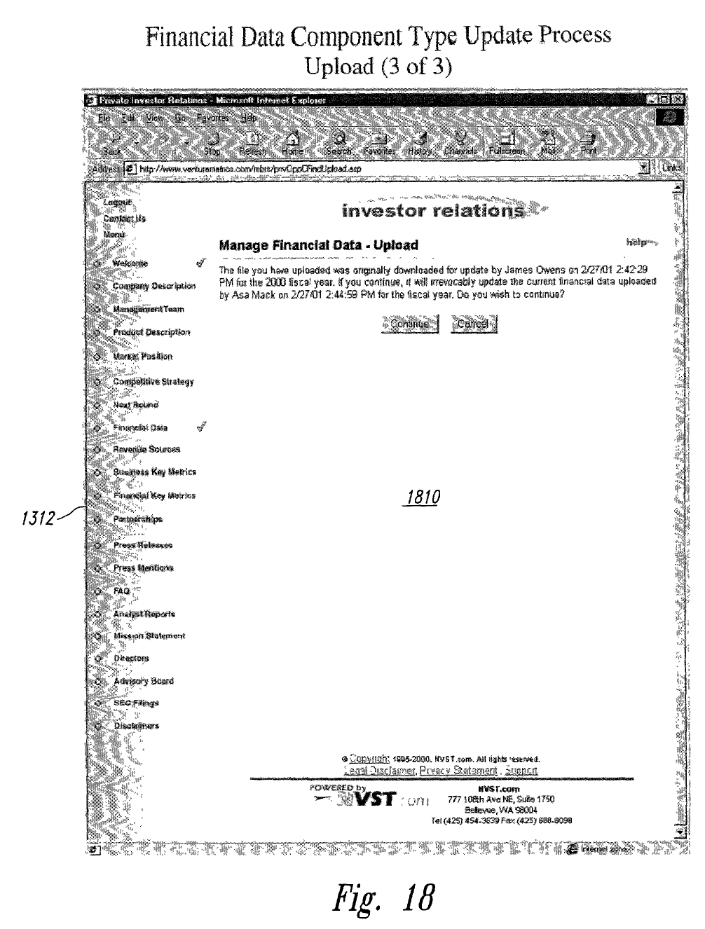

Once the template 1710 is filled with data from the financial data system 82 to the satisfaction of the user of the manage financial data page 1610, the upload data control 1618 (see FIG. 16) is activated to upload the template full of financial data to the server computer 60 for display under the financial data component of the venture reporting website. Upon activation of the upload data control 1618, a manage financial data—upload advisory page 1810 is displayed as shown in FIG. 18. The manage financial data—upload advisory page 1810 includes an advisory message explaining previous actions regarding updating and editing operations of associated financial data and also includes continue and cancel controls to verify or abort upload operations.

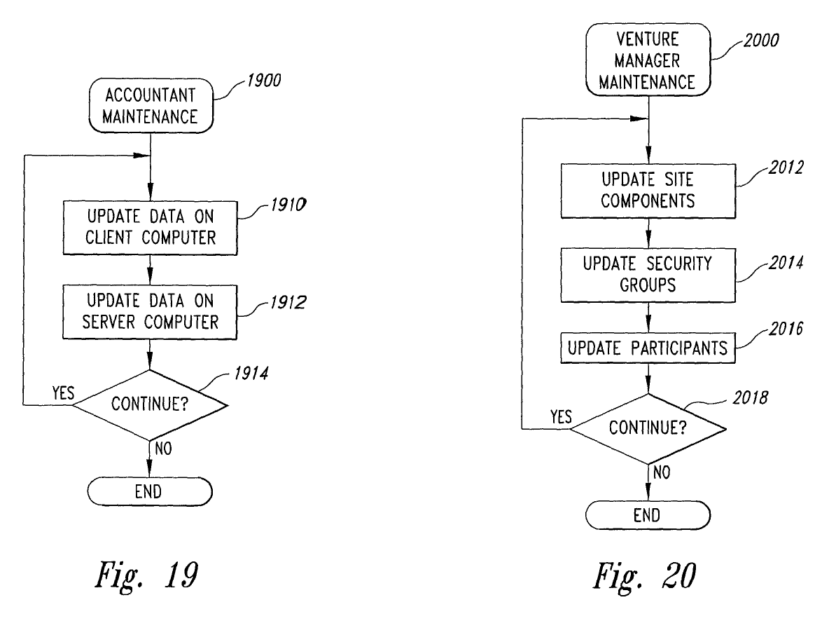

An exemplary accountant maintenance procedure 1900 is shown in FIG. 19. The client computer 10 used by an accountant as the accountant client computer 10b, displays financial data from the financial data system 82 whereby the accountant, using an input of the accountant client computer 10b such as the keyboard 42, manually transfers the financial data into the template 1710. Transfer of financial data into the template 1710 is generally the extent to which the accountant updates data on the client computer (step 1910). Once the template 1710 (see FIG. 17) contains updated financial data, it is uploaded to the server computer 60 (step 1912) to update the venture data 62 related to financial data. The accountant maintenance procedure 1900 continues as a yes branch of step 1914 until no further maintenance is needed (no branch of step 1914).

An exemplary venture manager maintenance procedure 2000 is shown in FIG. 20. The client computer 10 used by a venture manager as the venture manager client computer 10a, updates the venture data 62 for selected components of the venture reporting website (step 2012), updates identification, security and other of the venture data 62 associated with participant groups (step 2014), and updates identification, security and other of the venture data 62 associated with participants (step 2016) of the venture reporting website. The venture manager maintenance procedure 2000 continues as a yes branch of step 2018 until no further maintenance is needed (no branch of step 2018).

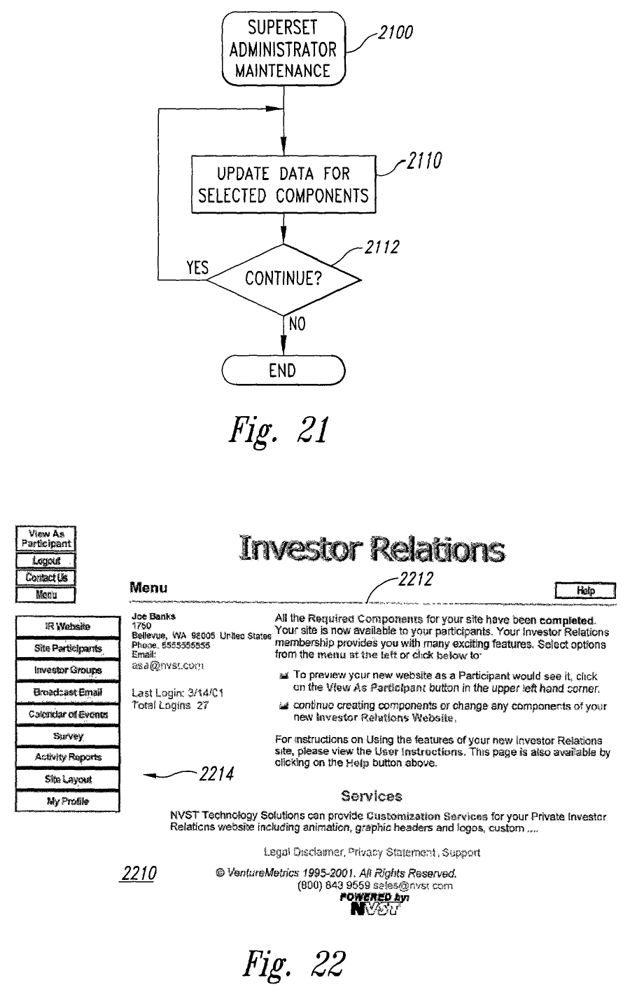

An exemplary superset administrator maintenance procedure 2100 is shown in FIG. 21. The client computer 10 used by a superset administrator as the superset administrator client computer 86, updates the venture data 62 for selected components of the venture reporting website (step 2110). The superset administrator maintenance procedure 2100 continues as a yes branch of step 2112 until no further maintenance is needed (no branch of step 2112).

A high-level page 2210, as shown in FIG. 22, is associated with the accountant maintenance procedure 1900, the venture manager maintenance procedure 2000, and the superset administrator maintenance procedure 2100. The high-level page 2210 includes an advisory information section 2212 and a high-level menu 2214 of option selections. The option selections of the high-level menu 2214 include an investor relations (IR) website selection, a site participants selection, an investor groups selection, a broadcast e-mail selection, a calendar of events selection, a survey selection, an activity reports selection, a site layout selection, and a my profile selection. The option selections of the high-level menu 2214 are used by the accountant, the venture manager, the superset administrator, and others with proper access privileges to view and update venture data 62 of the venture reporting website.

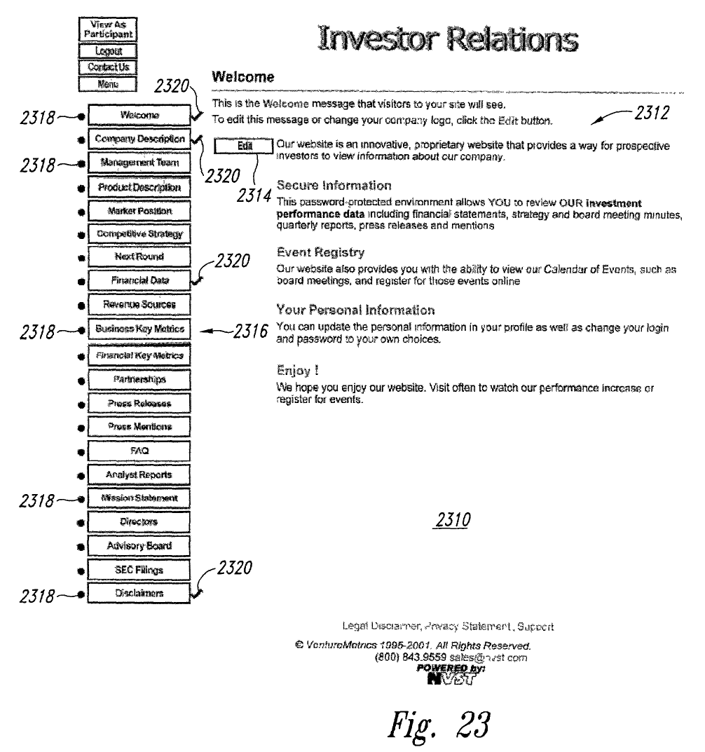

Upon activation of the investor relations website selection of the high-level menu 2214, a welcome component page 2310 is displayed for viewing by the venture manager and updating purposes, rather than for viewing by an investor, as shown in FIG. 23. The welcome component page 2310 includes an advisory information section 2312, an edit control 2314, and a component menu 2316 of option selections for the venture reporting website components. Each of the option selections of the component menu 2316 are for viewing pages of the venture reporting website by the venture manager for updating purposes rather than for viewing by an investor. The advisory information section 2312 explains the purpose of the welcome component page 2310 and displays a welcome message for the venture reporting website. Activation of the edit control 2314 allows editing of the welcome message.

The component menu 2316 in the exemplary embodiment contains option selections for a welcome component, a company description component, a management team component, a product description component, a market position component, a competitive strategy component, a next round component, a financial data component, a revenue sources component, a business key metrics component, a financial key metrics component, a partnerships component, a press releases component, a press mentions component, a FAQ component, an analyst reports component, a mission statement component, a directors component, an advisory board component, an SEC filings component, and a disclaimers component. Other embodiments contain further components related to venture reporting and contain additional information to inform investors, loan institutions, company officers and directors, other stakeholders, and others of interest in the venture.

The component menu 2316 includes indicators 2318 and 2320. The indicators 2318 shown by either color or shape indicate which component is required and which component is optional. Required components need to be completed with appropriate data before the venture reporting website is made available. The indicators 2320 indicate when a component has data or when no data exists in the venture data 62 for a component.

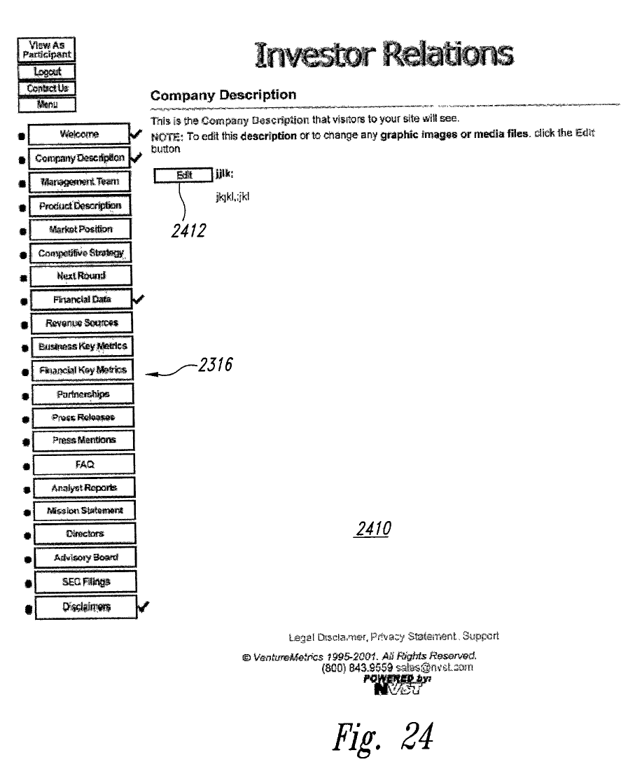

Upon activation of the company description component option selection of the component menu 2316, a company description component page 2410 is displayed as shown in FIG. 24. The company description component page 2410 contains an edit control 2412 used to activate editing features to update description data and associated graphic images or media files. The company description component page 2410 also includes the component menu 2316.

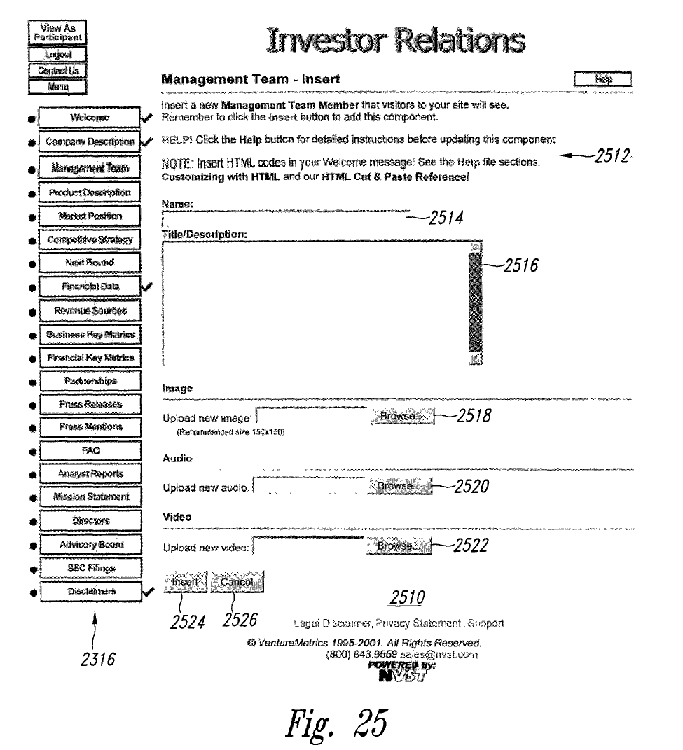

Upon activation of the management team component option selection of the component menu 2316, a management team component page 2510 is displayed as shown in FIG. 25. The management team component page 2510 is used to add a new management team member into a management team page of the venture reporting website. The management team component page 2510 includes an instructions section 2512, a name field 2514 used to input the name of the new team member, a title description field 2516 used to input the title and description of the new team member, an image upload section 2518 used to select an image of the new team member for uploading into the venture data 62, an audio upload section 2520 used to select an audio file associated with the new team member for uploading into the venture data 62, and a video upload section 2522 used to upload a video file associated with the new team member for uploading into the venture data 62. The management team component page 2510 also includes an insert control 2524 used to activate uploading of data to the venture data 62 and a cancel control 2526 used to abort uploading of data to the venture data.

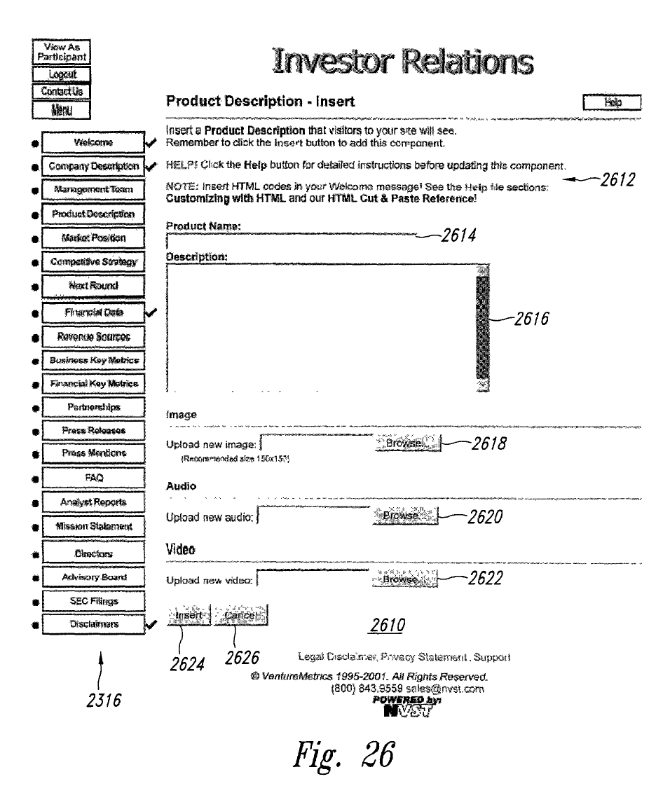

Upon activation of the product description component option selection of the component menu 2316, a product description component page 2610 is displayed as shown in FIG. 26. The product description component page 2610 is used to add data to the venture data 62 descriptive of products or other services offered by the venture. The product description component page 2610 includes an instruction section 2612, a product name field 2614 used to input the name of a product or service, a description field 2616 used to input the description of the product or service, an image upload section 2618 used to select an image related to the product or service for uploading into the venture data 62, an audio upload section 2620 used to select an audio file associated with the product or service for uploading into the venture data 62, and a video upload section 2622 used to upload a video file associated with the product or service for uploading into the venture data 62. The product description component page 2610 also includes an insert control 2624 used to activate uploading of data to the venture data 62 and a cancel control 2626 used to abort uploading of data to the venture data.

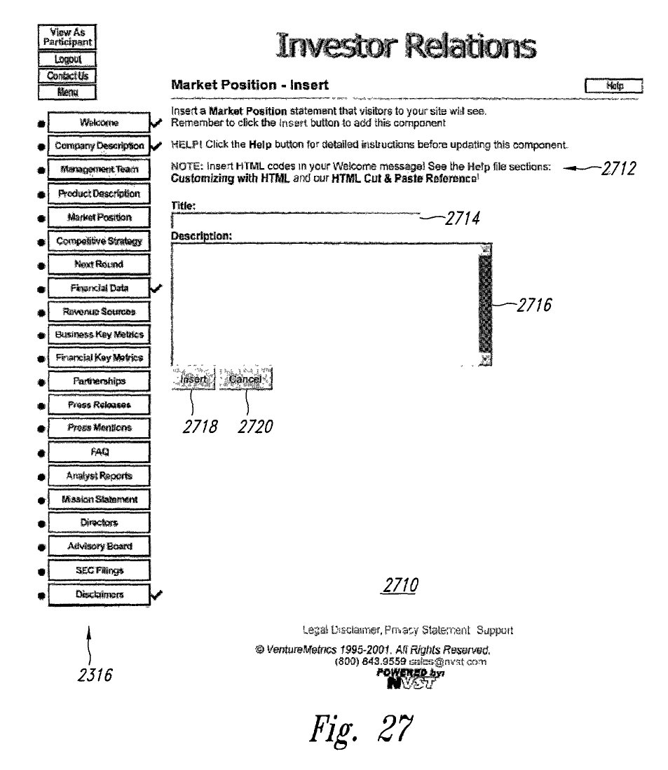

Upon activation of the market position component option selection of the component menu 2316, a market position component page 2710 is displayed as shown in FIG. 27. The market position component page 2710 is used to add data to the venture data 62 descriptive of the venture's position relative to competitors and other interests. The market position component page 2710 includes an instruction section 2712, a title field 2714 used to input the title of a market position statement, and a description field 2716 used to input the description of the market position of the venture. The market position component page 2710 also includes an insert control 2718 used to activate uploading of data to the venture data 62 and a cancel control 2720 used to abort uploading of data to the venture data.

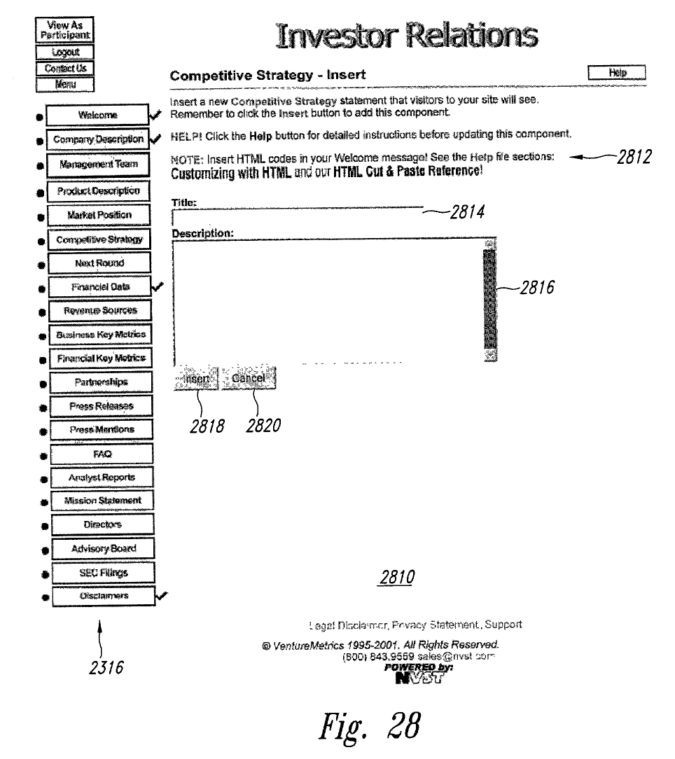

Upon activation of the competitive strategy component option selection of the component menu 2316, a competitive strategy component page 2810 is displayed as shown in FIG. 28. The competitive strategy component page 2810 is used to add data to the venture data 62 descriptive of the venture's competitive strategy relative to competitors and other interests. The competitive strategy component page 2810 includes an instruction section 2812, a title field 2814 used to input the title of the competitive strategy statement, and a description field 2816 used to input the description of the competitive strategy of the venture. The competitive strategy component page 2810 also includes an insert control 2818 used to activate uploading of data to the venture data 62 and a cancel control 2820 used to abort uploading of data to the venture data.

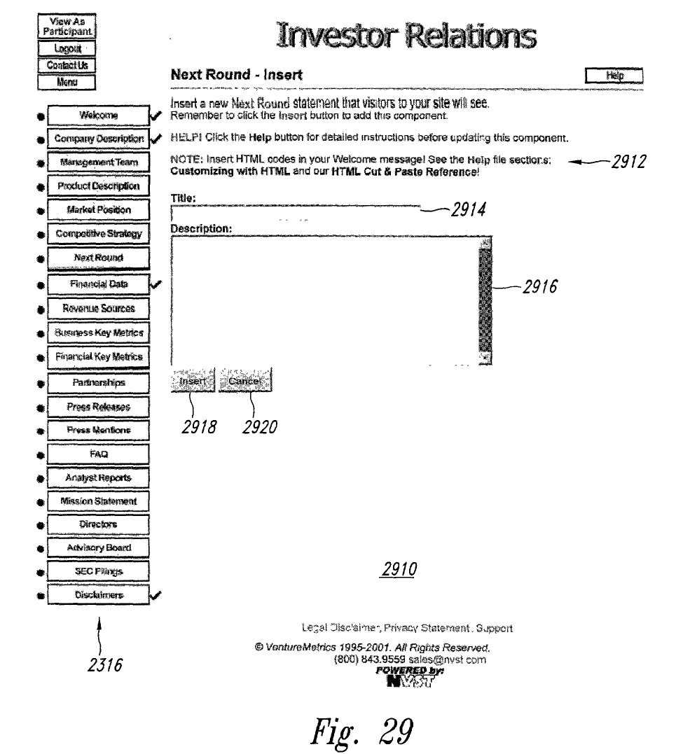

Upon activation of the next round component option selection of the component menu 2316, a next round component page 2910 is displayed as shown in FIG. 29. The next round component page 2910 is used to display information related to a next round of financing or other activities associated with the venture. The next round component page 2910 includes an instruction section 2912, a title field 2914 used to input the title of the next round description, and a description field 2916 used to input the description related to the next round of activities of the venture. The next round component page 2910 also includes an insert control 2918 to activate uploading of data to the venture data 62 and a cancel control 2920 used to abort uploading of data to the venture data.

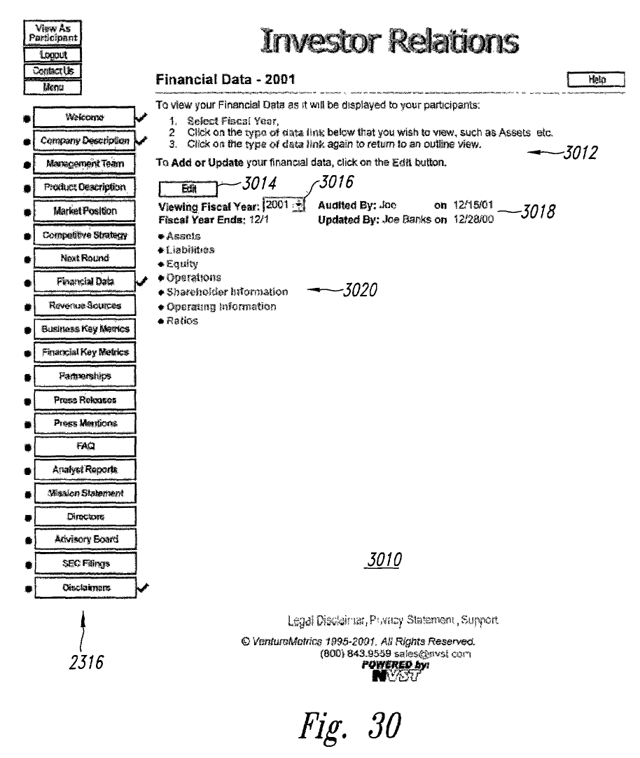

Upon activation of the financial data component option selection of the component menu 2316, a financial data component page 3010 is displayed as shown in FIG. 30. The financial data component page 3010 is used to display financial data associated with the venture. The financial data component page 3010 includes an instruction section 3012, an edit control 3014 used to edit the financial data, a fiscal year selection control 3016 used to select the fiscal year associated with the displayed financial data, a background informational section 3018 displaying information related to updating of the financial data, and a financial data section 3020. The financial data section 3020 includes an asset section, a liability section, an equity section, an operation section, a shareholder information section, an operating information section, and a ratio section. In other embodiments further informational sections are included in the financial data section 3020.

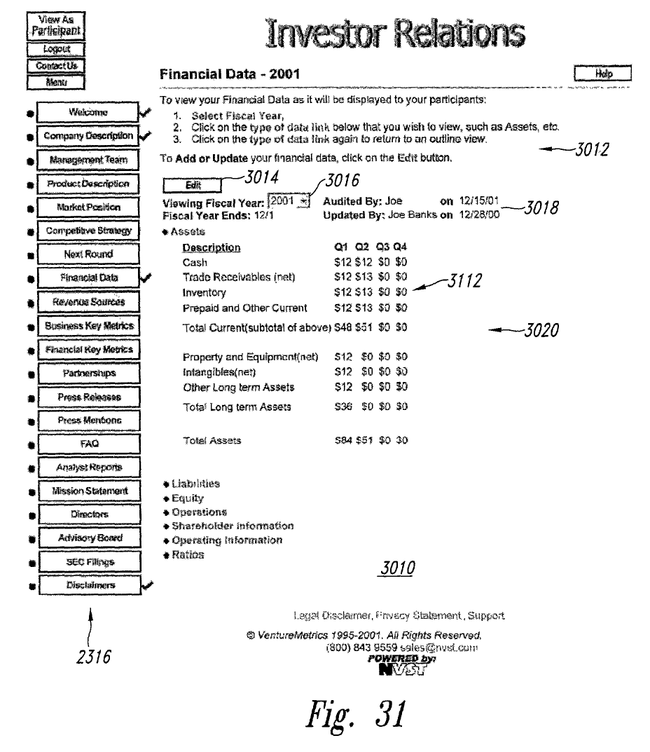

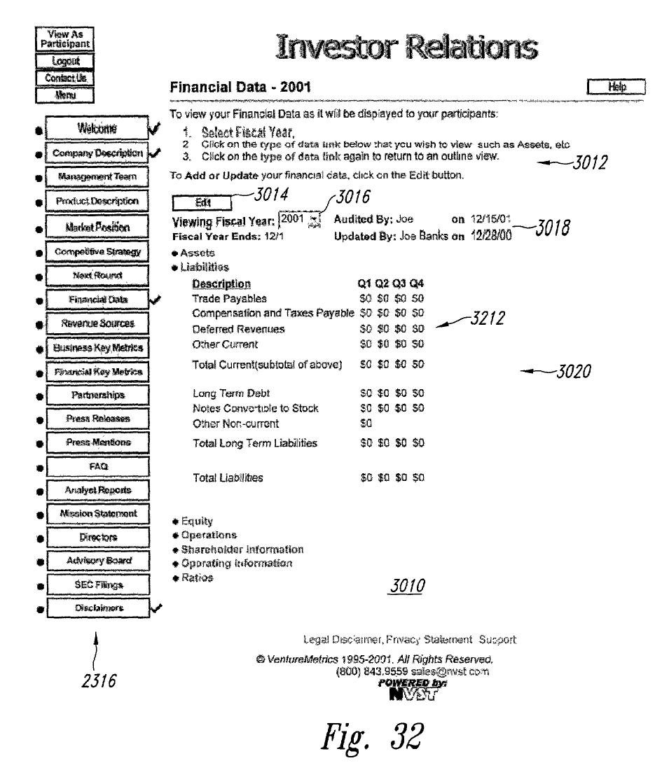

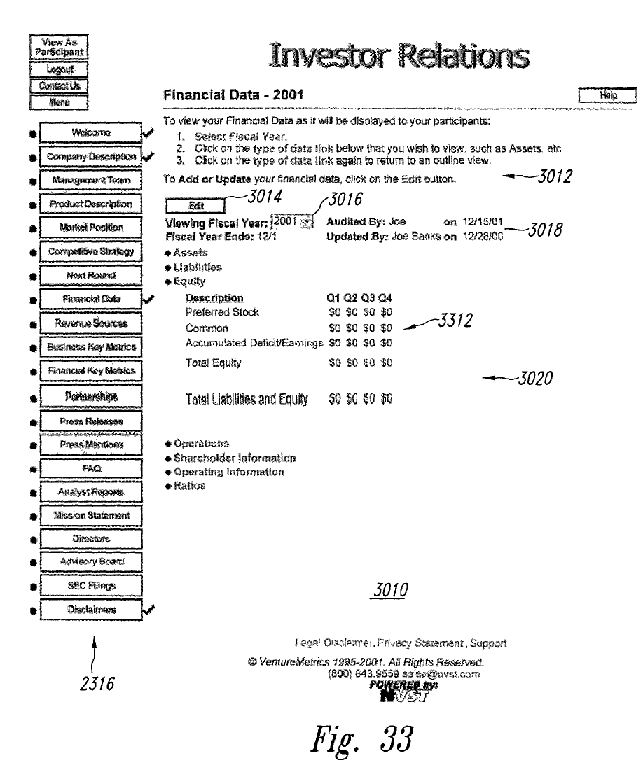

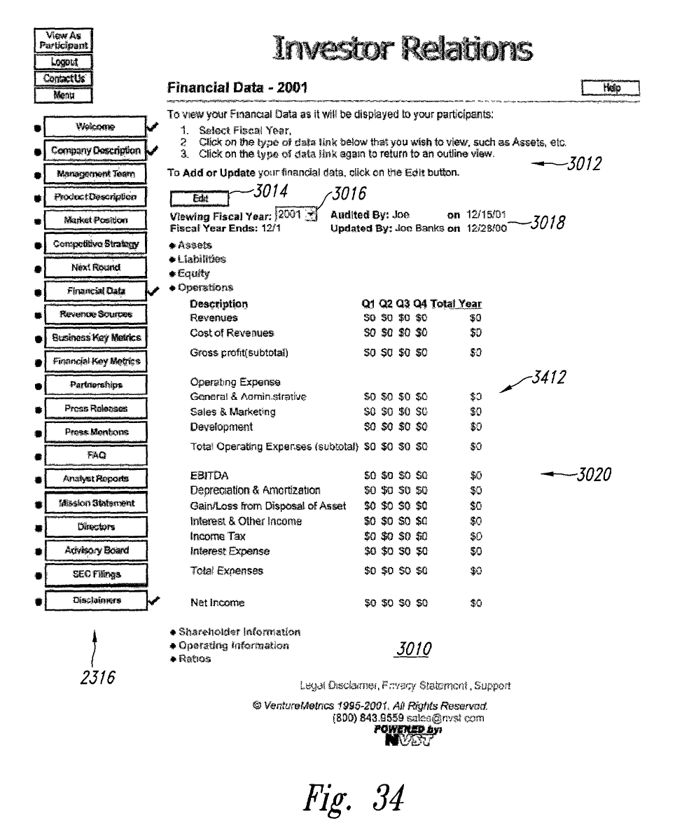

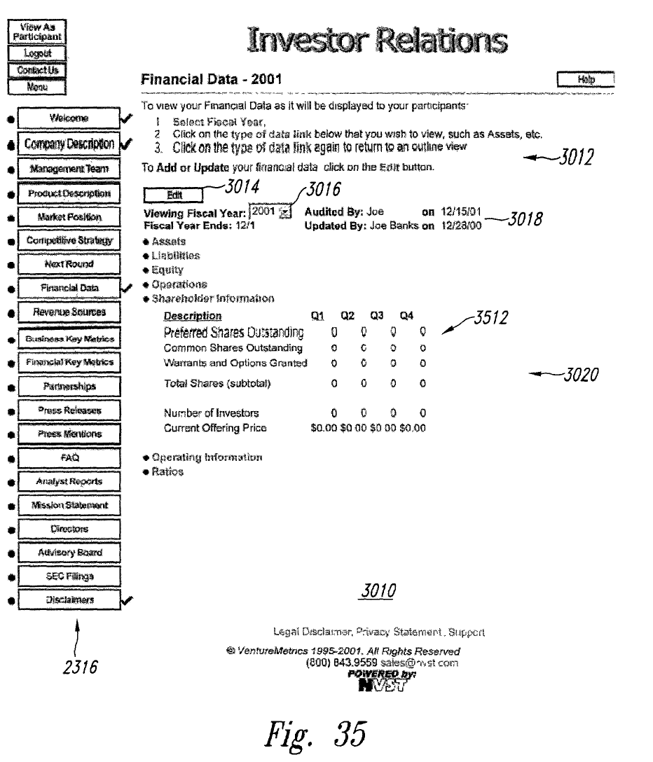

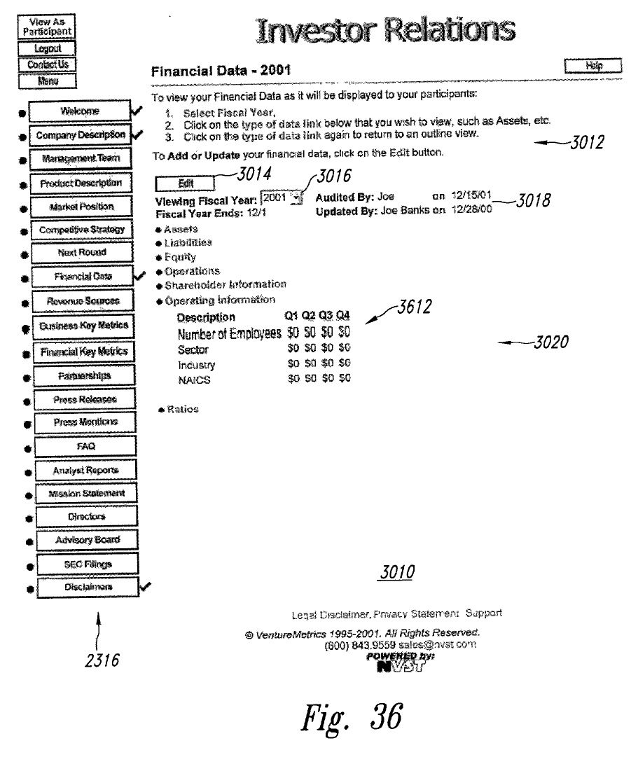

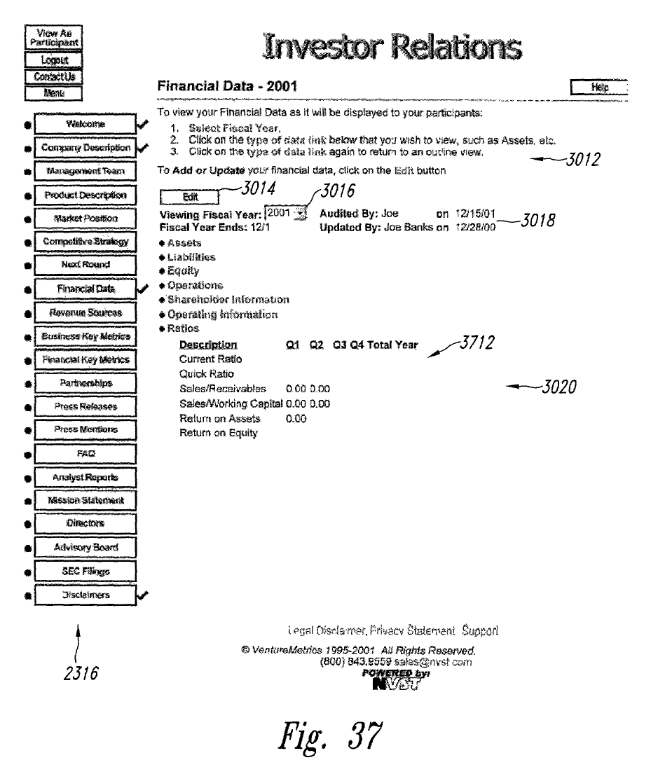

Each section of the financial data section 3020 is accessed through a hypertext link. When the hypertext link for the assets section is activated, financial data 3112 related to the venture's assets is displayed as shown in FIG. 31. When the hypertext link for the liability section is activated, financial data 3212 related to the venture's liabilities is displayed as shown in FIG. 32. When the hypertext link for the equity section is activated, financial data 3312 related to the venture's equity is displayed as shown in FIG. 33. When the hypertext link for the operations section is activated, financial data 3412 related to the venture's operations is displayed as shown in FIG. 34. When the hypertext link related to the shareholder information section is activated, shareholder information 3512 related to the venture is displayed as shown in FIG. 35. When the hypertext link related to the operating information section is activated, financial data 3612 related to the venture's operating status is displayed as shown in FIG. 36. When the hypertext link related to the ratio section is activated, ratio data 3712 related to the venture's financial status is displayed as shown in FIG. 37.

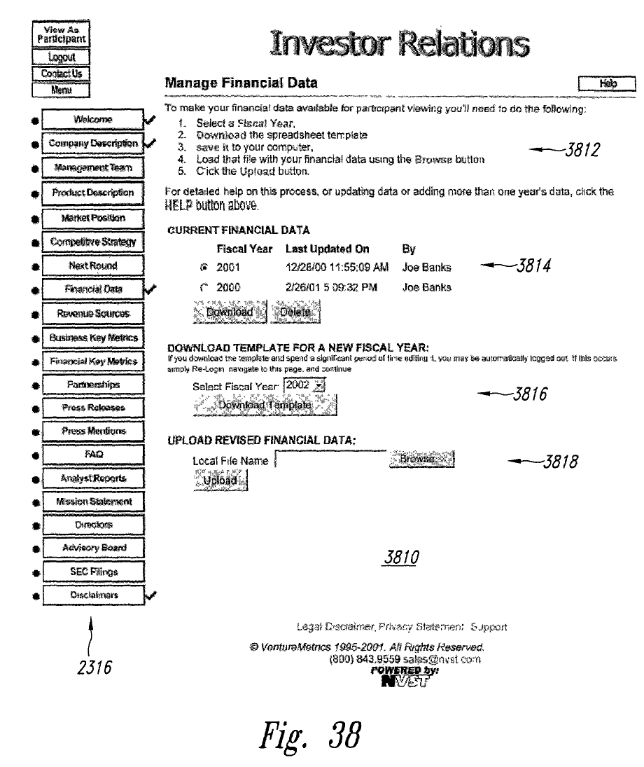

Upon activation of the edit control 3014, a manage financial data page 3810 is displayed as shown in FIG. 38. The manage financial data page 3810 is used to update financial data contained in the venture data 62. The manage financial data page 3810 includes an instruction section 3812, a current financial data section 3814, a download template section 3816, and an upload financial data section 3818. The current financial data section 3814 includes controls to select a particular fiscal year and to either download financial data related to the chosen fiscal year from the venture data 62 on the server computer 60 to the client computer 10 or delete it. The download template section 3816 includes controls to select a fiscal year related to the downloaded template and a control to activate downloading of the template. Use of the template is described in more detail above. The upload financial data section 3818 includes controls to select a file for a template containing financial data found on the client computer 10 and to activate uploading financial data found on the template to the venture data 62 on the server computer 60.

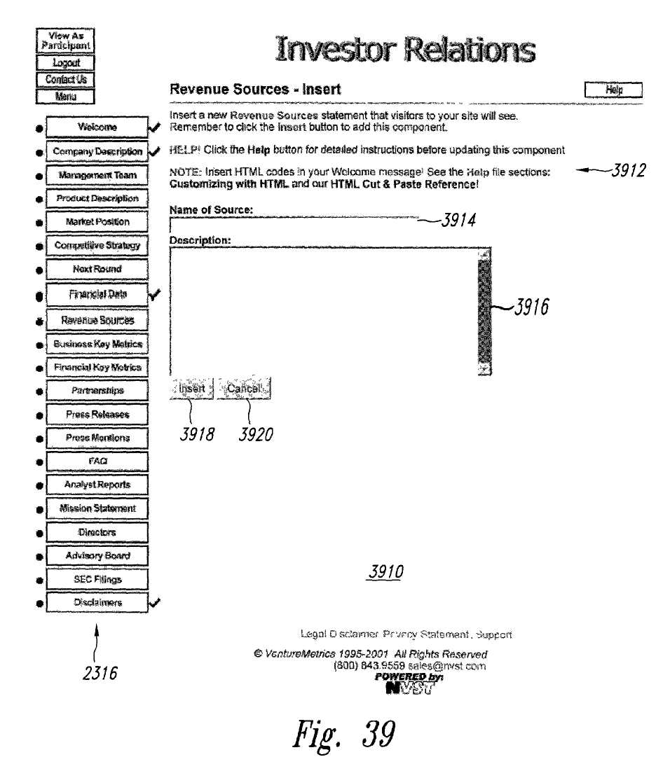

Upon activation of the revenue sources component option selection of the component menu 2316, a revenue sources component page 3910 is displayed as shown in FIG. 39. The revenue sources component page 3910 is used to display identification and description information of revenue sources of the venture. The revenue sources component page 3910 includes an instruction section 3912, a name of source field 3914 used to identify a source of revenue for the venture, and a description section 3916 used to include a description of the entitled revenue source. The revenue sources component page 3910 also includes an insert control 3918 used to activate uploading of the revenue sources identification and description information to the venture data 62 on the server computer 60. A cancel control 3920 is used for aborting operations of the revenue sources component page 3910.

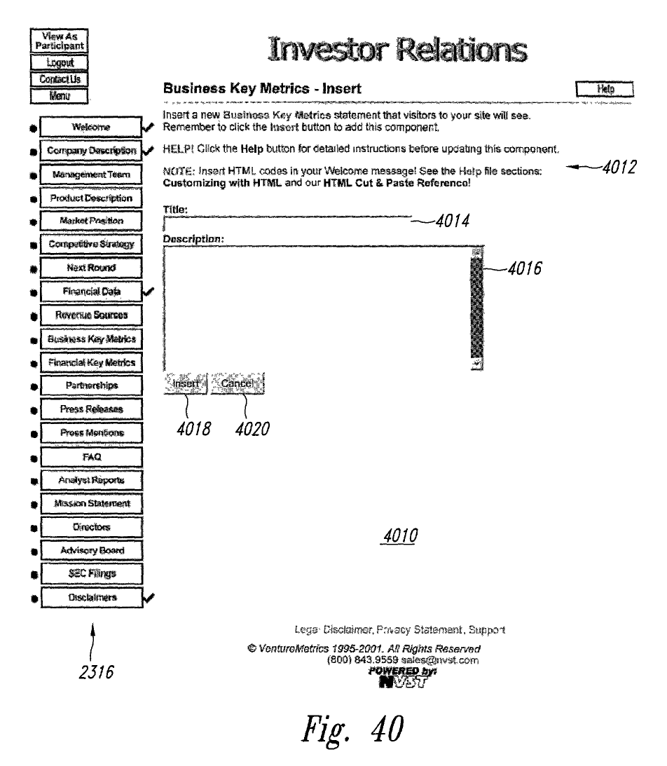

Upon activation of the business key metrics component option selection of the component menu 2316, a business key metrics component page 4010 is displayed as shown in FIG. 40. The business key metrics component page 4010 is used to display identification and description information of business key metrics related to the venture. The business key metrics component page 4010 includes an instruction section 4012, a title field 4014 used to identify a business key metric, and a description field 4016 used to describe aspects of the identified business key metric. The business key metrics component page 4010 also includes an insert control 4018 used to activate uploading of the business key metrics identification and description information to the venture data 62 on the server computer 60. A cancel control 4020 is used for aborting operations of the business key metrics component page 4010.

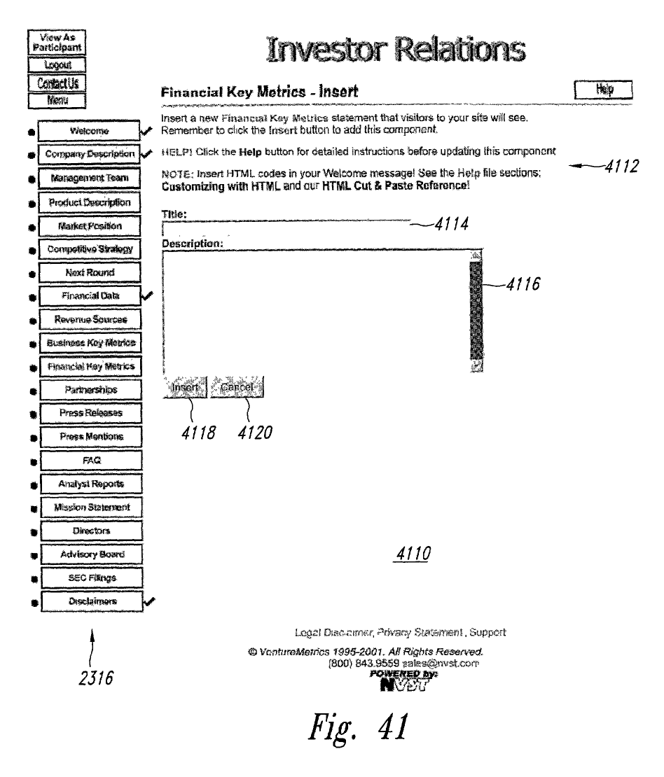

By activation of the financial key metrics component option selection of the component menu 2316, a financial key metrics component page 4110 is displayed as shown in FIG. 41. The financial key metrics component page 4110 is used to display identification and description information of financial key metrics related to the venture. The financial key metrics component page 4110 includes an instruction section 4112, a title field 4114 used to identify a financial key metric, and a description field 4116 used to describe aspects of the identified financial key metric. The financial key metrics component page 4110 also includes an insert control 4118 used to activate uploading of the financial key metrics identification and description information to the venture data 62 on the server computer 60. A cancel control 4120 is used for aborting operations of the financial key metrics component page 4110.

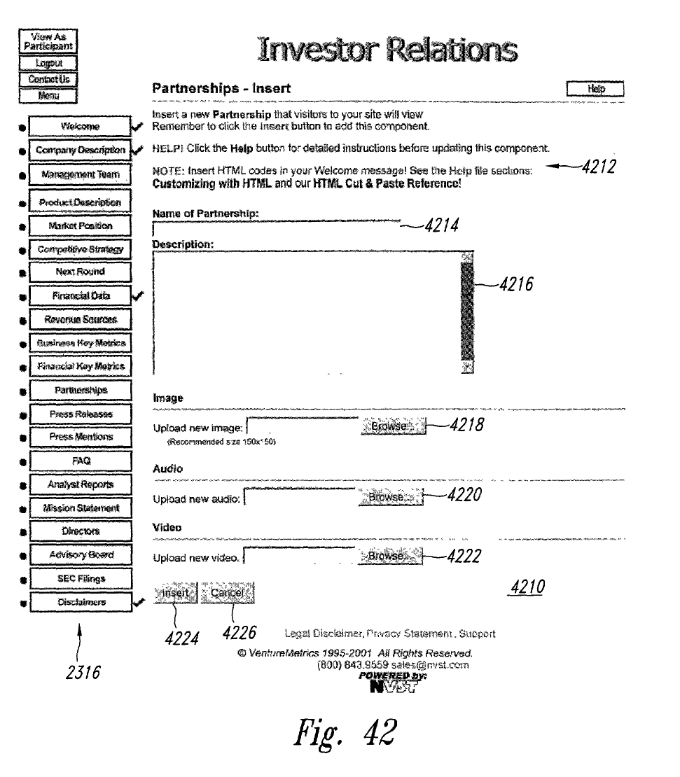

Upon activation of the partnerships component option selection of the component menu 2316, a partnerships component page 4210 is displayed as shown in FIG. 42. The partnerships component page 4210 is used to display identification and description information of partnerships related to the venture. The partnerships component page 4210 includes an instruction section 4212, a name of partnership field 4214 used to identify a partnership related to the venture, a description field 4216 used to describe the identified partnership, an image upload section 4218 used to select an image file related to the identified partnership for uploading to the venture data 62 on the server computer 60, an audio upload section 4220 used to select an audio file related to the identified partnership for uploading to the venture data 62 on the server computer 60, and a video upload section 4222 used to select a video file related to the identified partnership for uploading to the venture data 62 on the server computer 60. The partnerships component page 4210 also includes an insert control 4224 used to activate uploading of the partnerships identification and description information to the venture data 62 on the server computer 60. A cancel control 4226 is used for aborting operations of the partnerships component page 4210.

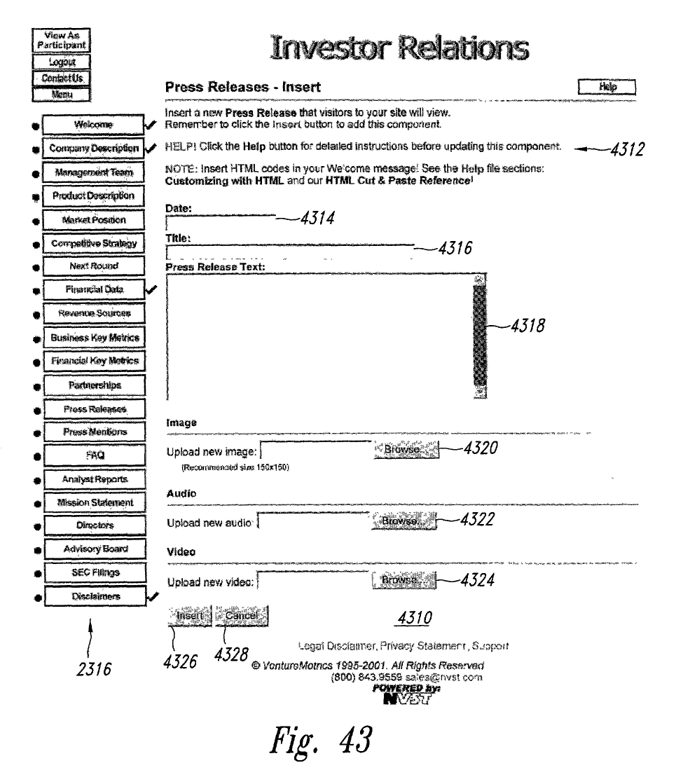

Upon activation of the press releases component option selection of the component menu 2316, a press releases component page 4310 is displayed as shown in FIG. 43. The press releases component page 4310 is used to display identification and description information for press releases related to the venture. The press releases component page 4310 includes an instruction section 4312, a date field 4314 associated with a press release, a title field 4316 associated with the press release, a press release text field 4318 used to contain text of the press release, an image upload section 4320 used to select an image file related to the press release for uploading to the venture data 62 on the server computer 60, an audio upload section 4322 used to select an audio file related to the press release for uploading to the venture data 62 on the server computer 60, and a video upload section 4324 used to select a video file related to the press release for uploading to the venture data 62 on the server computer 60. The press releases component page 4310 also includes an insert control 4326 used to activate uploading of partnerships identification and description information to the venture data 62 on the server computer 60. A cancel control 4328 is used for aborting operations of the press releases component page 4310.

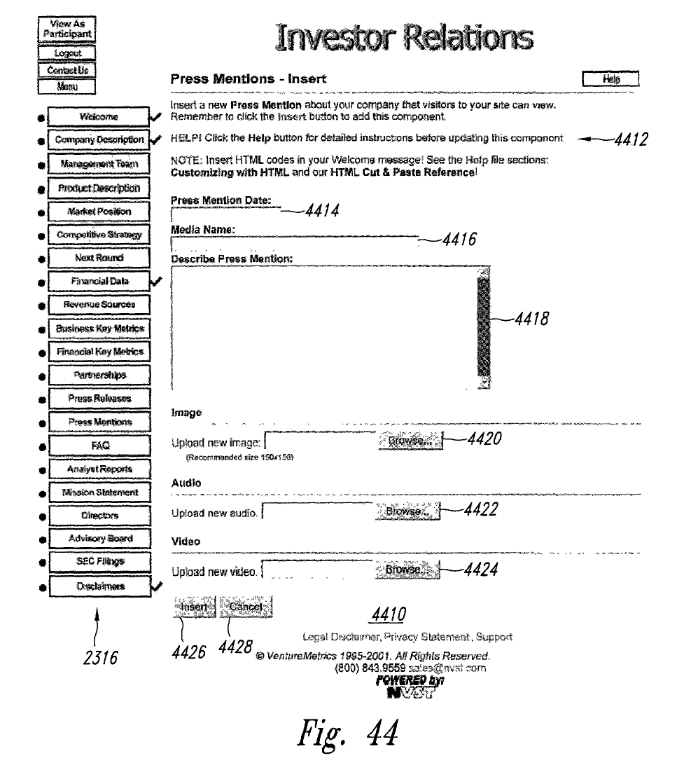

Upon activation of the press mentions component option selection of the component menu 2316, a press mentions component page 4410 is displayed as shown in FIG. 44. The press mentions component page 4410 is used to display identification and description information of press mentions related to the venture. The press mentions component page 4410 includes an instruction section 4412, a press mention date field 4414 associated with a press mention, a media name field 4416 associated with the press mention, a describe press mention field 4418 used to describe the press mention, an image upload section 4420 used to select an image file related to the press mention for uploading to the venture data 62 on the server computer 60, an audio upload section 4422 used to select an audio file related to the press mention for uploading to the venture data 62 on the server computer 60, and a video upload section 4424 used to select a video file related to the press mention for uploading to the venture data 62 on the server computer 60. The press mentions component page 4410 also includes an insert control 4426 used to activate uploading of press mentions identification and description information to the venture data 62 on the server computer 60. A cancel control 4428 is used for aborting operations of the press mentions component page 4410.

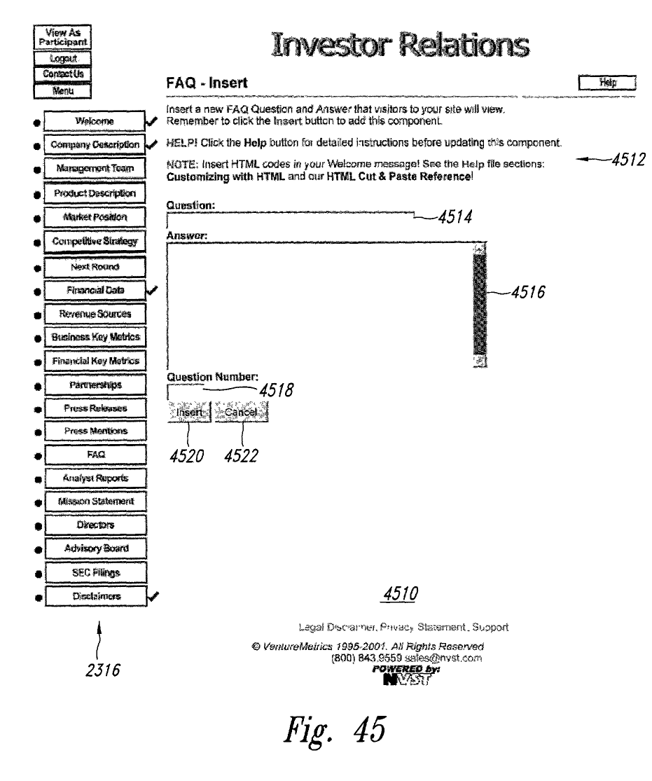

Upon activation of the FAQ component option selection of the component menu 2316, a FAQ component page 4510 is displayed as shown in FIG. 45. The FAQ component page 4510 is used to display identification and description information for frequently asked questions related to the venture. The FAQ component page 4510 includes an instruction section 4512, a question field 4514 used to identify and describe a question related to the venture, an answer field 4516 used to identify and describe an answer in response to the question related to the venture, and a question number field 4518 used to identify the particular question. The FAQ component page 4510 also includes an insert control 4520 used to activate uploading of the FAQ identification and description information to the venture data 62 on the server computer 60. A cancel control 4522 is used for aborting operations of the FAQ component page 4510.

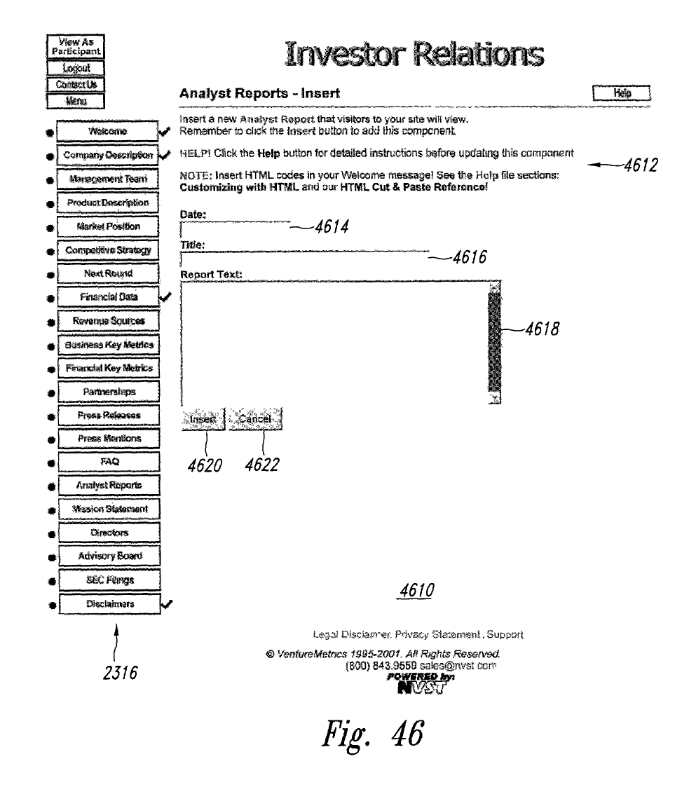

Upon activation of the analyst reports component option selection of the component menu 2316, an analyst reports component page 4610 is displayed as shown in FIG. 46. The analyst reports component page 4610 is used to identify and describe reports by analysts regarding the venture. The analyst reports component page 4610 includes an instruction section 4612, a date field 4614 to identify when an analyst report was written, a title field 4616 to identify the analyst report, and a report text field 4618, which contains text of the analyst report. The analyst reports component page 4610 also includes an insert control 4620 used to activate uploading of the analyst reports identification and description information to the venture data 62 on the server computer 60. A cancel control 4622 is used for aborting operations of the analyst reports component page 4610.

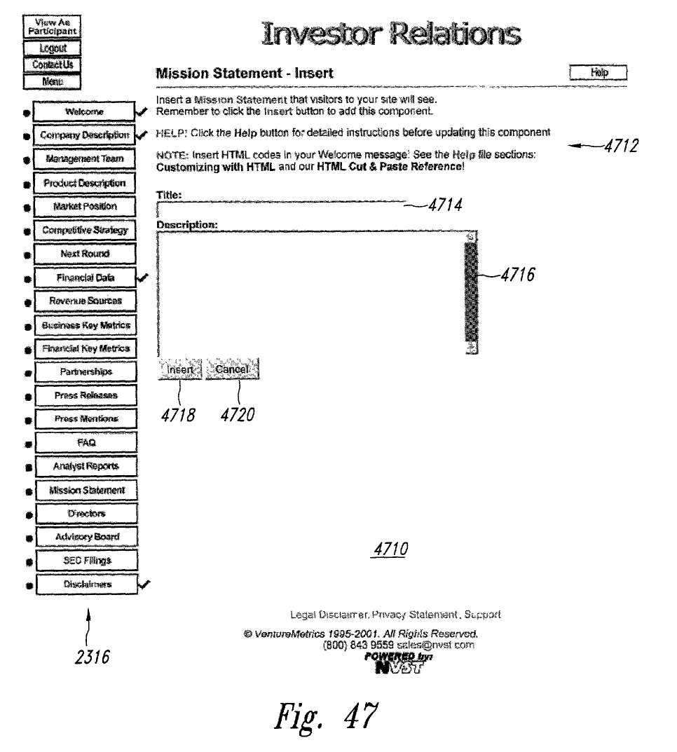

Upon activation of the mission statement component option selection of the component menu 2316, a mission statement component page 4710 is displayed as shown in FIG. 47. The mission statement component page 4710 is used to identify and describe a mission statement regarding the venture. The mission statement component page 4710 includes an instruction section 4712, a title field 4714 used to provide a title of the mission statement, and description field 4716 used to enter the body of the mission statement. The mission statement component page 4710 also includes an insert control 4718 used to activate uploading of the mission statement identification and description information to the venture data 62 on the server computer 60. A cancel control 4720 is used for aborting operations of the mission statement component page 4710.

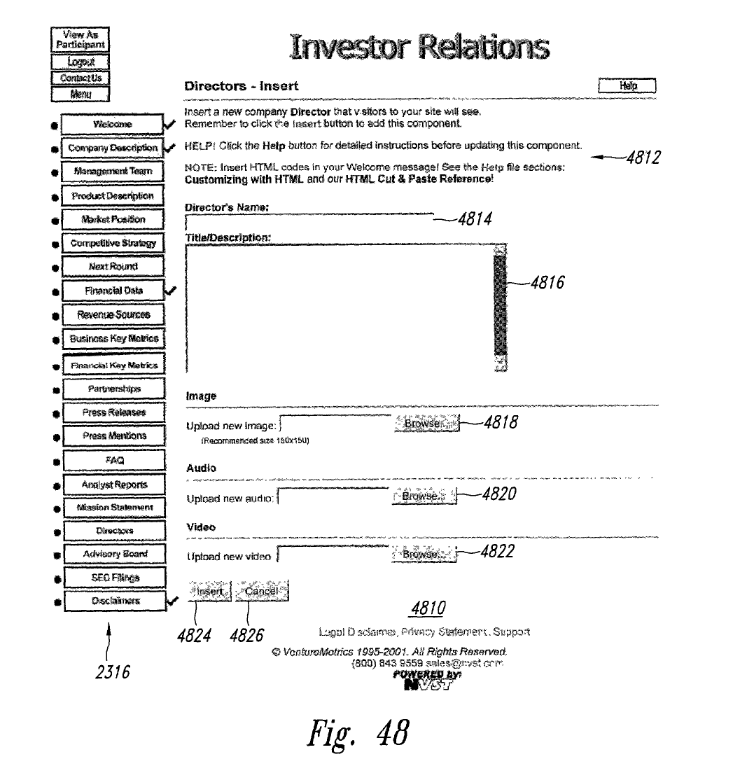

Upon activation of the directors component option selection of the component menu 2316, the directors component page 4810 is displayed as shown in FIG. 48. The directors component page 4810 is used to identify and describe directors of the venture. The directors component page 4810 includes an instruction section 4812, a director's name field 4814 used to input a name of a particular director, a title/description field 4816 used to input a title of the director and a description of their background, an image upload section 4818 used to select an image related to the director for uploading to the venture data 62 on the server computer 60, an audio upload section 4820 used to select an audio file related to the director for uploading to the venture data 62 on the server computer 60, and a video upload section 4822 used to select a video file related to the director for uploading to the venture data 62 on the server computer 60. The directors component page 4810 also includes an insert control 4824 used to activate uploading of director identification and description information to the venture data 62 on the server computer 60. A cancel control 4826 is used for aborting operations of the director component page 4810.

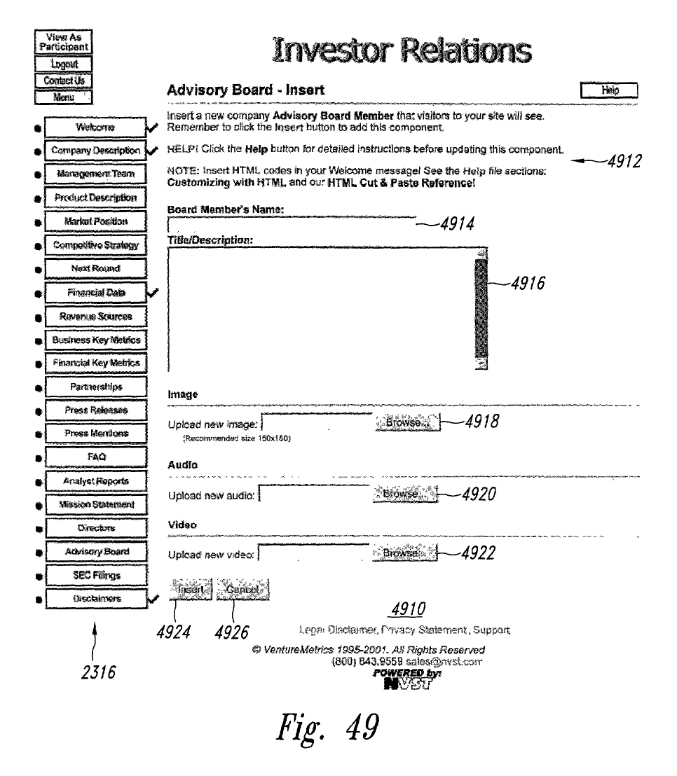

Upon activation of the advisory board component option selection of the component menu 2316, an advisory board component page 4910 is displayed as shown in FIG. 49. The advisory board component page 4910 is used to identify and describe members of the advisory board of the venture. The advisory board component page 4910 includes an instruction section 4912, a board member's name field 4914 used to input a name of a particular board member, a title/description field 4916 used to input a title of the board member and a description of their background, an image upload section 4918 used to select an image related to the board member for uploading to the venture data 62 on the server computer 60, an audio upload section 4920 used to select an audio file related to the board member for uploading to the venture data 62 on the server computer 60, and a video upload section 4922 used to select a video file related to the board member for uploading to the venture data 62 on the server computer 60. The advisory board component page 4910 also includes an insert control 4924 used to activate uploading of the board members identification and description information to the venture data 62 on the server computer 60. A cancel control 4926 is used for aborting operations of the advisory board component page 4910.

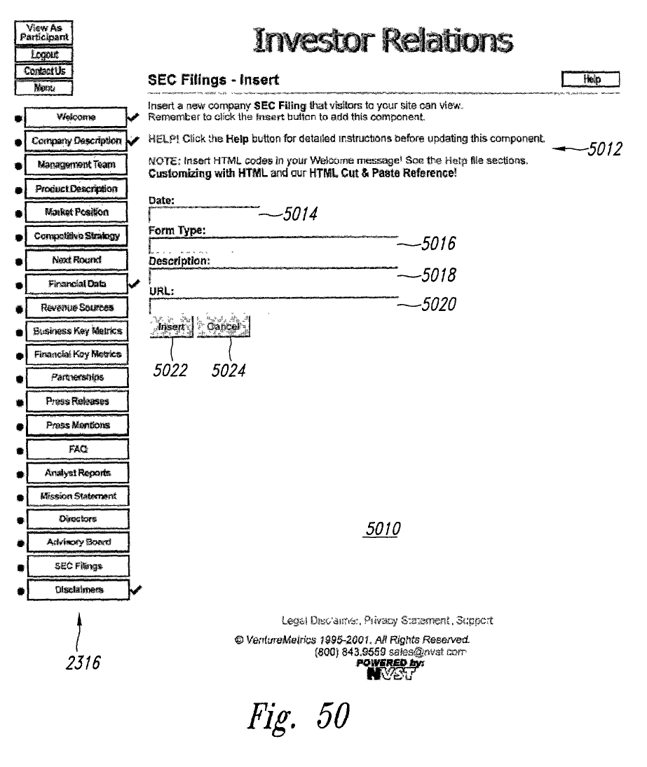

Upon activation of the SEC filings component option selection of the component menu 2316, an SEC filings component page 5010 is displayed as shown in FIG. 50. The SEC filings component page 5010 is used to identify and describe all SEC filings related to the venture. The SEC filings component page 5010 includes an instruction section 5012, a date field 5014 to identify the date of an SEC filing, a form type field 5016 used to identify the particular type of form associated with the SEC filing, a description field 5018 used to provide a description of the SEC filing, and a URL field 5020 used to provide a URL associated with the SEC filing. The SEC filings component page 5010 also includes an insert control 5022 used to activate uploading of the SEC filings identification and description information to the venture data 62 on the server computer 60. A cancel control 5024 is used for aborting operations of the SEC filings component page 5010.

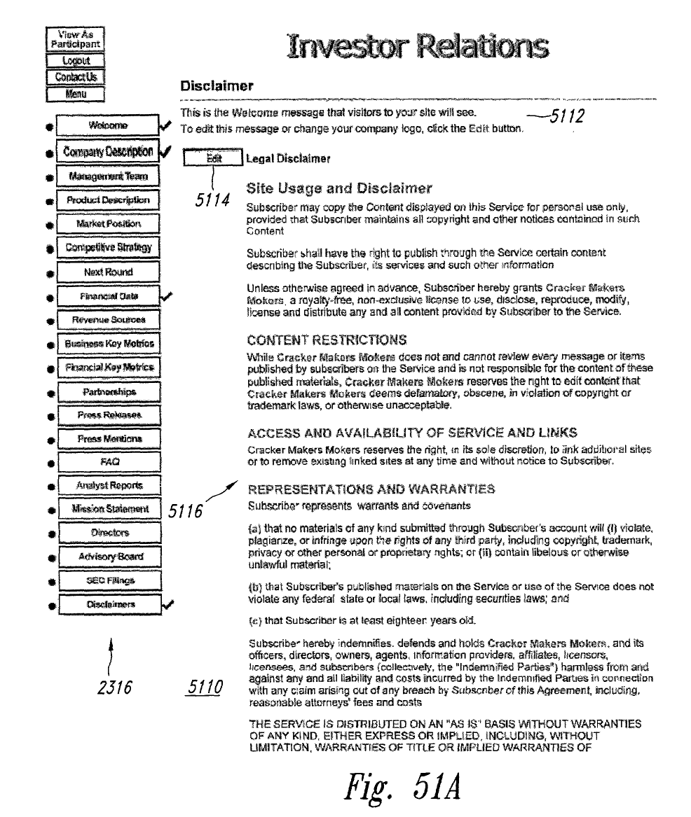

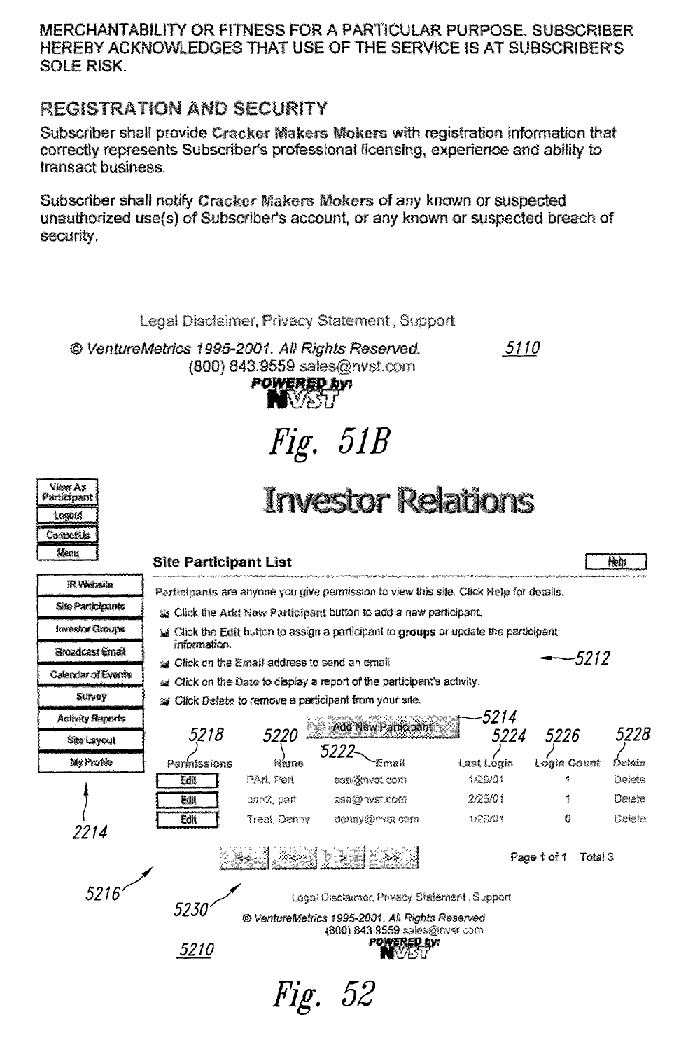

Upon activation of the disclaimers component option selection of the component menu 2316, a disclaimer component page 5110 is displayed as shown in FIGS. 51A and 51B. The disclaimer component page 5110 is used to provide a disclaimer for the venture reporting website. The disclaimer component page 5110 includes an instruction section 5112, an edit control 5114 used to edit a disclaimer, and a display section 5116 used to show the disclaimer currently used for the venture reporting website. In other embodiments the component menu 2316 contains other option selections useful for creating, viewing, modifying, and removing identification and description information associated with other reporting aspects of the venture reporting website.

Upon activation of the site participant's option selection of the high-level menu 2214 of the high-level page 2210 (see FIG. 22), a site participant page 5210 is displayed as shown in FIG. 52. The site participant page 5210 is used to oversee access privileges given to participants of the venture reporting website and includes login tracking and e-mail communication features. The site participant page 5210 includes an instruction section 5212, an add new participant control 5214 used to add an individual as a new participant to the venture reporting website including defining access privileges for the new participant, and a participant management table 5216.

The participant management table 5216 includes a permissions column 5218 with individual edit controls associated with each participant, which allows a user of the site participant page 5210 to edit the access permissions granted to the individual participants of the venture reporting website. The participant management table 5216 also includes a name column 5220 for displaying the name of each participant, an e-mail column 5222 for displaying e-mail addresses for each participant, a last login column 5224 identifying dates on which the participants last accessed the venture reporting website, a login count column 5226 detailing total login attempts for each participant, and a delete column 5228 having individual delete controls for removing each individual participant. The participant management table 5216 further includes selection controls 5230 to aid users of the site participant page 5210 in locating particular sections of the participant management table.

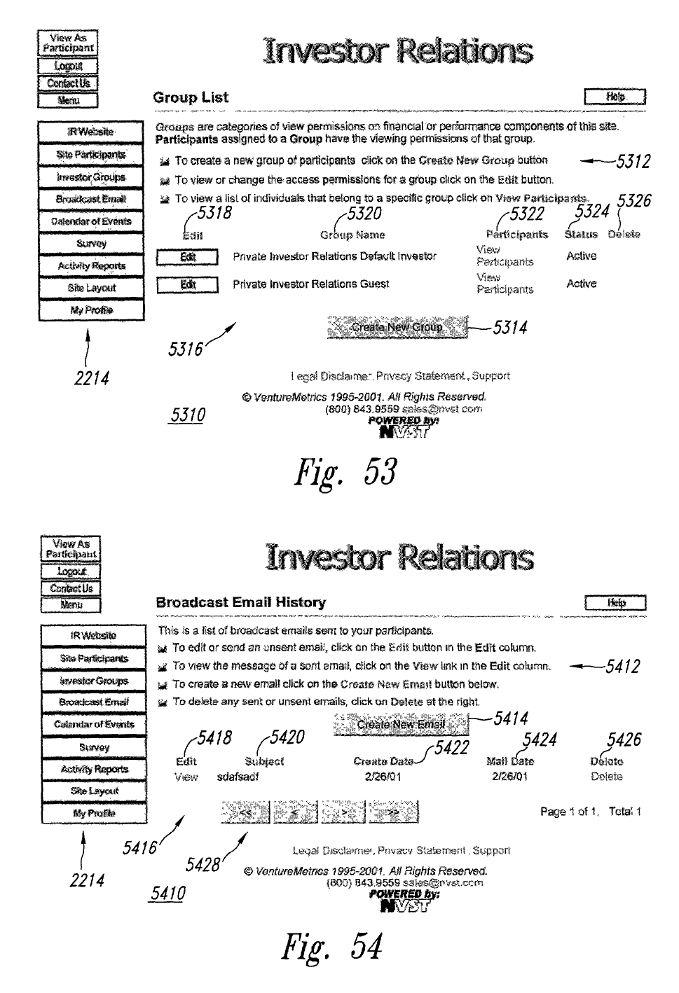

Upon activation of the investor groups option selection of the high-level menu 2214 of the high-level page 2210, a group page 5310 is displayed as shown in FIG. 53. The group page 5310 includes an instruction section 5312, a create group control 5314 used to create additional groups of participants having particular access privileges, and a group management table 5316. The group management table 5316 includes an edit column 5318 having individual edit controls for each individual group of participants used to view or modify the access permissions for the individual group. The group management table 5316 also includes a group name column 5320 providing the particular names of the individual groups, a participant's column 5322 having a hypertext link for each group, which upon activation, displays the list of individual participants for the group, a status column 5324 showing status for each of the groups, and a delete column 5326 providing delete controls to remove one or more of the groups.

Upon activation of the broadcast e-mail option selection of the high-level menu 2214 of the high-level page 2210, a broadcast e-mail history page 5410 is displayed as shown in FIG. 54. The broadcast e-mail history page 5410 includes an instruction section 5412, a create new e-mail control 5414, and an e-mail management table 5416. The e-mail management table 5416 includes an edit column 5418 used to edit or send a particular e-mail, a subject column 5420 used to identify particular e-mails, a create date column 5422 used to identify the creation date of each e-mail, a mail date column 5424 used to identify the date of mailing for each e-mail, and a delete column 5426 used to remove unwanted e-mails from the e-mail management table 5416. The e-mail management table 5416 further includes selection controls 5428 to aid users of the broadcast e-mail history page 5410 in locating particular sections of the broadcast e-mail history table.

Upon activation of the calendar of events option selection of the high-level menu 2214 of the high-level page 2210, a calendar of events page 5510 is displayed as shown in FIG. 55. The calendar of events page 5510 is used to update identification and description information related to events of the venture. The calendar of events page 5510 includes an instruction section 5512, an add new event control 5514 used to add a new event, and an event management table 5516. The event management table 5516 includes an edit column 5518 having individual and edit controls for each event to update the existing events, a date column 5520 showing date of occurrence for each event, an event title column 5522 containing identifying names for each event, and a contact section 5524 containing contact information for each event.

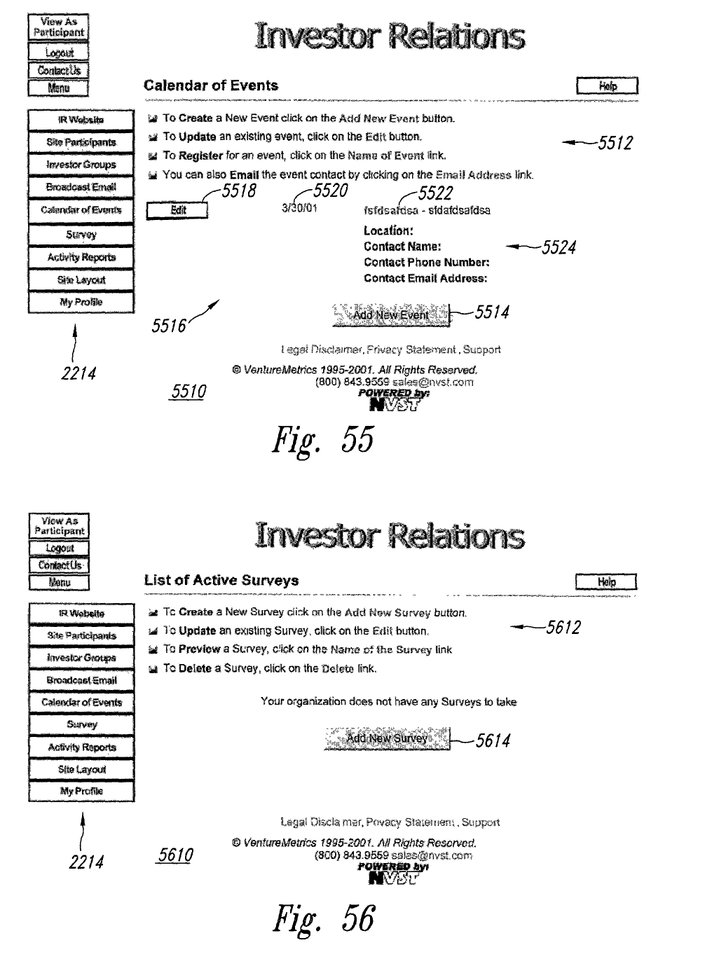

Upon activation of the survey option selection of the high-level menu 2214 of the high-level page 2210, a list of active surveys page 5610 is displayed as shown in FIG. 56. The list of active surveys page 5610 is used to update, preview, and delete surveys, such as investor surveys, related to the venture. The list of active surveys page 5610 includes an instruction section 5612, an add new survey control 5614 used to create new surveys, and an active surveys management table (not shown) used to update, preview, and delete surveys containing appropriate columns similar to other tables described above.

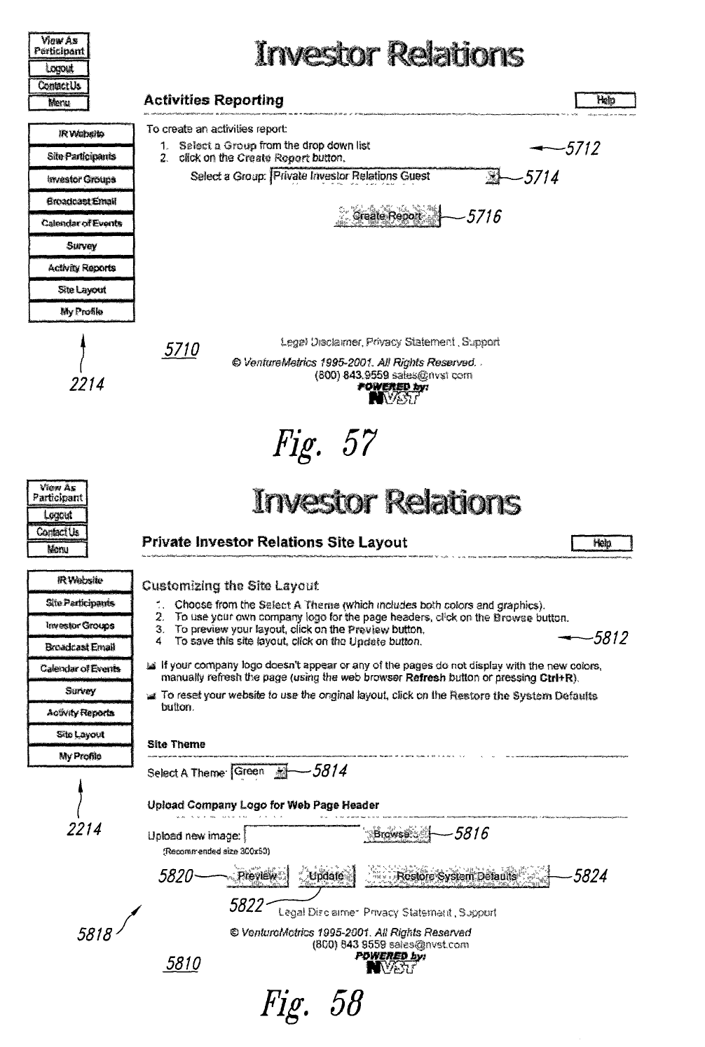

Upon activation of the activity reports option selection of the high-level menu 2214 of the high-level page 2210, an activities reporting page 5710 is displayed as shown in FIG. 57. The activities reporting page 5710 is used to generate activity reports concerning selected groups of participants of the venture reporting website. The activities reporting page 5710 includes an instruction section 5712, a group selection control 5714 used to select groups of participants for which an activity report will be generated, and a create report control 5716 used to initiate generation of an activity report.

Upon activation of the site layout option selection of the high-level menu 2214 of the high-level page 2210, a private investor relations site layout page 5810 is displayed as shown in FIG. 58. The private investor relations site layout page 5810 is used to modify the layout or “look and feel” of the venture reporting website. The private investor relations site layout page 5810 includes an instruction section 5812, a selected theme control 5814 used to select certain displaying features for the venture reporting website, a company logo upload control 5816 used to select an image file to be displayed on the venture reporting website as the logo for the venture, and activation controls 5818. The activation controls 5818 include a preview control 5820 used to preview the updated layout of the venture reporting website, and an update control 5822 used to activate loading of the newly selected layout of the venture reporting website to the venture data 62 on the server computer 60. The activation controls 5818 also includes a restore system defaults control 5824 used to abort operations on the private investor relations site layout page 5810 and restore default system settings.

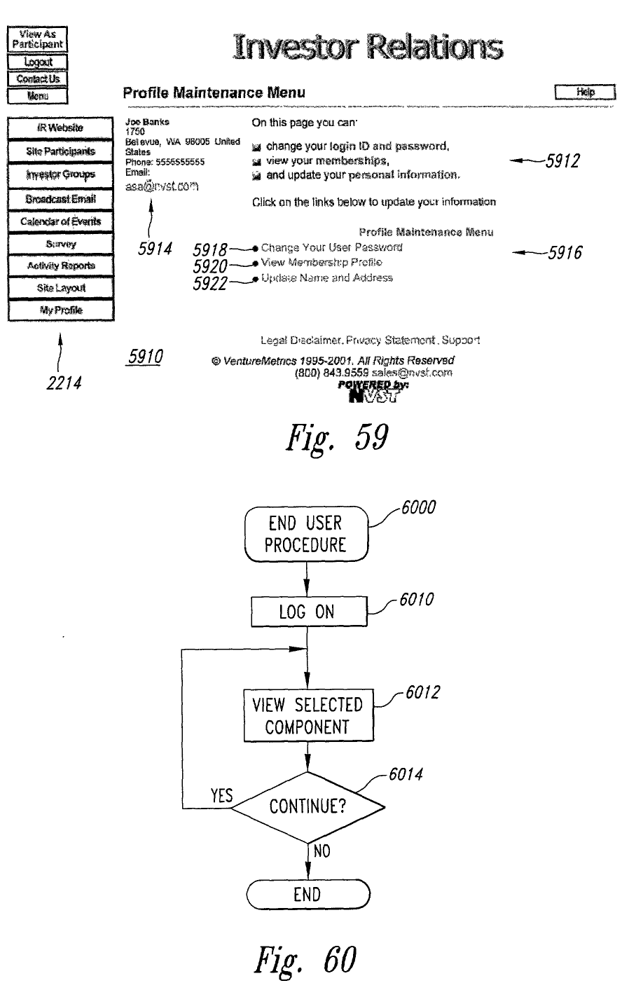

Upon activation of the my profile option selection of the high-level menu 2214 of the high-level page 2210, a profile maintenance menu page 5910 is displayed as shown in FIG. 59. The profile maintenance menu page 5910 is used by individuals to perform such tasks as modifying their access information, viewing their memberships, and updating their personal information. The profile maintenance menu page 5910 includes an instruction section 5912, a personal information section 5914 displaying data specifically related to the individual, and a profile maintenance menu 5916. The profile maintenance menu 5916 includes a change the individual's user password control 5918 used to change the individual's login identification or password, a view membership profile control 5920 used to view the memberships of the individual, and an update name and address control 5922 used to update personal information about the individual.

In other embodiments, the high-level menu 2214 of the high-level page 2210 contains other option selections useful for creating, viewing, modifying, and removing identification and description information associated with other reporting aspects of the venture reporting website.

An exemplary end-user procedure 6000 is shown in FIG. 60. An end-user such as an investor, officer of the venture, or other having an interest in the venture uses the client computer 10 to log on to the venture reporting website (step 6010) found on the server computer 60. The end-user then uses the client computer 10 to select a component of the venture reporting website for viewing (step 6012). As explained further above, components of the venture reporting website are available for viewing by the end-user based upon the end-user's access privileges and whether the components contain any data. The end-user procedure 6000 continues as a yes branch of decision step 6014 whereby the end-user views more components of the venture reporting website until the end-user is finished viewing (no branch of decision step 6014).

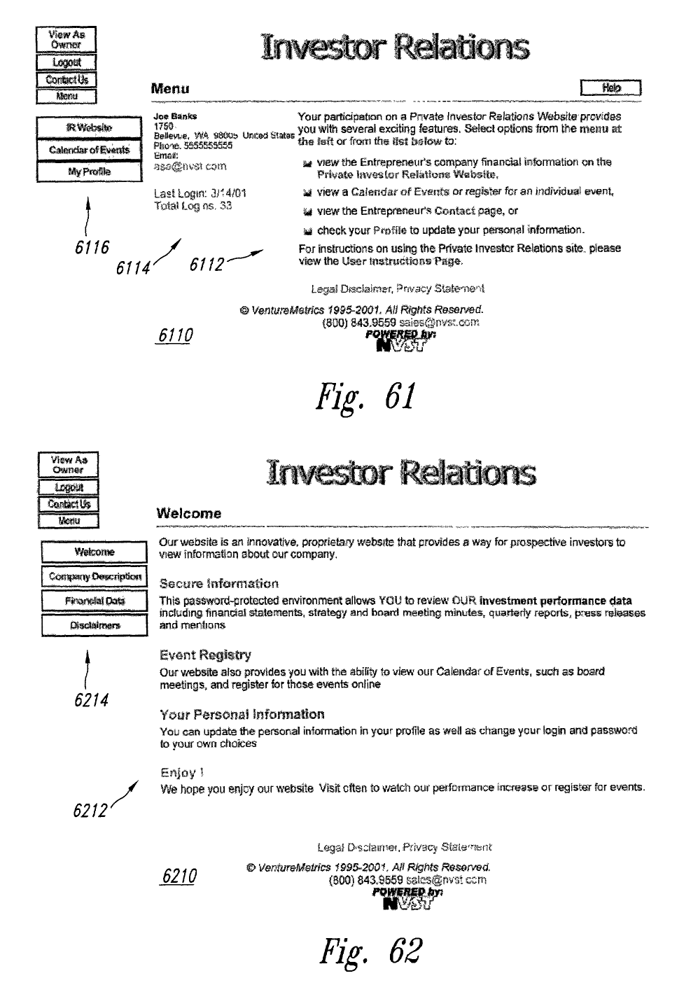

A high-level page 6110 associated with the end-user procedure 6000 is shown in FIG. 61. The high-level page 6110 includes an advisory information section 6112, a personal information section 6114 for the end-user viewing the high-level page, and a high-level menu 6116 of option selections. For the exemplary embodiment, given the particular end-user's access privileges and data found in the components of the venture reporting website, the high-level menu 6116 includes an investor relations (IR) website selection, a calendar of events selection, and a my profile selection. The option selections of the high-level menu 6116 are used by end-users with proper access privileges to view the venture data 62 of the venture reporting website found on the server computer 60.

Upon activation of the investor relations website selection of the high-level menu 6116, a welcome component page 6210 is displayed as shown in FIG. 62. The welcome component page 6210 includes an advisory information section 6212 and a component menu 6214 of option selections for the venture reporting website components. The advisory information section 6212 displays a welcome message for the venture reporting website. For the exemplary embodiment, given the access privileges for the particular end-user viewing the welcome component page 6210 and the data contained in the components of the venture reporting website, the component menu 6214 includes a welcome option selection, a company description option selection, a financial data option selection, and the disclaimers option selection.

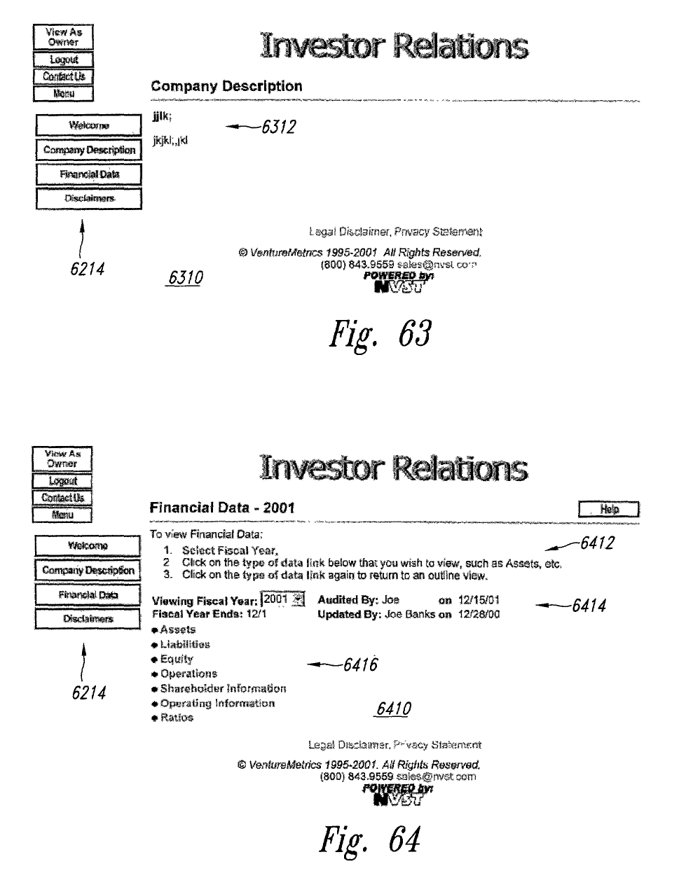

Upon activation of the company description option selection of the component menu 6214, a company description component page 6310 is displayed as shown in FIG. 63. The company description component page 6310 includes a company description 6312.

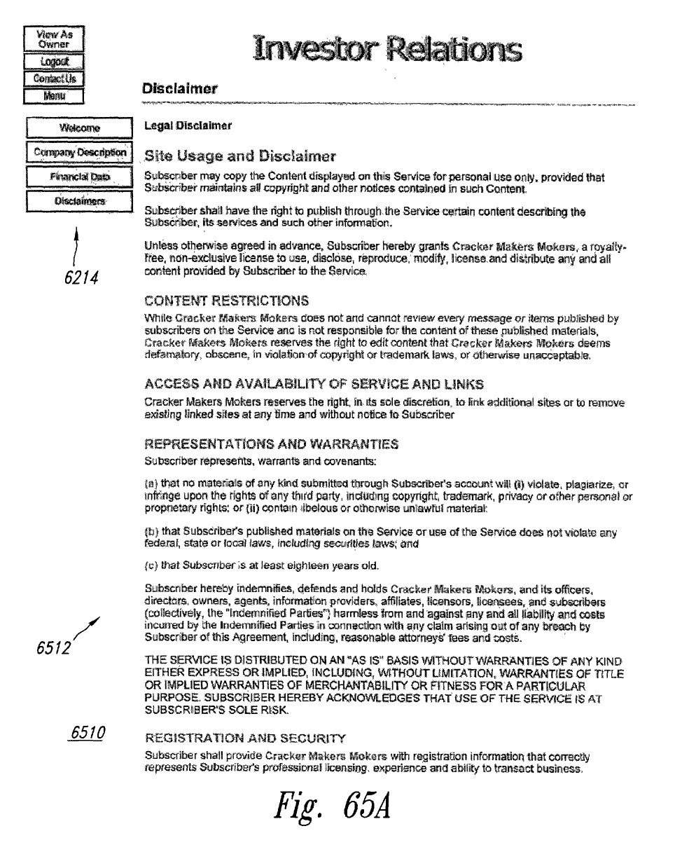

Upon activation of the financial data option selection of the component menu 6214, a financial data component page 6410 is displayed as shown in FIG. 64. The financial data component page 6410 includes an instruction section 6412, a status section 6414 that includes a fiscal year control to select a fiscal year of interest for financial data to be viewed, and a financial data section 6416. In the exemplary embodiment, the financial data section 6416 includes hypertext links to viewable sections of the financial data of the venture data 62, including assets, liabilities, equity, operations, shareholder information, operating information, and ratios. Other embodiments include sections with other financial data.

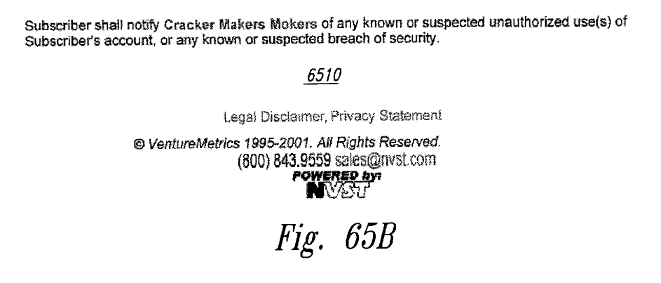

Upon activation of the disclaimers option selection of the component menu 6214, a disclaimer component page 6510 is displayed as shown in FIGS. 65A and 65B. The disclaimer component page 6510 includes a disclaimer 6512 directed in particular to end-users viewing the venture reporting website.

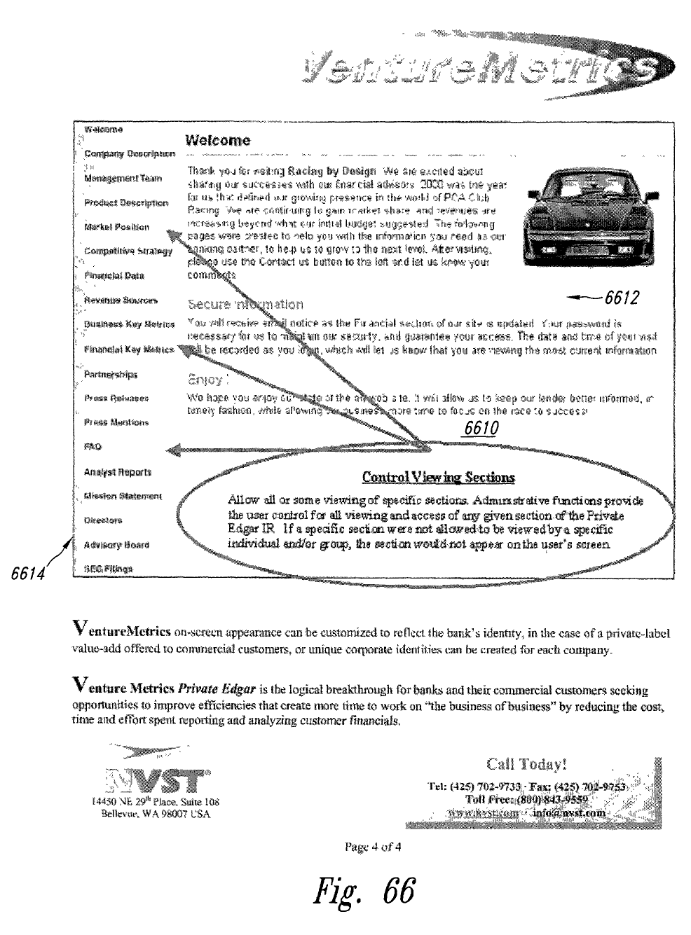

Another exemplary welcome component page 6610 having another welcome message 6612 and another component menu 6614 is shown in FIG. 66. Based upon the access privileges of the end-user viewing the welcome message 6612 and the data contained within the components of the venture reporting website of the exemplary embodiment, the component menu 6614 in this exemplary embodiment has a welcome component option selection, a company description option selection, the management team option selection, a product description option selection, a market position option selection, a competitive strategy option selection, a financial data option selection, a revenue sources option selection, a business key metrics option selection, a financial key metrics option selection, a partnerships option selection, a press releases option selection, a press mentions option selection, an FAQ option selection, an analyst reports option selection, a mission statement option selection, a directors option selection, an advisory board option selection, and an SEC filings option selection. Based upon the access privileges of the viewing end-user and the data contained within the components of the venture reporting website, other embodiments have other combinations of these and other option selections for component menus.

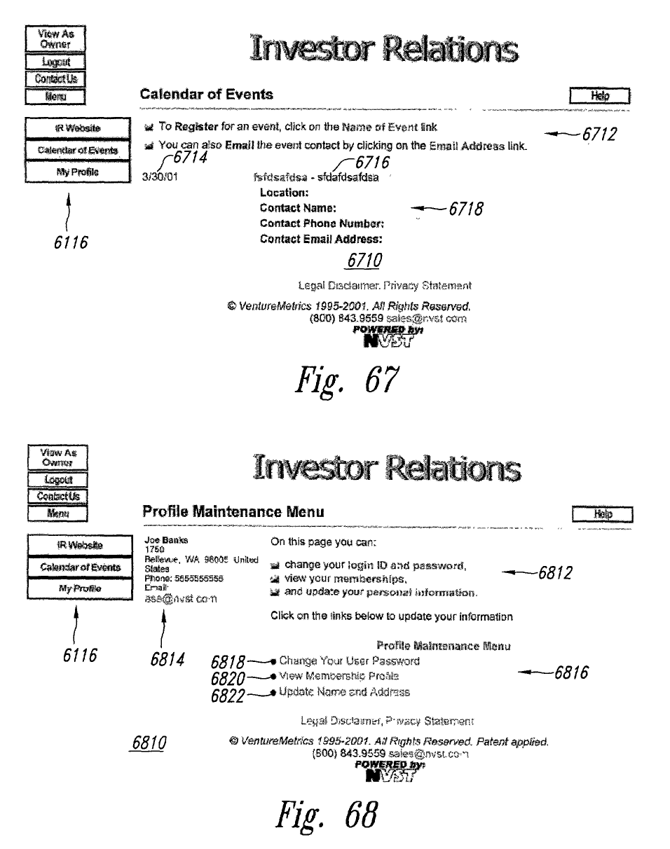

Upon activation of the calendar of events option selection of the high-level menu 6116, a calendar of events page 6710 is displayed as shown in FIG. 67 for events related to the venture. The calendar of events page 6710 includes an instruction section 6712, a date indicator 6714 showing dates for each individual event, a title indicator 6716 displaying the title of the individual event and linking to an automated registration procedure, and a contact section 6718 showing contact information related to the event, including an e-mail activating hypertext link.

Upon activation of the my profile option selection of the high-level menu 6116, a profile maintenance page 6810 is displayed as shown in FIG. 68 to allow the end-user viewing the profile maintenance page to perform such tasks as changing the end-user's access information, viewing information about the end-user's memberships, and updating the end-user's personal information. The profile maintenance page 6810 includes an instruction section 6812, a personal information section 6814 which displays information about the end-user, and a profile maintenance menu 6816 that includes a change user password control 6818 for changing login identification and password information for the end-user, a view membership profile control 6820 for viewing the various memberships of the end-user, and an update name address control 6822 for updating such data of the end-user.

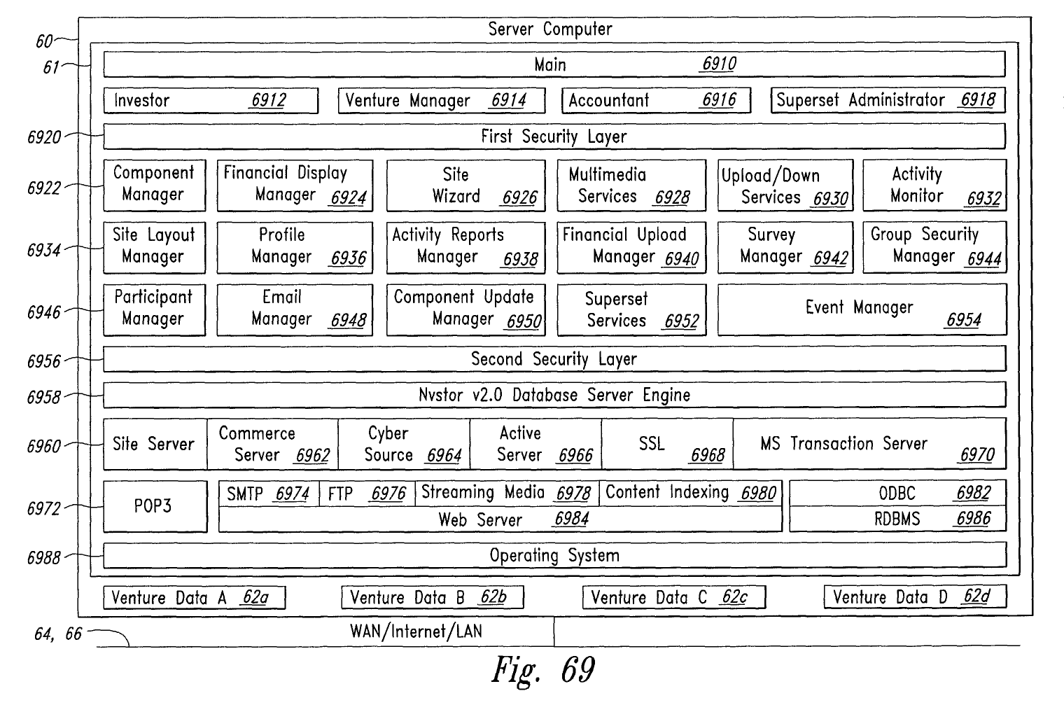

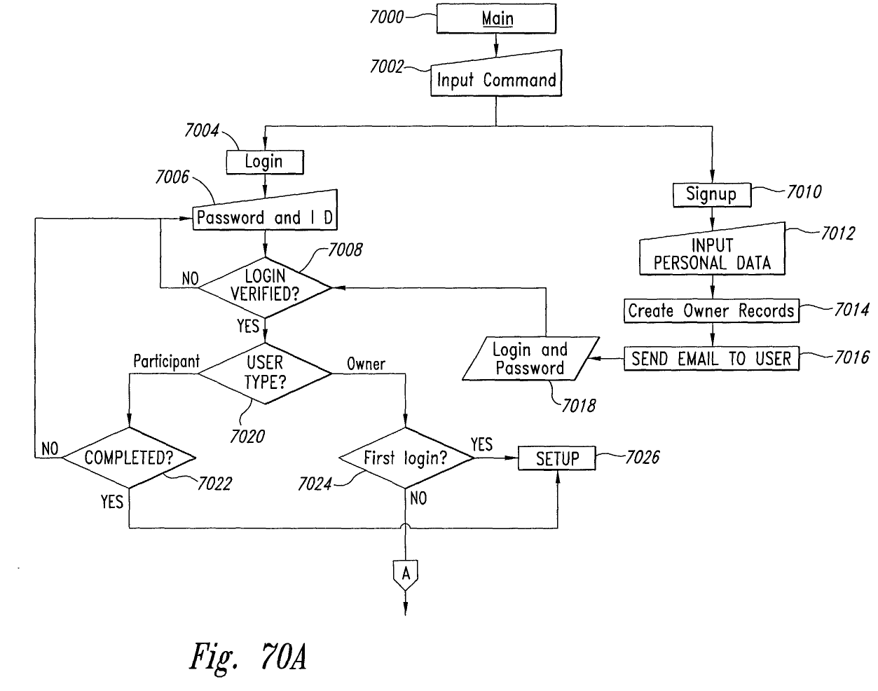

An exemplary embodiment of the server computer 60 showing many various application components resident in the memory 61 used to support aspects of the venture reporting website described above, is shown in FIG. 69. The application components include a main application component 6910 used for such tasks as being a general front end interface between the client computer 10 and the other application components such as with initial login procedures. Application components at a user interface/application layer level include an investor application component 6912, a venture manager application component 6914, an accountant application component 6916, and a superset administrator application component 6918. In addition to the main application component 6910, a first security layer 6920 furnishes additional access procedures to be followed before access is allowed.

To provide functions and services of various aspects described above, the memory 61 of the server computer 60 contains a plurality of specialized component applications, described in further detail below, including a component manager 6922, a financial display manager 6924, a site wizard 6926, a site layout manager 6934, a profile manager 6936, an activity report manager 6938, a financial upload manager 6940, a survey manager 6942, a group security manager 6944, a participant manager 6946, an e-mail manager 6948, a component update manager 6950, and an event manager 6954.

Further component applications resident in the memory 61 of the server computer 60 include a multimedia services component application 6928 used for aspects including selection and uploading of image, audio, and video data files. An upload/download services component application 6930 is also included and is directed toward downloading the financial template on to the client computer 10 and uploading the financial template to the venture data 62 on the server computer 60. An activity monitor application component 6932 is included to involve tracking activity of participants of the venture reporting website with regard to accessing the venture reporting website and reporting this activity in an effectively displayable manner. A superset services component application 6952 is primarily concerned with providing access for the superset administrator application component 6918 to various component applications, in particular, financially related ones such as the financial display manager 6924.

In addition to security aspects related to the main application component and the first security layer 6920, a second security layer section 6956 provides further access procedures to restrict access to the venture reporting website of a particular venture. In an exemplary embodiment, a Nvstor v2.0 Database Server Engine 6958 of NVST, Inc., Bellevue, Wash. was used as a primary database server. Other layers including operations, utility, and communications layers, are conventionally available application components such as from Microsoft Corp., Sun Microsystems, Inc., Hewlett-Packard Corp., and International Business Systems, Inc. These other layers include a site server 6960, a commerce server 6962, a cyber source 6964, and active server 6966, an SSL 6968, a transaction server 6970, a POP3 component 6972, an SMTP component 6974, an FTP component 6976, a streaming media section 6978, a context indexing 6980, an ODBC 6982, a Web server 6984, a RDBMS 6986, and an operating system 6988.

A shown in FIG. 69, the server computer 60 also includes a plurality of the venture data 62 including venture A data 62a, venture B data 62b, venture C data 62c, and venture D data 62d to support a plurality of venture reporting websites for the web-based venture reporting system 80. As explained above, each of the plurality of venture data 62 is associated to a different venture reporting website for a different venture.

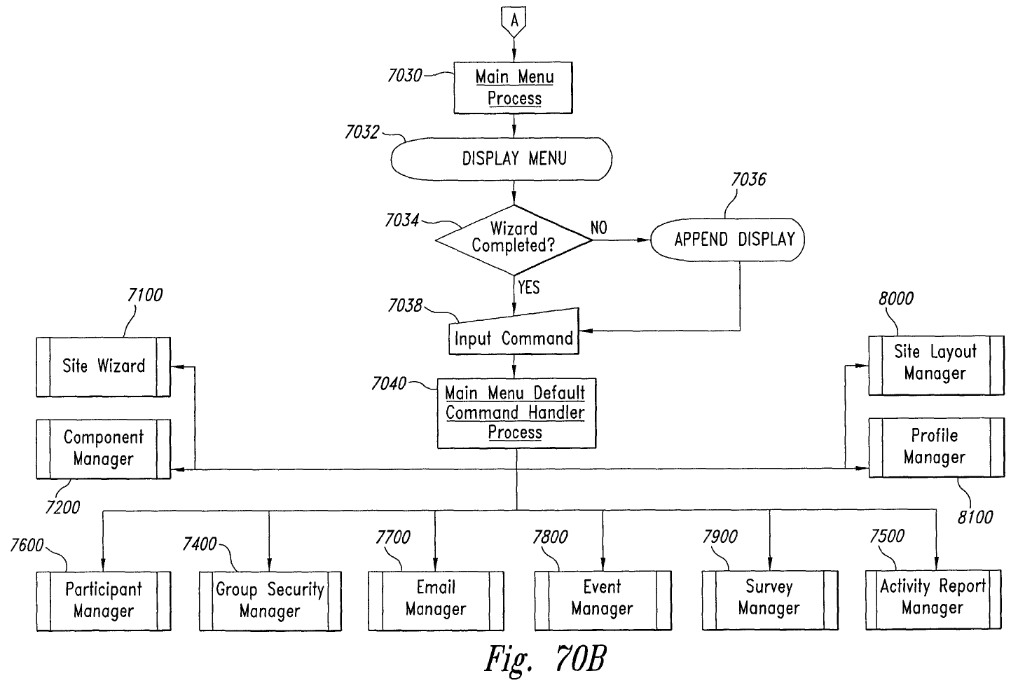

A main procedure 7000 associated with the main application component 6910 running on the server computer 60 is shown in FIG. 70. Based on the main procedure 7000, the main application component 6910 begins by receiving an input command (step 7002) from the client computer 10. If the received input command in step 7002 is recognized as a login command (step 7004), then the main application component 6910 receives an input login for a particular individual and a password associated with the input login from the client computer 10 (step 7006). The login is then verified (step 7008).

If the received input command in step 7002 is recognized as a signup command (step 7010), then the main application component 6910 receives personal data and billing information associated with the particular individual (step 7012) from the client computer 10. After receiving personal data and billing information in step 7012, the main application component 6910 creates one or more data records associated with a particular individual to contain the personal data, billing information, login information, and other information associated with the particular individual (step 7014). The main application component 6910 then generates and sends an e-mail message to the particular individual informing the individual of login procedures and the individual's login and password to be used when accessing the venture reporting website (step 7016).

In response to receiving the e-mail message containing the login procedures, login and password, a login and password is received by the main application component 6910 from the client computer 10 used by the particular individual (step 7018). This login and password is then verified by the main application component 6910 (step 7008). If the login and password are not verified (no branch of step 7008), the main application component 6910 waits to receive another login and password (step 7006). Otherwise, the main application component 6910 branches under the yes condition of step 7008 to determine what type of user is the particular logged-in individual (step 7020).

If the particular individual is a participant (participant branch of step 7020), the main application component 6910 then determines if the owner has completed the venture reporting website (step 7022), and if not (no branch of step 7022), waits to receive another login and password (step 7006). If the particular individual is the owner (owner branch of step 7020), the main application component 6910 determines if the received login is a first login for the particular individual (step 7024), and if not (no branch of step 7024), goes to a main menu process (step 7030). If the owner has completed the venture reporting website to satisfy the yes branch of step 7022 or the received login is a first login for the particular individual to satisfy the yes branch of step 7024, then the main application component 6910 performs a first time set up for the site (step 7026).

In implementing the main menu process (step 7030), the main application component 6910 displays (step 7032) the high-level menu 2214 of the high-level page 2210 containing options selections such as shown in FIG. 22. The main application component 6910 then determines if the steps associated with the site wizard application component 6926 have been completed and if not (no branch of step 7034), the main application component 6910 appends for display (step 7036) various command options used with the site wizard application component 6926 to activate wizard functions as described above.

If the main application component 6910 determines that the steps associated with the site wizard application component 6926 have been completed (yes condition of step 7034), then the main application component 6910 waits to receive an input command (step 7038) from the client computer 10, and upon receipt of an input command goes on to the main menu default command handler process (step 7040). The main menu default command handler process is used by the main application component 6910 to activate procedures associated with application components based upon the received input command. These procedures include a site wizard procedure 7100, a component manager procedure 7200, a group security manager 7400, an activity report manager 7500, a participant manager procedure 7600, an email manager procedure 7700, an event manager procedure 7800, a survey manager procedure 7900, a site layout manager procedure 8000, and a profile manager procedure 8100.

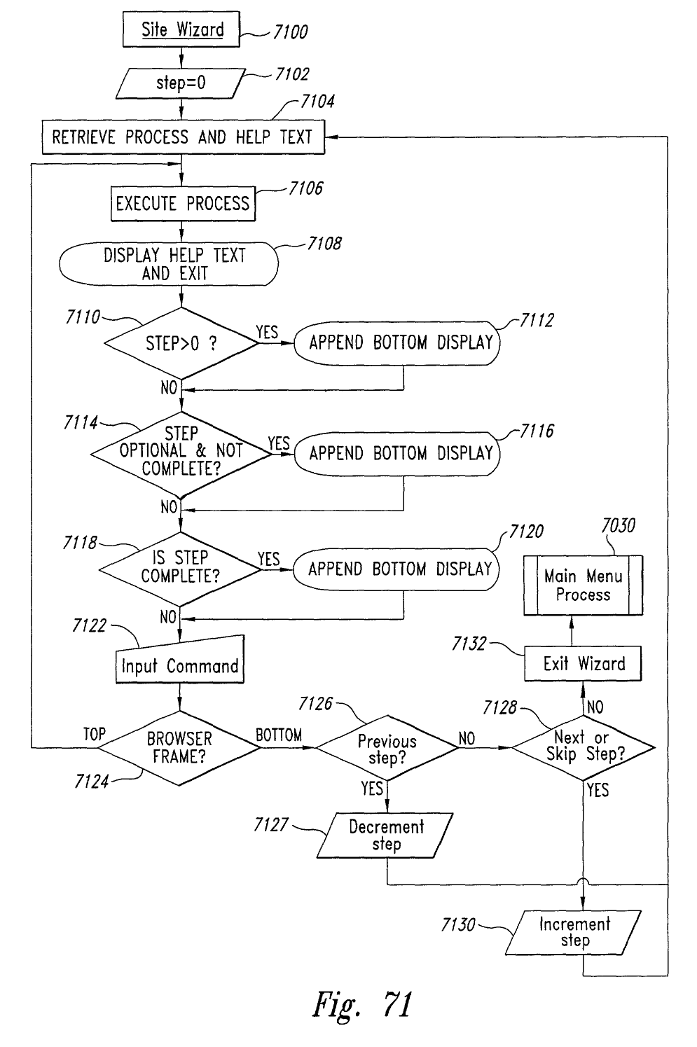

The site wizard procedure 7100 is associated with the site wizard application component 6926 and is shown in FIG. 71. In conjunction with the site wizard procedure 7100, the site wizard application component 6926 splits a Web browser window displayed by the client computer 10 into two frames: an upper frame and a lower frame. In the upper frame input forms and controls of a process are loaded for the particular individual using the client computer to complete and operate. In the lower frame, instructions are displayed to direct the particular individual to complete the input forms and operate the controls of the process. In implementing the site wizard procedure 7100, the site wizard application component 6926 begins by initiating a variable (labeled “step” in FIG. 71) by setting it equal to zero (step 7102). Each predefined value of the step variable represents one of the processes and its related set of instructions.

Based upon the value of the step variable, the site wizard application component 6926 retrieves an associated process and its related set of instructions (step 7104). The retrieved process is then executed and displayed in the top frame of the browser on the client computer 10 (step 7106). Instructions are then displayed along with an exit command in the bottom frame of the browser on the client computer 10 (step 7108).

A determination is then made whether the step variable is greater than zero (step 7110), and if so (yes branch of step 7110), the bottom frame of the browser is appended to display a previous step command (step 7112). Otherwise (no branch of step 7110), a determination is made whether the step variable is optional and not complete, and if so (yes branch of step 7114), the bottom frame of the browser is appended to display a skip step command (step 7116). Otherwise (no branch of step 7114), a determination is made whether the step variable is complete, and is so (yes branch of step 7118), the bottom frame of the browser is appended to display a next step command. Otherwise (no branch of step 7118), the site wizard application component 6926 awaits an input command (step 7122).

Upon receipt of the input command, a determination is made as to whether the lower or upper browser frame received the input command, and if the top frame received input command (top branch of step 7124), the site wizard procedure 7100 branches to execute another process (step 7106). Based upon input commands received by the top frame of the browser, the step variable will eventually be set equal to the value “complete” under typical conditions.

If the input command is received by the bottom frame of the browser (bottom branch of step 7124), a determination is made whether the input command is to go back to the step previous to the current step, and if so (yes branch of step 7126), the step variable is decremented (step 7128) and the site wizard procedure 7100 returns back to retrieve another process and instructions set found in step 7104. Otherwise (no branch of step 7106), a determination is made whether the input command is for the next step or to skip step, and if so (yes branch of step 7128), the step variable is incremented (step 7130) and the site wizard procedure 7100 returns back to retrieve another process and instructions set found step 7104. Otherwise (no branch of step 7128), the site wizard procedure 7100 performs an exit process (step 7132) and then returns to the main menu process 7030.

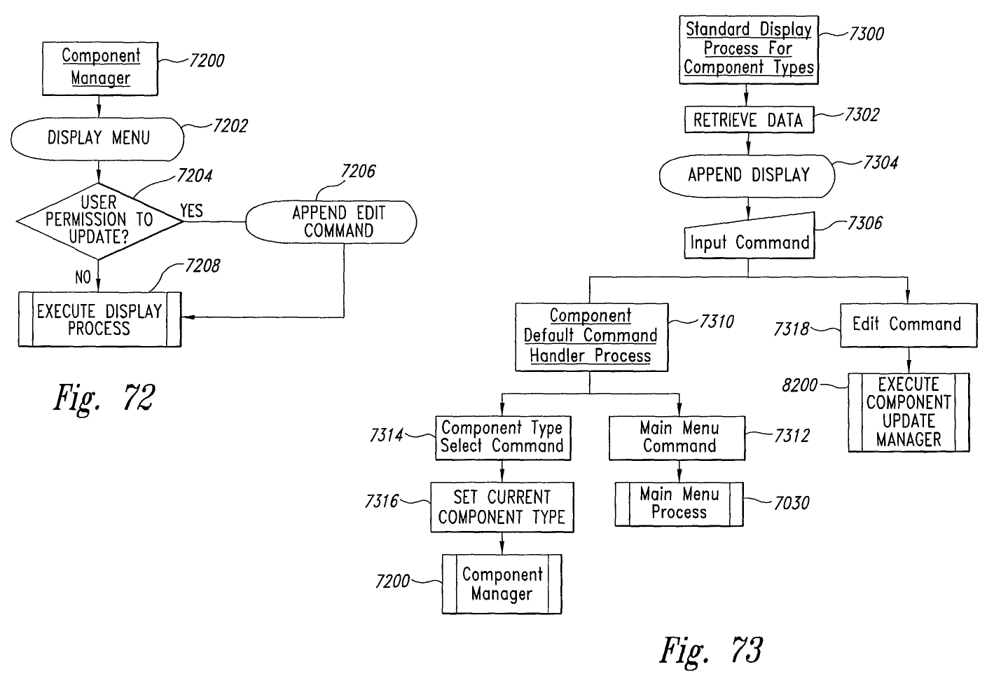

The component manager procedure 7200 is associated with the component manager application component 6922 and is illustrated in FIG. 72. A component found in the venture reporting website is a feature or set of data that is useful for the venture manager to display such as a company description, a description of the management team, financial data, or other components such as, but not limited to, those described above. The component manager first displays (step 7202) a menu of all components that a particular individual using the venture reporting website has permissions to access. The component manager procedure then determines if the particular individual has permission to update the current component type, and if so (yes branch of step 7204), a component edit command is appended for display (step 7206). Otherwise (no branch of step 7204), an appropriate display process is executed based upon the current component type (step 7208).

A standard display process for component types 7300 is illustrated in FIG. 73. Data is retrieved corresponding to the current component type (step 7302). Data based on the current component type is then appended for display (step 7304). The standard and display process pauses to await an input command (step 7306). Based upon the received input command a component default command handler process may be activated (step 7310). If the input command is of the high-level menu 2214 (step 7312), then return is made to the main menu process (step 7030). If the input command is a component types select command (step 7314), then the current component type is set to the selected component type (step 7316) and return is made to the component manager procedure 7200. If the received input command in step 7306 is an edit command (step 7318), then a component update manager procedure 8200 is executed for the appropriate component.

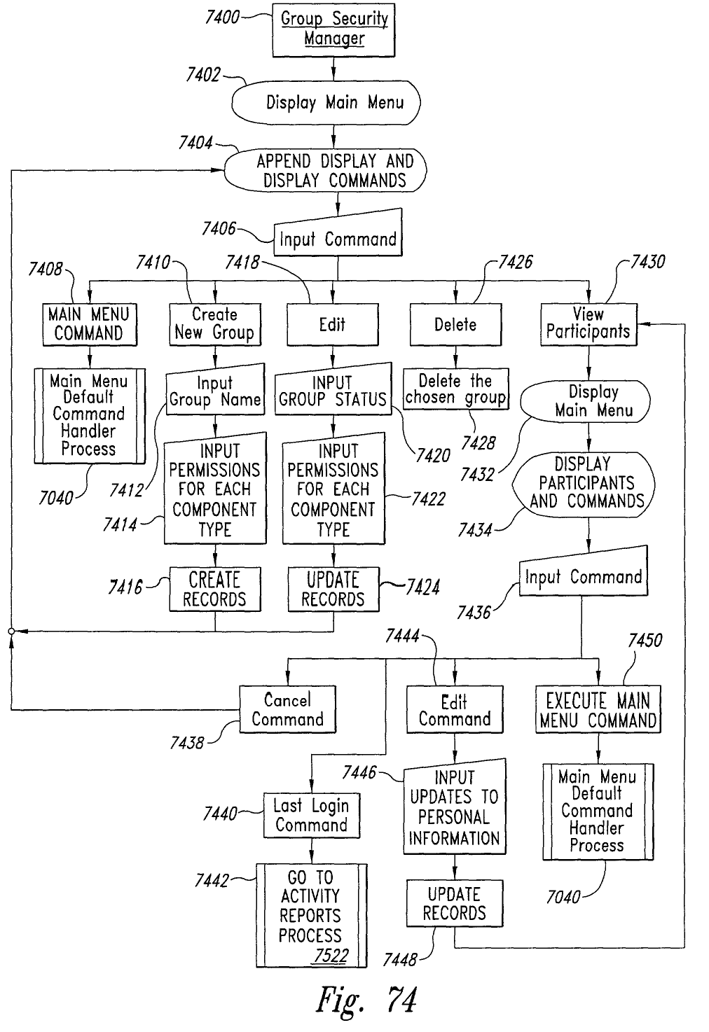

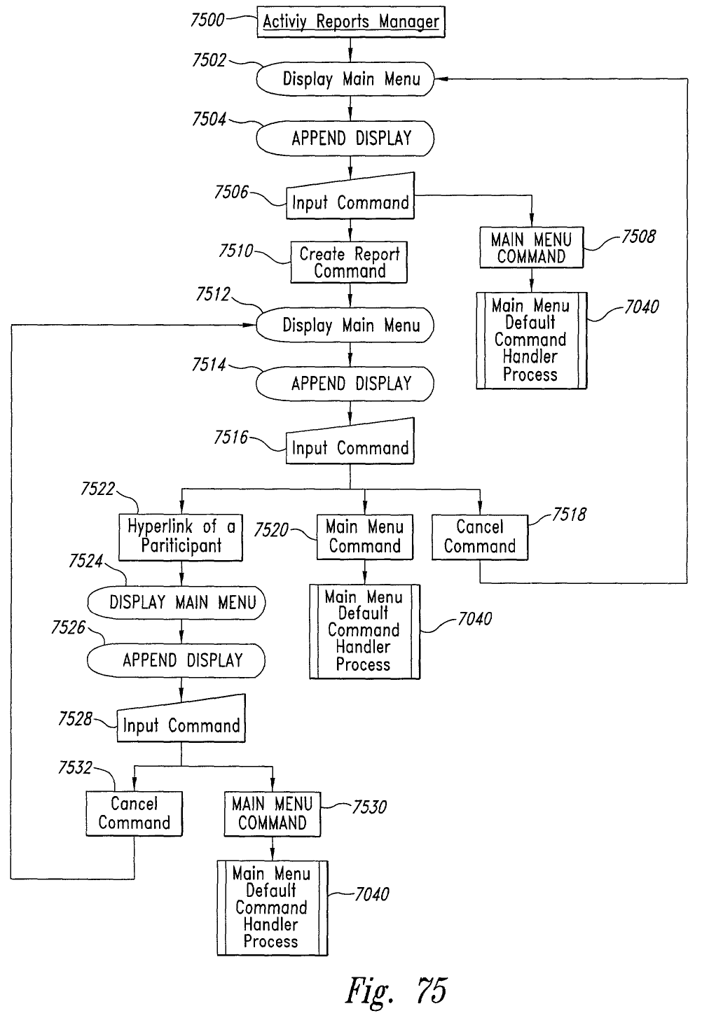

The group security manager procedure 7400 is associated with the group security manager application component 6944 and is shown in FIG. 74. Each participant has a set of associated permissions. These permissions control the participant's access to processes and features of the venture reporting website. A participant can have a few permissions to only a few select components or can have almost as many permissions as has an owner of the venture reporting website. These permissions are assigned to different groups similar to roles in database management associated with Oracle databases and user groups associated with Windows NT operating system by Microsoft Corporation. The participant may be a member of one or more groups and is given the set of permissions for each group they are in.

The group security manager procedure 7400 begins by displaying the high-level menu 2214 (step 7402). A list of groups is appended for display and for each group an edit command, a view participants command, and a delete command are displayed (step 7404). The group security manager procedure 7400 then awaits an input command (step 7406). If a command associated with the high-level menu 2414 is received (step 7408), then return is made to the main menu default command handler process 7040.

If a create new group command is received (step 7410), the group security manager procedure 7400 awaits a group name input (step 7412). Upon receipt of the group name input, the group security manager procedure 7400 awaits receipt of permissions associated with each component type for the particular group associated with the group name input (step 7414). Upon receipt of the permissions, database records are created associated with the named group (step 7416) and return is made to display the high-level menu 2214 (step 7402).

If an edit command is received (step 7418), the group security manager procedure 7400 awaits input of the group status whether it is active or inactive (step 7420). Upon receipt of the group status, the group security manager procedure 7400 awaits input of permissions associated with each component type for a designated group whose records are to be edited (step 7422). Upon receipt of the permissions, database records associated with the designated group are updated (step 7424) and return is made to display the high-level menu 2214 (step 7402).

If a delete command is received (step 7426), the chosen group designated by the delete command is deleted from the venture data 62 (step 7428). If a group has an active or deleted status, any participant who is a member of the group will not receive the permissions associated with the group.

If a view participants command is received (step 7430), the high-level menu 2214 is displayed (step 7432). A list of participants who are a member of an identified group are then displayed, and for each participant, an edit command and a last login command are displayed (step 7434). The group security manager procedure 7400 then awaits receipt of another input command (step 7436). Upon receipt of a cancel command (step 7438), return is made to display the high-level menu 2214 (step 7402). Upon receipt of a last login command (step 7440), the group security manager procedure 7400 goes to the activity reports process 7522 (step 7442). Upon receipt of an edit command (step 7444), the group security manager procedure 7400 awaits receipt of the updates to personal information of selected participants (step 7446). Upon receipt of update personal information, records of the selected participants are updated (step 7448) and return is made to step 7430 as though a view participants command had just been received. Upon receipt of an execute main menu command (step 7450), return is made to the main menu default command handler process 7040 (step 7452).

The activity reports manager procedure 7500 is associated with the activity monitor component application 6932 and is illustrated in FIG. 75. The activity reports manager procedure 7500 begins by displaying the high-level menu 2214 (step 7502). A list box containing all groups and the command create report are then appended for display (step 7504). The activity reports manager procedure 7500 then awaits an input command (step 7506). If a main menu command is received (step 7508), return is made to the main menu default command handler process 7040. If a create report command is received (step 7510), the high-level menu 2214 is displayed (step 7512) and then a list of each participant who is a member of the group chosen from the list box having login dates for the last month are appended for display (step 7514).

The activity reports manager procedure 7500 then awaits another input command (step 7516). If a cancel command is received (step 7518), return is made to display the high-level menu 2214 (step 7502). If a main menu command is received (step 7520), return is made to the main menu default command handler process 7040. If a hyperlink of a participant is received (step 7522), the high-menu 2214 is displayed (step 7524) and a list of component types and times that the participant accessed the component types on a selected login date are appended for display (step 7526).

The activity reports manager procedure then awaits another input command (step 7528). If a cancel command is received (step 7532), return is made to display the high-level menu 2214 (step 7512). If a main menu command is received (step 7530), return is made to the main menu default command handler process 7040.

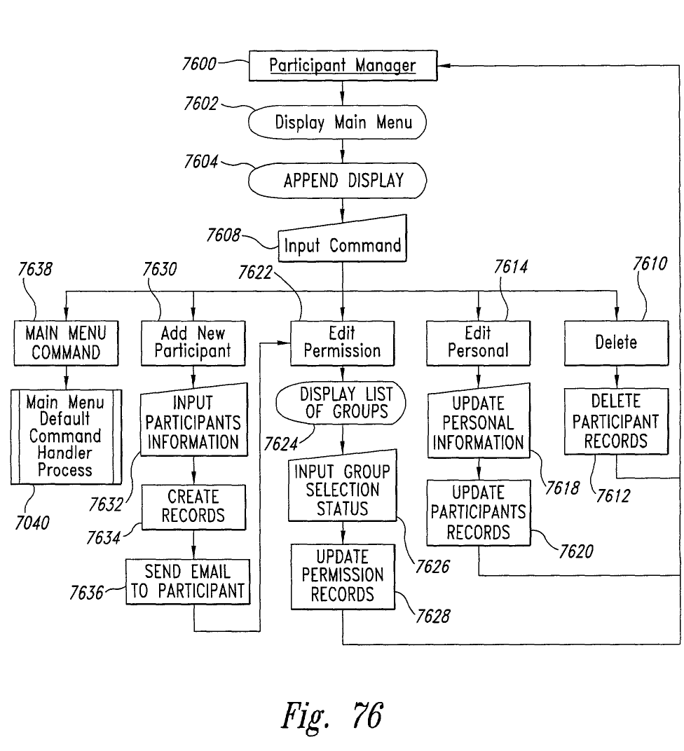

The participant manager procedure 7600 is associated with the participant manager component application 6946 and is shown in FIG. 76. The participant manager procedure 7600 begins by displaying the high-level menu 2214 (step 7602), and then a list of all participants are appended for display whereby an associated edit permission command, edit information command and delete command are displayed for each participant along with an add new participant command (step 7604).

The participant manager procedure 7600 then awaits an input command (step 7608). Upon receipt of a delete command (step 7610), selected participant records are deleted and their login is removed from the venture data 62 and return is made to the beginning of the participant manager procedure 7600. Upon receipt of an edit personal command (step 7614), personal information of a selected participant is updated (step 7618), associated data records for the participant are updated (step 7620), and return is made to the beginning of the participant manager procedure 7600.

Upon receipt of an edit permission command (step 7622), a list of groups indicating groups of which the selected participant is currently member are displayed (step 7624). The participant manager procedure 7600 then awaits input of selection status regarding additions and removals of groups from a selection's list (step 7626). Upon receipt of the selection status, participant permission records are updated (step 7628) and return is made to the beginning of the participant manager procedure 7600.

Upon receipt of an add new participant command (step 7630), the participant manager procedure 7600 awaits personal information, including e-mail information, regarding the new participant (step 7632). Upon receipt of the personal information, data records associated with the participant are added to the venture data 62 (step 7634), an e-mail is sent to the new participant informing them of their new login and password for accessing the venture reporting website (step 7636), and return is made to step 7622 as though an edit permission command was just received. Upon receipt of a main menu command (step 7638), return is made to the main menu default command handler process 7040.

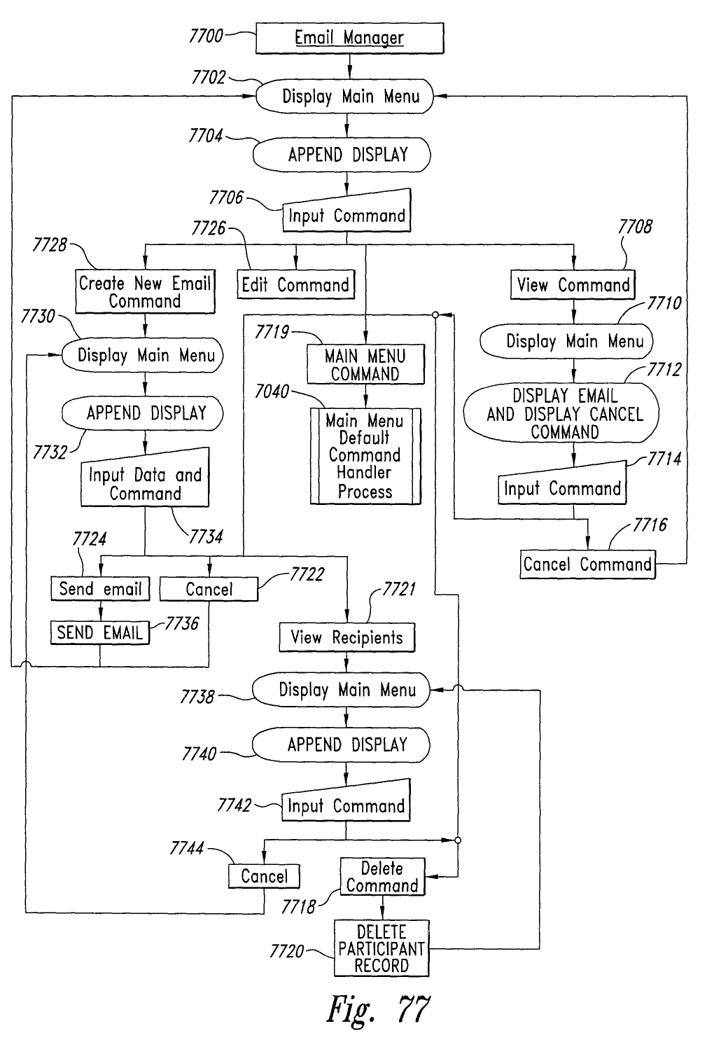

The e-mail manager procedure 7700 is associated with the e-mail manager component application 6948 and is displayed in FIG. 77. The e-mail manager procedure 7700 begins by displaying the high-level menu 2214 (step 7702). The following are then displayed: a list of all e-mails sent or in draft stage; a delete command for each e-mail; an edit command for each e-mail in draft form; a view command for each e-mail sent; and a create new e-mail command selection (step 7704). The e-mail manager procedure 7700 then awaits the receipt of an input command (step 7706). Upon receipt of a view command (step 7708), the high-level menu 2214 is displayed (step 7710). A sent e-mail associated with the received view command is displayed along with a cancel command selection (step 7712). The e-mail manager procedure 7700 then awaits another input command (step 7714). Upon receipt of a cancel command (step 7716), return is made to display the high-level menu 2214 (step 7702).

Upon receipt of a main menu command (step 7720), a return is made to the main menu default command handler process 7040.

Upon receipt of a view recipients command (step 7721), the high-level menu 2214 is displayed (step 7738). The following is then displayed: a list of all participants that are a member of a selected group in a list box before the view recipients command is received and a delete command selection for each participant (step 7740). The e-mail manager procedure 7700 then awaits another input command (step 7742). Upon receipt of a delete command (step 7718), a participant record is deleted from a recipient list (step 7720) so the participant does not received further e-mail and return is made to display the high-level menu 2214 (step 7738).

Upon receipt of a cancel command (step 7722), a return is made to display the high-level menu 2214 (step 7702).

Upon receipt of a send e-mail command (step 7724), an e-mail is sent to e-mail addresses corresponding to each participant on a recipient list and the sent e-mail is marked as sent (step 7736). A return is then made to display the high-level menu 2214 (step 7702).

Upon receipt of an edit command (step 7726), e-mail editing utilities are provided.

Upon receipt of a create new e-mail command (step 7728), the high-level menu 2214 is displayed (step 7730). An input form having a from address, subject, and a body; and a list box containing groups of participants to receive the created e-mail; and a view recipients command selection, a send e-mail command selection, and a cancel command selection are appended for display (step 7732). The e-mail manager procedure 7700 then awaits input of data and another command (step 7734).

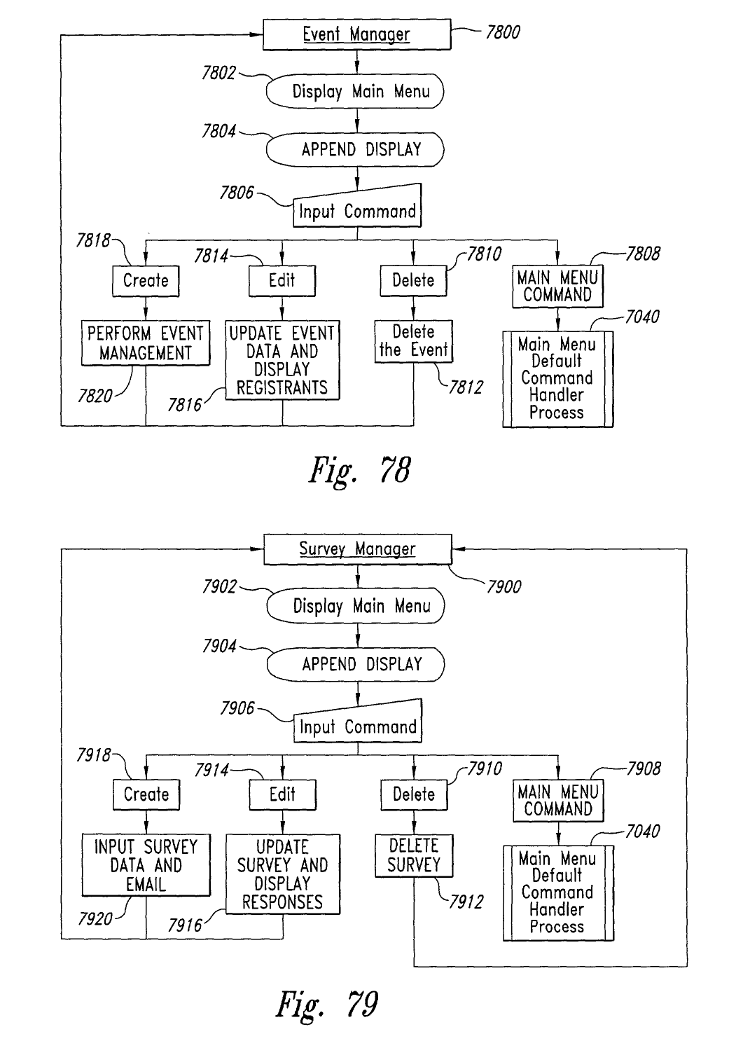

The event manager procedure 7800 is associated with the event manager component application 6954 and shown in FIG. 78. The event manager procedure 7800 begins by displaying the high-level menu 2214 (step 7802). A list of events with create, edit, and delete commands are then appended for display (step 7804). The event manager procedure 7800 then awaits an input command (step 7806). Upon receipt of a main menu command (step 7808), return is made to the main menu default command handler process 7040.

Upon receipt of a delete command (step 7810), a selected event is deleted (step 7812) and return is made to the beginning of the event manager procedure 7800.

Upon receipt of an edit command (step 7814), the event data is updated and registrant information is displayed (step 7816) and return is made to the beginning of the event manager procedure 7800.

Upon receipt of a create command (step 7818), an event is added to the venture data 62, with starting and closing dates set, and the event is assigned an attendance price (step 7820) and return is made to the beginning of the event manager procedure 7800.

The survey manager procedure 7900 is associated with the survey manager component application 6942 and is shown in FIG. 79. The survey manager procedure 7900 begins by displaying the high-level menu 2214 (step 7902). A list of surveys with create, edit, and delete commands is appended for display (step 7904). The survey manager procedure 7900 then awaits an input command (step 7906). Upon receipt of a main menu command (step 7908), return is made to the main menu default command handler process 7040.

Upon receipt of a delete command (step 7910), a selected survey is deleted (step 7912) and return is made to the beginning of the survey manager procedure 7900.

Upon receipt of an edit command (step 7914), a selected survey is updated and responses are displayed (step 7916) and return is made to the beginning of the survey manager procedure 7900.

Upon receipt of an e-mail create command (step 7918), survey question data is inputted to the venture data 62 and e-mails containing survey questions are sent to participants (step 7920), and return is made to the beginning of the survey manager procedure 7900.

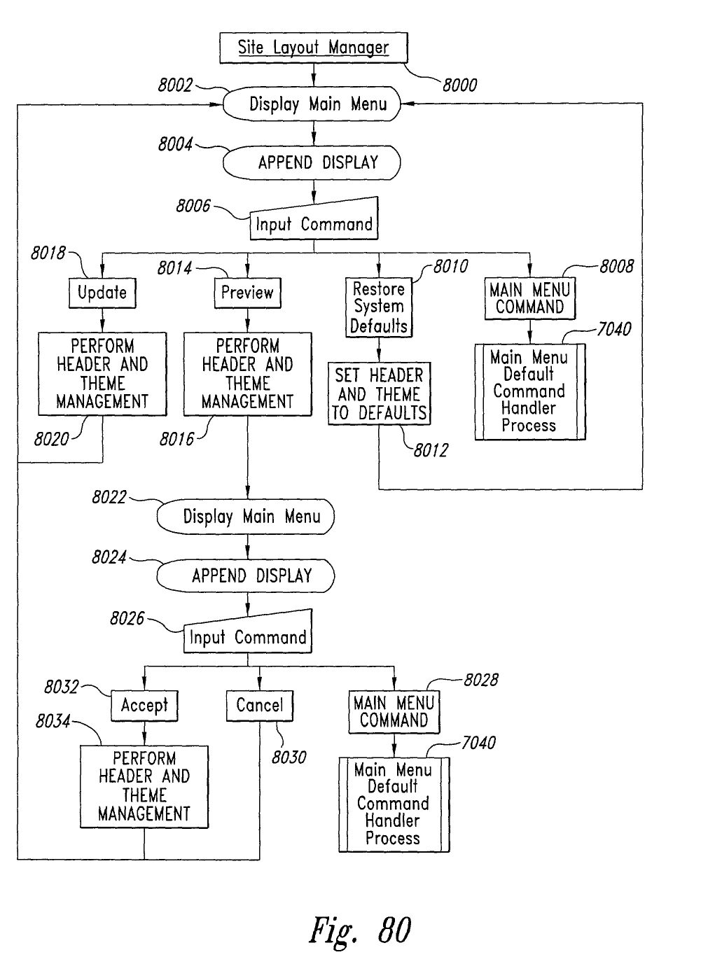

The site layout manager procedure 8000 is related to the site layout manager component application 6934 and is shown in FIG. 80. The site layout manager procedure 8000 begins by displaying the high-level menu 2214 (step 8002). Appended for display are a theme list box, company logo header file upload box, and display commands including preview, update, and restore system defaults (step 8004). The site layout manager procedure 8000 then awaits an input command (step 8006). Upon receipt of a main menu command (step 8008), return is made to the main menu default command handler process 7040.

Upon receipt of a restore system defaults command (step 8010), the header and theme are sent to default values (step 8012) and return is made to displaying the high-level menu 2014 in step 8002. Upon receipt of a preview command (step 8014), header and theme management are performed including retrieving and storing an uploaded header image and temporarily setting the current theme to the selected theme (step 8016). The high-level menu 2214 is then displayed (step 8022). Subsequently, the theme list box and company logo header file upload box along with accept and cancel display commands are appended for display (step 8024). The site layout manager procedure 8000 then awaits an input command (step 8026). Upon receipt of a main menu command (step 8028), return is made to the main menu default command handler process 7040. Upon receipt of a cancel command (step 8030), return is made to display the high-level menu 2214 (step 8002). Upon receipt of an accept command (step 8032), a temporary image is stored as the header image and a current theme is changed to a temporary theme (step 8034), and return is made to display the high-level menu 2214 (step 8002).

Upon receipt of an update command (step 8018), an uploaded header image is retrieved and stored in the venture data 62 as the near header image and the current theme is changed to the selected theme (step 8020), and return is made to display the high-level menu 2214 (step 8002).

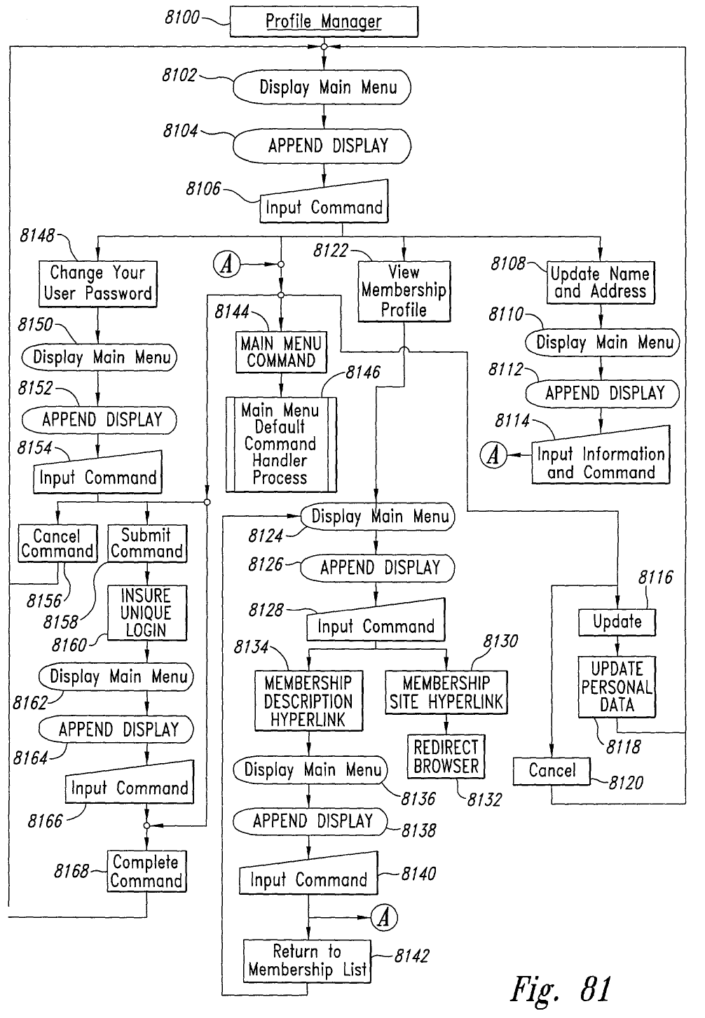

The profile manager procedure 8100 is associated with the profile manager component application 6930 and is shown in FIG. 81. The profile manager procedure 8100 begins by displaying the high-level menu 2214 (step 8102). Command selections including change user password, membership profile, and update name and address are then displayed (step 8104). The profile manager procedure 8100 then awaits receipt of an input command (step 8106).

Upon receipt of an update name and address command (step 8108), the high-level menu 2014 is displayed (step 8110). A formal line editing of personal information, a cancel command selection, and an update command selection are then displayed (step 8112). The profile manager procedure 8100 then awaits input of information and another command (step 8114). Upon receipt of an update command (step 8116), personal information is updated in the venture data 62 (step 8118) and return is made to display the high-level menu 2014 (step 8102). Upon receipt of a cancel command (step 8120), return is made to display the high-level menu 2214 (step 8102).

Upon receipt of a view membership profile command (step 8122), the high-level menu 2014 is displayed (step 8124). A list of members, potentially including those members of other venture reporting websites, with hyperlinks to membership descriptions for each member are all displayed (step 8126). The profile manager procedure 8100 then awaits receipt of another input command (step 8128). Upon receipt of a membership site hyperlink (step 8130), the browser of the client computer 10 is redirected to a new site address (step 8132). Upon receipt of a membership description hyperlink (step 8134), the high-level menu 2214 is displayed (step 8136). A selected membership description, sign update, expiration date, and return to membership command selection is then displayed (step 8138). The profile manager procedure 8100 then awaits receipt of another input command (step 8140). Upon receipt of a return to membership list command (step 8142), a return is made to display the high-level menu 2014 (step 8124).

Upon receipt of a main menu command (step 8144), return is made to the main menu default command handler process (step 8146).

Upon receipt of a change your user password command (step 8148), the high-level menu 2014 is displayed (step 8150). A form containing areas to insert login, numbers, pastor, pastor confirmation, cancel command selection and submit command selection is then displayed (step 8152). The profile manager procedure 8100 then awaits receipt of another input command (step 8154). Upon receipt of a cancel command (step 8156), return is made to display the high-level menu 2214 (step 8102).

Upon receipt of a submit command (step 8158), a login is verified as unique, and if not, a unique login is created using three one digit numbers appended to the end of the entered login (step 8160). The high-level menu 2014 is then displayed (step 8162). A confirmation message containing the new login and password and a complete command selection is next displayed (step 8164). The profile manager procedure 8100 then awaits another input command (step 8166). Upon receipt of a complete command (step 8168), a return is made to display the high-level menu 2214 (step 8102).

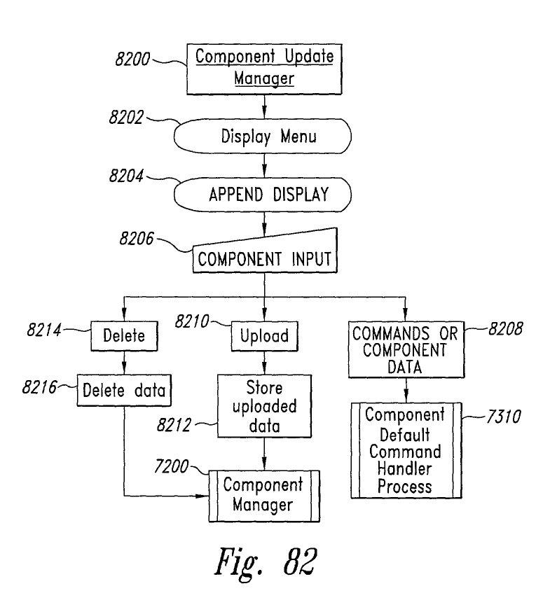

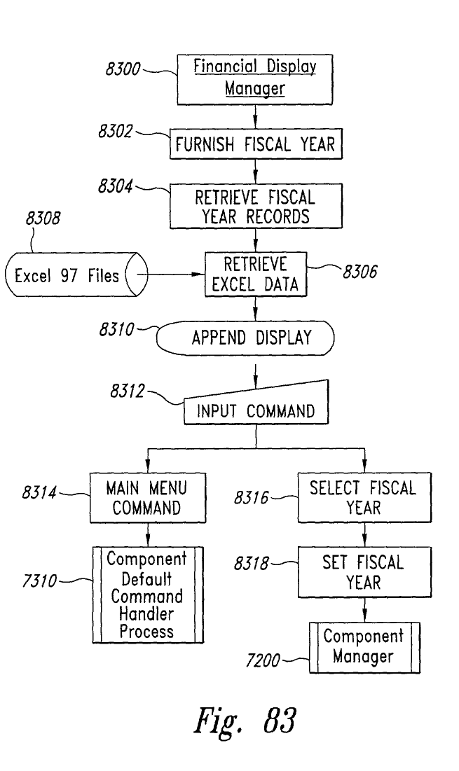

A component update manager procedure 8200 is associated with the component update manager component application 6950 and is shown in FIG. 82. The component update manager procedure 8200 begins by displaying a menu with commands for all component types that the particular individual has permission to view and a main menu command (step 8202). Next, current component data, an upload command, and a delete command are displayed (step 8204).

The component update manager procedure 8200 then awaits component data, files, and commands to be received (step 8206). Upon receipt of commands or component data (step 8208), return is made to the component default command handler process 7310. Upon receipt of an upload command (step 8210), uploaded data is stored to the venture data 62 (step 8212), and return is made to the component manager procedure 7200. Upon receipt of a delete command (step 8214), data related to a selected component is deleted (step 8016), and return is made to the component manager procedure 7200.

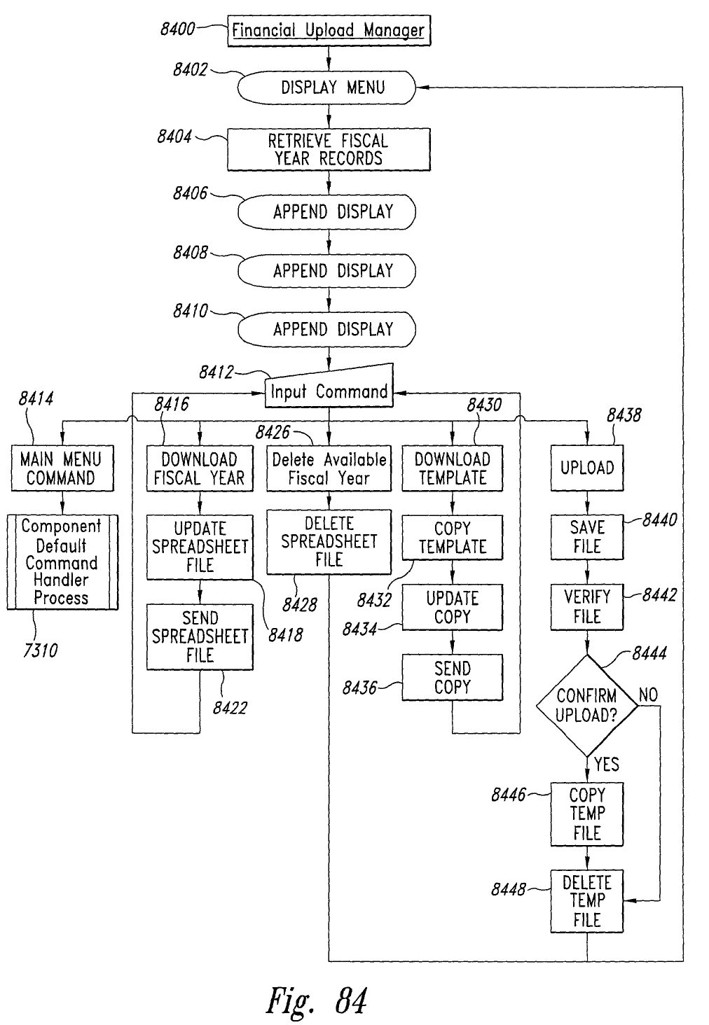

A financial display manager procedure 8300 is associated with the financial display manager component application 6924 and is shown in FIG. 83. If a chosen fiscal year variable is not set, then be chosen fiscal year variable is set to the most recent available fiscal year (step 8302). An available fiscal year is defined as a fiscal year for which the venture manager or other user with permission has uploaded a spreadsheet template, such as an Excel spreadsheet, via a financial data component type update process.

Records are then retrieved to indicate available fiscal years (step 8304). Spreadsheet data is then retrieved (step 8306), which in the depicted embodiment is found in Excel spreadsheet files (step 8308). Retrieved data and an available fiscal years list box are then appended for display (step 8310).

The financial display manager procedure 8300 then awaits an input command (step 8312). Upon receipt of a main menu command (step 8314), return is made to the component default command handler process 7310. Upon a select fiscal year command (step 8316), the chosen fiscal year variable is set to the selected fiscal year (step 8318) and return is made to the component manager procedure 7200.

A financial upload manager procedure 8400 is associated with the financial upload manager 6940 and is shown in FIG. 84. The financial upload manager procedure 8400 begins by displaying a menu with commands for all component types that a particular individual has permission to view and also displays the main menu command (step 8402), which when activated causes display of the high-level menu 2214. Records are then retrieved, which indicate available fiscal years (step 8404). A list box of available fiscal years and download and delete commands are appended for display (step 8406). A list box of available fiscal years for years 1975 to the current year excluding those associated with step 8406, are appended for display (step 8408). An upload command is then appended for display (step 8410).

The financial upload manager procedure 8400 then awaits an input command (step 8412). Upon receipt of a main menu command (step 8414), return is made to the component default command handler process 7310.

Upon receipt of a download available fiscal year command (8416), a spreadsheet file, such as an Excel file, is updated corresponding to the chosen fiscal year including the download time and the user identification (step 8418). The updated spreadsheet file is then sent to the client computer 10 being used by the particular individual (step 8422), and return is made to step 8412 and the financial upload manager procedure 8400 awaits another input command.

Upon receipt of a delete available fiscal year command (step 8426), a selected spreadsheet file, such as an Excel file, is deleted (step 8428).

Upon receipt of a download template command (step 8430), a spreadsheet template, such as an Excel spreadsheet template, is copied from the venture data 62 (step 8432). The copied spreadsheet template is updated with the selected fiscal year, download time, and user identification form (step 8434). The copied spreadsheet template is then sent to the client computer 10 used by the particular individual (step 8436), and return is made to step 8412 and the financial upload manager procedure 8400 awaits another input command.

Upon receipt of an upload command (step 8438), a completed version of the spreadsheet template file containing financial data inputted by the particular individual using an input device such as the keyboard 42 is sent from the client computer 10 used by the particular individual to the server data 62 on the server computer 60 and stored in a temporary directory (step 8440). The file type of the completed spreadsheet template file is then determined and verified (step 8442). A determination is then made that the completed spreadsheet template file was successfully sent from the client computer 10 to the venture data 62 on the server computer 60. If successful (yes branch of step 8444), the spreadsheet template file stored in the temporary directory is stored in a permanent location by coping the temporary file over corresponding available fiscal year data if it exists or by creating a new permanent file (step 8446), and the temporary file is deleted (step 8448). Otherwise (no branch of step 8444), the temporary file is simply deleted (step 8448).

From the foregoing it will be appreciated that, although specific embodiments of the invention have been described herein for purposes of illustration, various modifications may be made without deviating from the spirit and scope of the invention. Accordingly, the invention is not limited except as by the appended claims.

It is claimed:

1. A venture reporting system comprising:
a server computer having venture data and component applications including venture reporting components, operation components, and security components, the venture data having one or more venture data sets, each set directed to a particular venture, for each venture data set the security components configured to allow full access to the venture data set to a group of individuals, each group having a different member set from the other groups, the security components configured to allow at least one individual full access to all venture data sets.

2. A venture reporting system comprising:
a server computer having component applications including a wizard component configured to guide an individual to set up a venture reporting website.

3. A method for operating a venture reporting system comprising:
receiving payment;
granting to an individual associated with the payment access to a wizard to guide the individual in setting up a venture reporting website; and
running a wizard component to support the individual in setting up the venture reporting website.

4. A method for operating a venture reporting system comprising:
running a server computer hosting more than one venture reporting websites;
providing access to each venture reporting website to a different set of individuals;
allowing different access privileges among at least one of the sets of individuals; and
allowing full access privileges to at least one individual to all of the venture reporting websites.
